(19) United States
(12) Patent Application Publication
(10) Pub. No.: US 2026/0262038 A1
(43) Pub. Date: Sep. 3, 2026

(54) UPLINK TRANSMISSION METHOD, APPARATUS, AND SYSTEM IN WIRELESS COMMUNICATION SYSTEM

(71) Applicant: WILUS INSTITUTE OF STANDARDS AND TECHNOLOGY INC., Gyeonggi-do (KR)

(72) Inventors: Geunyoung SEOK, Gyeonggi-do (KR); Minseok NOH, Gyeonggi-do (KR); Juhyung SON, Gyeonggi-do (KR); Jinsam KWAK, Gyeonggi-do (KR)

(21) Appl. No.: 18/707,571

(22) PCT Filed: Nov. 4, 2022
(86) PCT No.: PCT/KR2022/017253

§ 371 Date: May 4, 2026

(30) Foreign Application Priority Data
Nov. 4, 2021 (KR) 10-2021-0150946

(51) Int. Cl. H04W 72/21; H04W 72/115

(52) U.S. Cl. CPC H04W 72/21; H04W 72/115

(57) ABSTRACT

The present invention relates to a wireless communication system, and relates to a method comprising the steps of: determining a TBS on the basis of N slots: determining K slot groups for repetitively transmitting CG PUSCH based on the TBS K times, wherein each slot group comprises N slots respectively corresponding to CG PUSCH repeated transmissions; and performing repeated transmissions of the CG PUSCH on N*K slots in slot basis, considering a slot available for transmitting the CG PUSCH, wherein when an RRC parameter for initial TO determination is set to a first value, initial transmission of the CG PUSCH starts only at a first slot from among the N*K slots for the CG PUSCH, and an apparatus therefor.

### TECHNICAL FIELD

The present disclosure relates to a wireless communication system. Specifically, the present disclosure relates to a method, a device, and a system for determining and transmitting resources of an uplink shared channel.

### BACKGROUND ART

After commercialization of 4th generation (4G) communication system, in order to meet the increasing demand for wireless data traffic, efforts are being made to develop new 5th generation (5G) communication systems. The 5G communication system is called as a beyond 4G network communication system, a post LTE system, or a new radio (NR) system. In order to achieve a high data transfer rate, 5G communication systems include systems operated using the millimeter wave (mmWave) band of 6 GHz or more, and include a communication system operated using a frequency band of 6 GHz or less in terms of ensuring coverage so that implementations in base stations and terminals are under consideration.

A 3rd generation partnership project (3GPP) NR system enhances spectral efficiency of a network and enables a communication provider to provide more data and voice services over a given bandwidth. Accordingly, the 3GPP NR system is designed to meet the demands for high-speed data and media transmission in addition to supports for large volumes of voice. The advantages of the NR system are to have a higher throughput and a lower latency in an identical platform, support for frequency division duplex (FDD) and time division duplex (TDD), and a low operation cost with an enhanced end-user environment and a simple architecture.

For more efficient data processing, dynamic TDD of the NR system may use a method for varying the number of orthogonal frequency division multiplexing (OFDM) symbols that may be used in an uplink and downlink according to data traffic directions of cell users. For example, when the downlink traffic of the cell is larger than the uplink traffic, the base station may allocate a plurality of downlink OFDM symbols to a slot (or subframe). Information about the slot configuration should be transmitted to the terminals.

In order to alleviate the path loss of radio waves and increase the transmission distance of radio waves in the mmWave band, in 5G communication systems, beamforming, massive multiple input/output (massive MIMO), full dimensional MIMO (FD-MIMO), array antenna, analog beam-forming, hybrid beamforming that combines analog beamforming and digital beamforming, and large scale antenna technologies are discussed. In addition, for network improvement of the system, in the 5G communication system, technology developments related to evolved small cells, advanced small cells, cloud radio access network (cloud RAN), ultra-dense network, device to device communication (D2D), vehicle to everything communication (V2X), wireless backhaul, non-terrestrial network communication (NTN), moving network, cooperative communication, coordinated multi-points (CoMP), interference cancellation, and the like are being made. In addition, in the 5G system, hybrid FSK and QAM modulation (FQAM) and sliding window superposition coding (SWSC), which are advanced coding modulation (ACM) schemes, and filter bank multi-carrier (FBMC), non-orthogonal multiple access (NOMA), and sparse code multiple access (SCMA), which are advanced connectivity technologies, are being developed.

Meanwhile, in a human-centric connection network where humans generate and consume information, the Internet has evolved into the Internet of Things (IoT) network, which exchanges information among distributed components such as objects. Internet of Everything (IoE) technology, which combines IoT technology with big data processing technology through connection with cloud servers, is also emerging. In order to implement IoT, technology elements such as sensing technology, wired/wireless communication and network infrastructure, service interface technology, and security technology are required, so that in recent years, technologies such as sensor network, machine to machine (M2M), and machine type communication (MTC) have been studied for connection between objects. In the IoT environment, an intelligent internet technology (IT) service that collects and analyzes data generated from connected objects to create new value in human life can be provided. Through the fusion and mixture of existing information technology (IT) and various industries, IoT can be applied to fields such as smart home, smart building, smart city, smart car or connected car, smart grid, healthcare, smart home appliance, and advanced medical service.

Accordingly, various attempts have been made to apply the 5G communication system to the IoT network. For example, technologies such as a sensor network, a machine to machine (M2M), and a machine type communication (MTC) are implemented by techniques such as beamforming, MIMO, and array antennas. The application of the cloud RAN as the big data processing technology described above is an example of the fusion of 5G technology and IoT technology. Generally, a mobile communication system has been developed to provide voice service while ensuring the user's activity.

However, the mobile communication system is gradually expanding not only the voice but also the data service, and now it has developed to the extent of providing high-speed data service. However, in a mobile communication system in which services are currently being provided, a more advanced mobile communication system is required due to a shortage phenomenon of resources and a high-speed service demand of users.

### DISCLOSURE OF INVENTION

### Technical Problem

The present disclosure is to provide a wireless communication system and, particularly, a method and a device for determining and transmitting resources for data and/or control information transmitted through an uplink shared channel in a cellular wireless communication system.

### Solution to Problem

As an aspect of the present disclosure, a UE used in a wireless communication system is provided, the UE including: a communication module; and a processor configured to control the communication module, wherein the processor is configured to determine a transport block size (TBS) based on N (>1) slots, determine K slot groups for repetitively transmitting, K (>=1) times, a configured grant (CG) physical uplink shared channel (PUSCH) based on the TBS, each slot group including N slots corresponding to each repetitive CG PUSCH transmission, and in consideration of a slot in which transmission of the CG PUSCH is possible, perform the repetitive CG PUSCH transmission in units of slots on N*K slots, wherein, based on that radio resource control (RRC) for determination of an initial transmission occasion (TO) is configured to be a first value, initial transmission of the CG PUSCH starts only in a first slot among the N*K slots for the repetitive CG PUSCH transmission.

As another aspect of the present disclosure, a method used by a UE in a wireless communication system is provided, the method including: determining a transport block size (TBS) based on N (>1) slots, determining K slot groups for repetitively transmitting, K (>=1) times, a configured grant (CG) physical uplink shared channel (PUSCH) based on the TBS, each slot group including N slots corresponding to each repetitive CG PUSCH transmission, and in consideration of a slot in which transmission of the CG PUSCH is possible, performing the repetitive CG PUSCH transmission in units of slots on N*K slots, wherein, when a radio resource control (RRC) parameter for determination of an initial transmission occasion (TO) is configured to be a first value, initial transmission of the CG PUSCH starts only in a first slot among the N*K slots for the CG PUSCH.

Preferably, receiving of configuration information on an RV sequence may be further included, wherein, based on index n corresponding to the N*K slots, RV values in the RV sequence are cyclically mapped one by one in a unit of N slots within the N*K slots, and the RV sequence includes one or more RV0s.

Preferably, based on that (1) the RRC parameter for determination of the initial TO is configured to be a second value, and (2) the RV sequence is {RV0, RV3, RV0, RV3}, the initial transmission of the CG PUSCH may start within slots associated with RV0 among the N*K slots.

Preferably, based on that (1) the RRC parameter for determination of the initial TO is configured to be a second value, and (2) the RV sequence is {RV0, RV0, RV0, RV0}, the initial transmission of the CG PUSCH may start within slots associated with RV0 among the N*K slots.

Preferably, based on that (1) the RRC parameter for determination of the initial TO is configured to be a second value, and (2) the RV sequence is {RV0, RV2, RV3, RV1}, the initial transmission of the CG PUSCH may start only in the first slot among the N*K slots.

As another aspect of the present disclosure, a base station used in a wireless communication system is provided, the base station including: a communication module; and a processor configured to control the communication module, wherein the processor is configured to determine a transport block size (TBS) based on N (>1) slots, determine K slot groups for repetitively receiving, K (>=1) times, a configured grant (CG) physical uplink shared channel (PUSCH) based on the TBS, each slot group including N slots corresponding to each repetitive CG PUSCH reception, and in consideration of a slot in which reception of the CG PUSCH is possible, perform the repetitive CG PUSCH reception in units of slots on N*K slots, wherein, based on that a radio resource control (RRC) parameter for determination of an initial transmission occasion (TO) is configured to be a first value, initial reception of the CG PUSCH starts only in a first slot among the N*K slots for the repetitive CG PUSCH reception.

As another aspect of the present disclosure, a method used by a base station in a wireless communication system is provided, the method including: determining a transport block size (TBS) based on N (>1) slots, determining K slot groups for repetitively receiving, K (>=1) times, a configured grant (CG) physical uplink shared channel (PUSCH) based on the TBS, each slot group including N slots corresponding to each repetitive CG PUSCH reception, and in consideration of a slot in which reception of the CG PUSCH is possible, performing the repetitive CG PUSCH reception in units of slots on N*K slots, wherein, when a radio resource control (RRC) parameter for determination of an initial transmission occasion (TO) is configured to be a first value, initial reception of the CG PUSCH starts only in a first slot among the N*K slots for the CG PUSCH.

Preferably, transmitting of configuration information on an RV sequence may be further included, wherein, based on index n corresponding to the N*K slots, RV values in the RV sequence are cyclically mapped one by one in a unit of N slots within the N*K slots, and the RV sequence includes one or more RV0s.

Preferably, based on that (1) the RRC parameter for determination of the initial TO is configured to be a second value, and (2) the RV sequence is {RV0, RV3, RV0, RV3}, the initial reception of the CG PUSCH may start within slots associated with RV0 among the N*K slots.

Preferably, based on that (1) the RRC parameter for determination of the initial TO is configured to be a second value, and (2) the RV sequence is {RV0, RV0, RV0, RV0}, the initial reception of the CG PUSCH may start within slots associated with RV0 among the N*K slots.

Preferably, based on that (1) the RRC parameter for determination of the initial TO is configured to be a second value, and (2) the RV sequence is {RV0, RV2, RV3, RV1}, the initial reception of the CG PUSCH may start only in the first slot among the N*K slots.

### Advantageous Effects of Invention

According to an embodiment of the present disclosure, a UE can efficiently transmit data and/or uplink control information via an uplink shared channel.

The effects obtainable in the present disclosure are not limited to the above-mentioned effects, and other effects that are not mentioned may be clearly understood by those skilled in the art to which the present disclosure belongs, from descriptions below.

### BRIEF DESCRIPTION OF DRAWINGS

FIG. 1 illustrates an example of a wireless frame structure used in a wireless communication system.

FIG. 2 illustrates an example of a downlink (DL)/uplink (UL) slot structure in a wireless communication system.

FIG. 3 is a diagram for explaining a physical channel used in a 3GPP system and a typical signal transmission method using the physical channel.

FIGS. 4a and 4b illustrate an SS/PBCH block for initial cell access in a 3GPP NR system.

FIGS. 5a and 5b illustrate a procedure for transmitting control information and a control channel in a 3GPP NR system.

FIG. 6 illustrates a control resource set (CORESET) in which a physical downlink control channel (PDCCH) may be transmitted in a 3GPP NR system.

FIG. 7 illustrates a method for configuring a PDCCH search space in a 3GPP NR system.

FIG. 8 is a conceptual diagram illustrating carrier aggregation.

FIG. 9 is a diagram for explaining signal carrier communication and multiple carrier communication.

FIG. 10 is a diagram showing an example in which a cross carrier scheduling technique is applied.

FIG. 11 is a block diagram showing the configurations of a UE and a base station according to an embodiment of the present disclosure.

FIG. 12 illustrates a method of scheduling a physical uplink shared channel in a time domain according to an embodiment of the present disclosure.

FIG. 13 illustrates a method of scheduling a physical uplink shared channel in a frequency domain according to an embodiment of the present disclosure.

FIG. 14 illustrates repeated transmission of a physical uplink shared channel according to an embodiment of the present disclosure.

FIG. 15 and FIG. 16 illustrate RE mapping of a physical uplink shared channel according to an embodiment of the present disclosure;

FIG. 17 illustrates a method of determining a transmission block size (TBS) by a UE, based on one slot or one nominal PUSCH;

FIG. 18 illustrates resource allocation for multiple slots based on repetitive PUSCH transmission type A according to an embodiment of the present disclosure;

FIG. 19 illustrates resource allocation for multiple nominal PUSCHs based on repetitive PUSCH transmission type B according to an embodiment of the present disclosure;

FIG. 20 and FIG. 21 illustrate a method of determining a TBS for multiple slots or multiple nominal PUSCHs according to an embodiment of the present disclosure;

FIG. 22 and FIG. 23 illustrate examples of a collision between multiple PUCCHs and a PUSCH for which a TBS has been determined based on multiple slots or multiple nominal PUSCHs;

FIG. 24 illustrates an example of a method of determining transmission power of a PUSCH for which a TBS has been determined based on multiple slots or multiple nominal PUSCHs;

FIG. 25 illustrates an example of a PUSCH transmission power determination method according to an embodiment of the present disclosure;

FIG. 26 illustrates another example of a PUSCH transmission power determination method according to an embodiment of the present disclosure;

FIG. 27 illustrates a method of determining a transmission occasion of a PUSCH for which a TBS has been determined based on multiple slots or multiple nominal PUSCHs according to an embodiment of the present disclosure;

FIG. 28 and FIG. 29 illustrate uplink transmission according to an embodiment of the present disclosure;

FIG. 30 illustrates an example of a method of determining an initial transmission occasion of a PUSCH for which a TBS has been determined based on multiple slots or multiple nominal PUSCHs;

FIG. 31 illustrates another example of a method of determining an initial transmission occasion of a PUSCH for which a TBS has been determined based on multiple slots or multiple nominal PUSCHs according to an embodiment of the present disclosure;

FIG. 32 illustrates an example of a method of determining an initial transmission occasion of a PUSCH for which a TBS has been determined based on multiple slots or multiple nominal PUSCHs according to an embodiment of the present disclosure; and

FIG. 33 illustrates another example of a method of determining an initial transmission occasion of a PUSCH for which a TBS has been determined based on multiple slots or multiple nominal PUSCHs according to an embodiment of the present disclosure.

### BEST MODE FOR CARRYING OUT THE INVENTION

Terms used in the specification adopt general terms which are currently widely used as possible by considering functions in the present disclosure, but the terms may be changed depending on an intention of those skilled in the art, customs, and emergence of new technology. Further, in a specific case, there is a term arbitrarily selected by an applicant and in this case, a meaning thereof will be described in a corresponding description part of the present disclosure. Accordingly, it intends to be revealed that a term used in the specification should be analyzed based on not just a name of the term but a substantial meaning of the term and contents throughout the specification.

Throughout this specification and the claims that follow, when it is described that an element is “connected” to another element, the element may be “directly connected” to the other element or “electrically connected” to the other element through a third element. Further, unless explicitly described to the contrary, the word “comprise” will be understood to imply the inclusion of stated elements but not the exclusion of any other elements unless otherwise stated. Moreover, limitations such as “more than or equal to” or “less than or equal to” based on a specific threshold may be appropriately substituted with “more than” or “less than”, respectively, in some exemplary embodiments.

The following technology may be used in various wireless access systems, such as code division multiple access (CDMA), frequency division multiple access (FDMA), time division multiple access (TDMA), orthogonal frequency division multiple access (OFDMA), single carrier-FDMA (SC-FDMA), and the like. The CDMA may be implemented by a wireless technology such as universal terrestrial radio access (UTRA) or CDMA2000. The TDMA may be implemented by a wireless technology such as global system for mobile communications (GSM)/general packet radio service (GPRS)/enhanced data rates for GSM evolution (EDGE). The OFDMA may be implemented by a wireless technology such as IEEE 802.11(Wi-Fi), IEEE 802.16(WiMAX), IEEE 802-20, evolved UTRA (E-UTRA), and the like. The UTRA is a part of a universal mobile telecommunication system (UMTS). 3rd generation partnership project (3GPP) long term evolution (LTE) is a part of an evolved UMTS (E-UMTS) using evolved-UMTS terrestrial radio access (E-UTRA) and LTE-advanced (A) is an evolved version of the 3GPP LTE. 3GPP new radio (NR) is a system designed separately from LTE/LTE-A, and is a system for supporting enhanced mobile broadband (eMBB), ultra-reliable and low latency communication (URLLC), and massive machine type communication (mMTC) services, which are requirements of IMT-2020. For the clear description, 3GPP NR is mainly described, but the technical idea of the present disclosure is not limited thereto.

Unless otherwise specified in this specification, a base station may refer to a next generation node B (gNB) as defined in 3GPP NR. Furthermore, unless otherwise specified, a terminal may refer to a user equipment (UE). Hereinafter, in order to facilitate understanding of the description, each content is separately divided into embodiments and described, but each of the embodiments may be used in combination with each other. In the present disclosure, the configuration of the UE may indicate configuration by the base station. Specifically, the base station may transmit a channel or signal to the UE to configure an operation of the UE or a parameter value used in a wireless communication system.

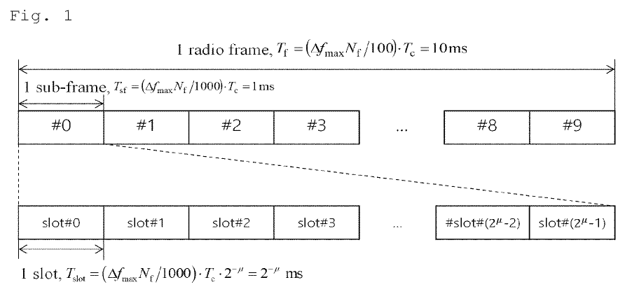

FIG. 1 illustrates an example of a wireless frame structure used in a wireless communication system.

Referring to FIG. 1, the wireless frame (or radio frame) used in the 3GPP NR system may have a length of 10 ms (ΔfmaxNf/100)*Tc). In addition, the wireless frame includes 10 subframes (SFs) having equal sizes. Herein, Δfmax=480*103 Hz, Nf=4096, Tc=1/(Δfref*Nf,ref), Δfref=15*103 Hz, and Nf,ref=2048. Numbers from 0 to 9 may be respectively allocated to 10 subframes within one subframe. Each subframe has a length of 1 ms and may include one or more slots according to a subcarrier spacing. More specifically, in the 3GPP NR system, the subcarrier spacing that may be used is 15*2p kHz, and y can have a value of μ=0, 1, 2, 3, 4 as subcarrier spacing configuration. That is, 15 kHz, 30 kHz, 60 kHz, 120 kHz and 240 kHz may be used for subcarrier spacing. One subframe having a length of 1 ms may include 2p slots. In this case, the length of each slot is 2-μ ms. Numbers from 0 to 2μ-1 may be respectively allocated to 2μ slots within one wireless frame. In addition, numbers from 0 to 10*2μ-1 may be respectively allocated to slots within one subframe. The time resource may be distinguished by at least one of a wireless frame number (also referred to as a wireless frame index), a subframe number (also referred to as a subframe number), and a slot number (or a slot index).

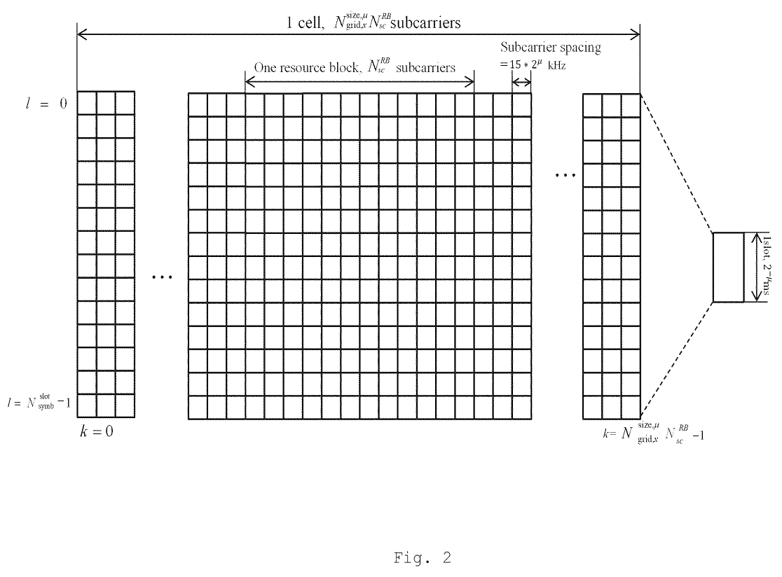

FIG. 2 illustrates an example of a downlink (DL)/uplink (UL) slot structure in a wireless communication system. In particular, FIG. 2 shows the structure of the resource grid of the 3GPP NR system.

There is one resource grid per antenna port. Referring to FIG. 2, a slot includes a plurality of orthogonal frequency division multiplexing (OFDM) symbols in a time domain and includes a plurality of resource blocks (RBs) in a frequency domain. An OFDM symbol also means one symbol section. Unless otherwise specified, OFDM symbols may be referred to simply as symbols. One RB includes 12 consecutive subcarriers in the frequency domain. Referring to FIG. 2, a signal transmitted from each slot may be represented by a resource grid including Nsize,pgrid,x*NRBsc subcarriers, and Nslotsymb OFDM symbols. Here, x=DL when the signal is a DL signal, and x=UL when the signal is an UL signal. Nsize,μgrid,x represents the number of resource blocks (RBs) according to the subcarrier spacing constituent μ (x is DL or UL), and Nslotsymb represents the number of OFDM symbols in a slot. NRBsc is the number of subcarriers constituting one RB and NRBsc=12. An OFDM symbol may be referred to as a cyclic shift OFDM (CP-OFDM) symbol or a discrete Fourier transform spread OFDM (DFT-s-OFDM) symbol according to a multiple access scheme.

The number of OFDM symbols included in one slot may vary according to the length of a cyclic prefix (CP). For example, in the case of a normal CP, one slot includes 14 OFDM symbols, but in the case of an extended CP, one slot may include 12 OFDM symbols. In a specific embodiment, the extended CP can only be used at 60 kHz subcarrier spacing. In FIG. 2, for convenience of description, one slot is configured with 14 OFDM symbols by way of example, but embodiments of the present disclosure may be applied in a similar manner to a slot having a different number of OFDM symbols. Referring to FIG. 2, each OFDM symbol includes Nsize,μgrid,x*NRBsc subcarriers in the frequency domain. The type of subcarrier may be divided into a data subcarrier for data transmission, a reference signal subcarrier for transmission of a reference signal, and a guard band. The carrier frequency is also referred to as the center frequency (fc).

One RB may be defined by NRBsc (e.g., 12) consecutive subcarriers in the frequency domain. For reference, a resource configured with one OFDM symbol and one subcarrier may be referred to as a resource element (RE) or a tone. Therefore, one RB can be configured with Nslotsymb*NRBsc resource elements. Each resource element in the resource grid can be uniquely defined by a pair of indexes (k, 1) in one slot. k may be an index assigned from 0 to Nsize,μgrid, x*NRBsc−1 in the frequency domain, and 1 may be an index assigned from 0 to Nslotsymb−1 in the time domain.

In order for the UE to receive a signal from the base station or to transmit a signal to the base station, the time/frequency of the UE may be synchronized with the time/frequency of the base station. This is because when the base station and the UE are synchronized, the UE can determine the time and frequency parameters necessary for demodulating the DL signal and transmitting the UL signal at the correct time.

Each symbol of a radio frame used in a time division duplex (TDD) or an unpaired spectrum may be configured with at least one of a DL symbol, an UL symbol, and a flexible symbol. A radio frame used as a DL carrier in a frequency division duplex (FDD) or a paired spectrum may be configured with a DL symbol or a flexible symbol, and a radio frame used as a UL carrier may be configured with a UL symbol or a flexible symbol. In the DL symbol, DL transmission is possible, but UL transmission is impossible. In the UL symbol, UL transmission is possible, but DL transmission is impossible. The flexible symbol may be determined to be used as a DL or an UL according to a signal.

Information on the type of each symbol, i.e., information representing any one of DL symbols, UL symbols, and flexible symbols, may be configured with a cell-specific or common radio resource control (RRC) signal. In addition, information on the type of each symbol may additionally be configured with a UE-specific or dedicated RRC signal. The base station informs, by using cell-specific RRC signals, i) the period of cell-specific slot configuration, ii) the number of slots with only DL symbols from the beginning of the period of cell-specific slot configuration, iii) the number of DL symbols from the first symbol of the slot immediately following the slot with only DL symbols, iv) the number of slots with only UL symbols from the end of the period of cell specific slot configuration, and v) the number of UL symbols from the last symbol of the slot immediately before the slot with only the UL symbol. Here, symbols not configured with any one of a UL symbol and a DL symbol are flexible symbols.

When the information on the symbol type is configured with the UE-specific RRC signal, the base station may signal whether the flexible symbol is a DL symbol or an UL symbol in the cell-specific RRC signal. In this case, the UE-specific RRC signal can not change a DL symbol or a UL symbol configured with the cell-specific RRC signal into another symbol type. The UE-specific RRC signal may signal the number of DL symbols among the Nslotsymb symbols of the corresponding slot for each slot, and the number of UL symbols among the Nslotsymb symbols of the corresponding slot. In this case, the DL symbol of the slot may be continuously configured with the first symbol to the i-th symbol of the slot. In addition, the UL symbol of the slot may be continuously configured with the j-th symbol to the last symbol of the slot (where i<j). In the slot, symbols not configured with any one of a UL symbol and a DL symbol are flexible symbols.

The type of symbol configured with the above RRC signal may be referred to as a semi-static DL/UL configuration. In the semi-static DL/UL configuration previously configured with RRC signals, the flexible symbol may be indicated as a DL symbol, an UL symbol, or a flexible symbol through dynamic slot format information (SFI) transmitted on a physical DL control channel (PDCCH). In this case, the DL symbol or UL symbol configured with the RRC signal is not changed to another symbol type. Table 1 exemplifies the dynamic SFI that the base station can indicate to the UE.

TABLE 1

| | Symbol number in a slot | | | | | | | | | | | | | | | Symbol number in a slot | | | | | | | | | | | | | |
|---|---|---|---|---|---|---|---|---|---|---|---|---|---|---|---|---|---|---|---|---|---|---|---|---|---|---|---|---|---|
| index | 0 | 1 | 2 | 3 | 4 | 5 | 6 | 7 | 8 | 9 | 10 | 11 | 12 | 13 | index | 0 | 1 | 2 | 3 | 4 | 5 | 6 | 7 | 8 | 9 | 10 | 11 | 12 | 13 |
| 0 | D | D | D | D | D | D | D | D | D | D | D | D | D | D | 28 | D | D | D | D | D | D | D | D | D | D | D | D | X | U |
| 1 | U | U | U | U | U | U | U | U | U | U | U | U | U | U | 29 | D | D | D | D | D | D | D | D | D | D | D | X | X | U |
| 2 | X | X | X | X | X | X | X | X | X | X | X | X | X | X | 30 | D | D | D | D | D | D | D | D | D | D | X | X | X | U |
| 3 | D | D | D | D | D | D | D | D | D | D | D | D | D | X | 31 | D | D | D | D | D | D | D | D | D | D | D | X | U | U |
| 4 | D | D | D | D | D | D | D | D | D | D | D | D | X | X | 32 | D | D | D | D | D | D | D | D | D | D | X | X | U | U |
| 5 | D | D | D | D | D | D | D | D | D | D | D | X | X | X | 33 | D | D | D | D | D | D | D | D | D | X | X | X | U | U |
| 6 | D | D | D | D | D | D | D | D | D | D | X | X | X | X | 34 | D | X | U | U | U | U | U | U | U | U | U | U | U | U |
| 7 | D | D | D | D | D | D | D | D | D | X | X | X | X | X | 35 | D | D | X | U | U | U | U | U | U | U | U | U | U | U |
| 8 | X | X | X | X | X | X | X | X | X | X | X | X | X | U | 36 | D | D | D | X | U | U | U | U | U | U | U | U | U | U |
| 9 | X | X | X | X | X | X | X | X | X | X | X | X | U | U | 37 | D | X | X | U | U | U | U | U | U | U | U | U | U | U |
| 10 | X | U | U | U | U | U | U | U | U | U | U | U | U | U | 38 | D | D | X | X | U | U | U | U | U | U | U | U | U | U |
| 11 | X | X | U | U | U | U | U | U | U | U | U | U | U | U | 39 | D | D | D | X | X | U | U | U | U | U | U | U | U | U |
| 12 | X | X | X | U | U | U | U | U | U | U | U | U | U | U | 40 | D | X | X | X | U | U | U | U | U | U | U | U | U | U |
| 13 | X | X | X | X | U | U | U | U | U | U | U | U | U | U | 41 | D | D | X | X | X | U | U | U | U | U | U | U | U | U |
| 14 | X | X | X | X | X | U | U | U | U | U | U | U | U | U | 42 | D | D | D | X | X | X | U | U | U | U | U | U | U | U |
| 15 | X | X | X | X | X | X | U | U | U | U | U | U | U | U | 43 | D | D | D | D | D | D | D | D | D | X | X | X | X | U |
| 16 | D | X | X | X | X | X | X | X | X | X | X | X | X | X | 44 | D | D | D | D | D | D | X | X | X | X | X | X | U | U |
| 17 | D | D | X | X | X | X | X | X | X | X | X | X | X | X | 45 | D | D | D | D | D | D | X | X | U | U | U | U | U | U |
| 18 | D | D | D | X | X | X | X | X | X | X | X | X | X | X | 46 | D | D | D | D | D | X | U | D | D | D | D | D | X | U |
| 19 | D | X | X | X | X | X | X | X | X | X | X | X | X | U | 47 | D | D | X | U | U | U | U | D | D | X | U | U | U | U |
| 20 | D | D | X | X | X | X | X | X | X | X | X | X | X | U | 48 | D | X | U | U | U | U | U | D | X | U | U | U | U | U |
| 21 | D | D | D | X | X | X | X | X | X | X | X | X | X | U | 49 | D | D | D | D | X | X | U | D | D | D | D | X | X | U |
| 22 | D | X | X | X | X | X | X | X | X | X | X | X | U | U | 50 | D | D | X | X | U | U | U | D | D | X | X | U | U | U |
| 23 | D | D | X | X | X | X | X | X | X | X | X | X | U | U | 51 | D | X | X | U | U | U | U | D | X | X | U | U | U | U |
| 24 | D | D | D | X | X | X | X | X | X | X | X | X | U | U | 52 | D | X | X | X | X | X | U | D | X | X | X | X | X | U |
| 25 | D | X | X | X | X | X | X | X | X | X | X | U | U | U | 53 | D | D | X | X | X | X | U | D | D | X | X | X | X | U |
| 26 | D | D | X | X | X | X | X | X | X | X | X | U | U | U | 54 | X | X | X | X | X | X | X | D | D | D | D | D | D | D |
| 27 | D | D | D | X | X | X | X | X | X | X | X | U | U | U | 55 | D | D | X | X | X | U | U | U | D | D | D | D | D | D |

| | |
|---|---|
| 56~255 | Reserved |

In Table 1, D denotes a DL symbol, U denotes a UL symbol, and X denotes a flexible symbol. As shown in Table 1, up to two DL/UL switching in one slot may be allowed.

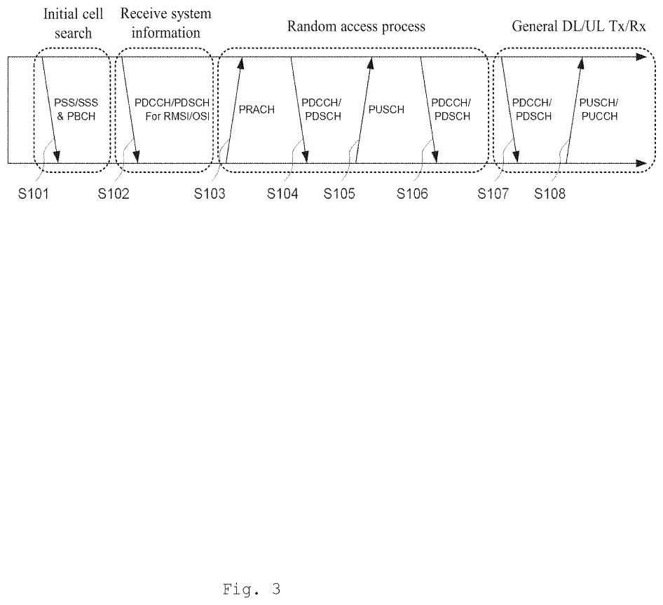

FIG. 3 is a diagram for explaining a physical channel used in a 3GPP system (e.g., NR) and a typical signal transmission method using the physical channel.

If the power of the UE is turned on or the UE camps on a new cell, the UE performs an initial cell search (S101). Specifically, the UE may synchronize with the BS in the initial cell search. For this, the UE may receive a primary synchronization signal (PSS) and a secondary synchronization signal (SSS) from the base station to synchronize with the base station, and obtain information such as a cell ID. Thereafter, the UE can receive the physical broadcast channel from the base station and obtain the broadcast information in the cell.

Upon completion of the initial cell search, the UE receives a physical downlink shared channel (PDSCH) according to the physical downlink control channel (PDCCH) and information in the PDCCH, so that the UE can obtain more specific system information than the system information obtained through the initial cell search (S102). Here, the system information received by the UE is cell-common system information for the UE to properly operate at the physical layer in Radio Resource Control (RRC), and is referred to as remaining system information (RSMI) or system information block (SIB) 1.

When the UE initially accesses the base station or does not have radio resources for signal transmission (when the UE is in RRC_IDLE mode), the UE may perform a random access procedure on the base station (operations S103 to S106). First, the UE may transmit a preamble through a physical random access channel (PRACH) (S103), and receive a random access response (RAR) message for the preamble from the base station through the PDCCH and the corresponding PDSCH (S104). In this case, the preamble in steps S103 and S104 may be described as message 1 (Msg1), and the random access response may be described as a response message or message 2 (Msg2). When a valid random access response is received by the UE, the UE transmits data including the identifier of the UE and the like to the base station through a physical uplink shared channel (PUSCH) indicated by the UL grant transmitted through the PDCCH from the base station (S105). In this case, the data including the own identifier of step S105 and the PUSCH including the data may be described as message 3 (Msg3). Also, the PUSCH including the data may be described as Message 3 PUSCH (Msg3 PUSCH). Next, the UE waits for reception of the PDCCH as an indication of the base station for collision resolution. When the UE successfully receives the PDCCH through its own identifier and receives the corresponding PDSCH (S106), the random access process ends. In this case, the PDCCH and PDSCH of step S106 may be described as message 4 (Msg 4). During the random access process, the UE may obtain UE-specific system information necessary for the UE to properly operate at the physical layer in the RRC layer. When the UE obtains UE-specific system information from the RRC layer, the UE enters the RRC CONNECTED mode.

The RRC layer is used for message generation and management for control between a UE and a radio access network (RAN). More specifically, in the RRC layer, the base station and the UE may perform broadcasting of cell system information, delivery management of paging messages, mobility management and handover, measurement report and control thereof, UE capability management, and storage management including existing management necessary for all UEs in the cell. In general, since the update of the signal (hereinafter, referred to as RRC signal) transmitted from the RRC layer is longer than the transmission/reception period (i.e., transmission time interval, TTI) in the physical layer, the RRC signal may be maintained unchanged for a long period.

After the above-described procedure, the UE receives PDCCH/PDSCH (S107) and transmits a physical uplink shared channel (PUSCH)/physical uplink control channel (PUCCH) (S108) as a general UL/DL signal transmission procedure. In particular, the UE may receive downlink control information (DCI) through the PDCCH. The DCI may include control information such as resource allocation information for the UE. Also, the format of the DCI may vary depending on the intended use. The uplink control information (UCI) that the UE transmits to the base station through UL includes a DL/UL ACK/NACK signal, a channel quality indicator (CQI), a precoding matrix index (PMI), a rank indicator (RI), and the like. Here, the CQI, PMI, and RI may be included in channel state information (CSI). In the 3GPP NR system, the UE may transmit control information such as HARQ-ACK and CSI described above through the PUSCH and/or PUCCH.

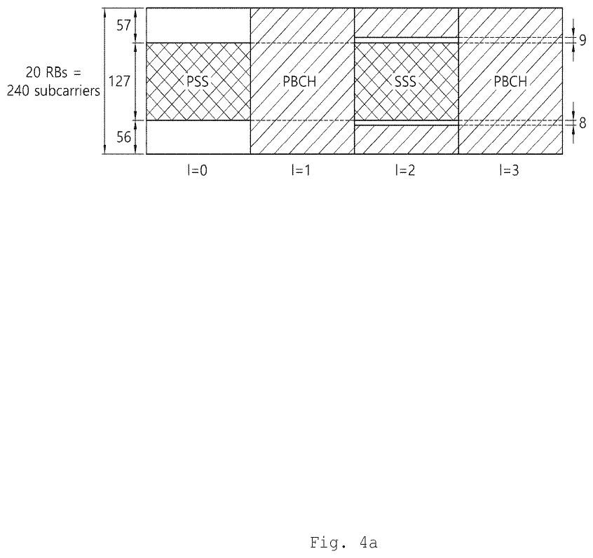

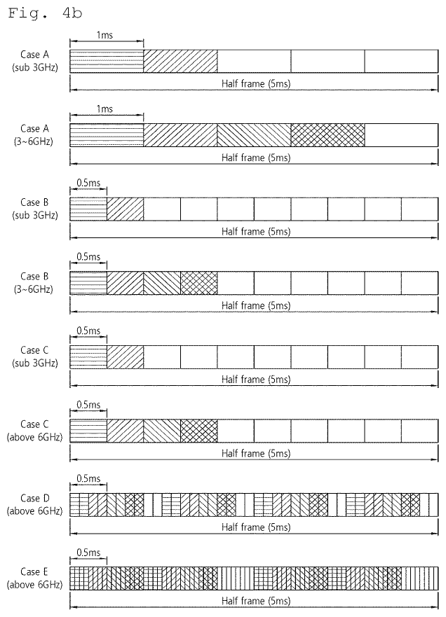

FIGS. 4a and 4b illustrate an SS/PBCH block for initial cell access in a 3GPP NR system.

When the power is turned on or wanting to access a new cell, the UE may obtain time and frequency synchronization with the cell and perform an initial cell search procedure. The UE may detect a physical cell identity NcellID of the cell during a cell search procedure. For this, the UE may receive a synchronization signal, for example, a primary synchronization signal (PSS) and a secondary synchronization signal (SSS), from a base station, and synchronize with the base station. In this case, the UE can obtain information such as a cell identity (ID).

Referring to FIG. 4a, a synchronization signal (SS) will be described in more detail. The synchronization signal can be classified into PSS and SSS. The PSS may be used to obtain time domain synchronization and/or frequency domain synchronization, such as OFDM symbol synchronization and slot synchronization. The SSS can be used to obtain frame synchronization and cell group ID. Referring to FIG. 4a and Table 2, the SS/PBCH block can be configured with consecutive 20 RBs (=240 subcarriers) in the frequency axis, and can be configured with consecutive 4 OFDM symbols in the time axis. In this case, in the SS/PBCH block, the PSS is transmitted in the first OFDM symbol and the SSS is transmitted in the third OFDM symbol through the 56th to 182th subcarriers. Here, the lowest subcarrier index of the SS/PBCH block is numbered from 0. In the first OFDM symbol in which the PSS is transmitted, the base station does not transmit a signal through the remaining subcarriers, i.e., 0th to 55th and 183th to 239th subcarriers. In addition, in the third OFDM symbol in which the SSS is transmitted, the base station does not transmit a signal through 48th to 55th and 183th to 191th subcarriers. The base station transmits a physical broadcast channel (PBCH) through the remaining RE except for the above signal in the SS/PBCH block.

TABLE 2

| | OFDM symbol number/ | Subcarrier number k |
|---|---|---|
| Channel | relative to the start | relative to the start |
| or signal | of an SS/PBCH block | of an SS/PBCH block |
| PSS | 0 | 56, 57, . . . , 182 |
| SSS | 2 | 56, 57, . . . , 182 |
| Set to 0 | 0 | 0, 1, . . . , 55, 183, |
| | | 184, . . . , 239 |
| | 2 | 48, 49, . . . , 55, 183, |
| | | 184, . . . , 191 |
| PBCH | 1, 3 | 0, 1, . . . , 239 |
| | 2 | 0, 1, . . . , 47, |
| | | 192, 193, . . . , 239 |
| DM-RS | 1, 3 | 0 + v, 4 + v, 8 + v, . . . , 236 + v |
| for | 2 | 0 + v, 4 + v, 8 + v, . . . , 44 + v |
| PBCH | | 192 + v, 196 + v, . . . , 236 + v |

The SS allows a total of 1008 unique physical layer cell IDs to be grouped into 336 physical-layer cell-identifier groups, each group including three unique identifiers, through a combination of three PSSs and SSSs, specifically, such that each physical layer cell ID is to be only a part of one physical-layer cell-identifier group. Therefore, the physical layer cell ID NcellID=3N(1)ID+N(2)ID can be uniquely defined by the index N(1)ID ranging from 0 to 335 indicating a physical-layer cell-identifier group and the index N(2)ID ranging from 0 to 2 indicating a physical-layer identifier in the physical-layer cell-identifier group. The UE may detect the PSS and identify one of the three unique physical-layer identifiers. In addition, the UE can detect the SSS and identify one of the 336 physical layer cell IDs associated with the physical-layer identifier. In this case, the sequence dPSS(n) of the PSS is as follows.

$${d}_{PSS} ( n ) = 1 - 2 x ( m )$$

$$m = ( n + 43 {N}_{ID}^{( 2 )} ) mod 127$$

$$0 \leq n < 127$$

$$Here ,$$

$$x ( i + 7 ) = ( x ( i + 4 ) + x ( i ) ) mod 2$$

is given as,

$$[ x ( 6 ) \qquad x ( 5 ) \qquad x ( 4 ) \qquad x ( 3 ) \qquad x ( 2 ) \qquad x ( 1 ) \qquad x ( 0 ) ] = [ 1 \qquad 1 \qquad 1 \qquad 0 \qquad 1 \qquad 1 \qquad 0 ]$$

Further, the sequence d_{SSS}(n) of the SSS is as follows.

$${d}_{SSS} ( n ) = [ 1 - 2 {x}_{0} ( ( n + {m}_{0} ) mod 127 ) \text{?} 1 - 2 {x}_{1} ( ( n + {m}_{1} ) mod 127 ) ]$$

$${m}_{0} = 15 ⌊ \frac{{N}_{ID}^{( 1 )}}{112} ⌋ + 5 {N}_{ID}^{( 2 )}$$

$${m}_{1} = {N}_{ID}^{( 1 )} mod 112$$

$$0 \leq n < 127$$

$$Here ,$$

$${x}_{0} ( i + 7 ) = ( {x}_{0} ( i + 4 ) + {x}_{0} ( i ) ) mod 2$$

$${x}_{1} ( i + 7 ) = ( {x}_{1} ( i + 1 ) + {x}_{1} ( i ) ) mod 2$$

and is given as,

$$\begin{matrix}[ {x}_{0} ( 6 ) & {x}_{0} ( 5 ) & {x}_{0} ( 4 ) & {x}_{0} ( 3 ) & {x}_{0} ( 2 ) & {x}_{0} ( 1 ) & {x}_{0} ( 0 ) ] = [ 0 & 0 & 0 & 0 & 0 & 0 & 1 ] \\ [ {x}_{1} ( 6 ) & {x}_{1} ( 5 ) & {x}_{1} ( 4 ) & {x}_{1} ( 3 ) & {x}_{1} ( 2 ) & {x}_{1} ( 1 ) & {x}_{1} ( 0 ) ] = [ 0 & 0 & 0 & 0 & 0 & 0 & 1 ]\end{matrix}$$

A radio frame with a 10 ms length may be divided into two half frames with a 5 ms length. Referring to FIG. 4b, a description will be made of a slot in which SS/PBCH blocks are transmitted in each half frame. A slot in which the SS/PBCH block is transmitted may be any one of the cases A, B, C, D, and E. In the case A, the subcarrier spacing is 15 kHz and the starting time point of the SS/PBCH block is the ({2, 8}+14*n)-th symbol. In this case, n=0 or 1 at a carrier frequency of 3 GHz or less. In addition, it may be n=0, 1, 2, 3 at carrier frequencies above 3 GHz and below 6 GHz. In the case B, the subcarrier spacing is 30 kHz and the starting time point of the SS/PBCH block is {4, 8, 16, 201+28*n. In this case, n=0 at a carrier frequency of 3 GHz or less. In addition, it may be n=0, 1 at carrier frequencies above 3 GHz and below 6 GHz. In the case C, the subcarrier spacing is 30 kHz and the starting time point of the SS/PBCH block is the ({2, 8}+14*n)-th symbol. In this case, n=0 or 1 at a carrier frequency of 3 GHz or less. In addition, it may be n=0, 1, 2, 3 at carrier frequencies above 3 GHz and below 6 GHz. In the case D, the subcarrier spacing is 120 kHz and the starting time point of the SS/PBCH block is the ({4, 8, 16, 20}+28*n)-th symbol. In this case, at a carrier frequency of 6 GHz or more, n=0, 1, 2, 3, 5, 6, 7, 8, 10, 11, 12, 13, 15, 16, 17, 18. In the case E, the subcarrier spacing is 240 kHz and the starting time point of the SS/PBCH block is the ({8, 12, 16, 20, 32, 36, 40, 44}+56*n)-th symbol. In this case, at a carrier frequency of 6 GHz or more, n=0, 1, 2, 3, 5, 6, 7, 8.

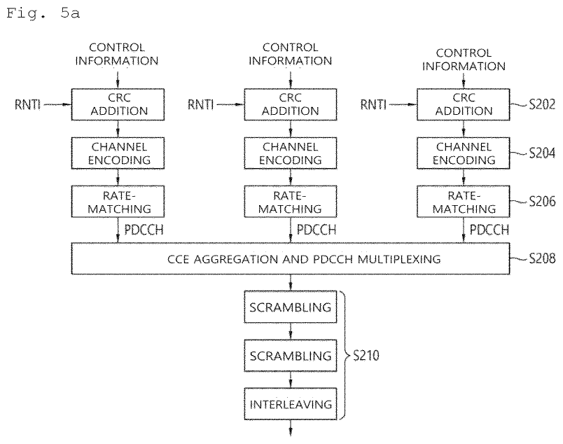

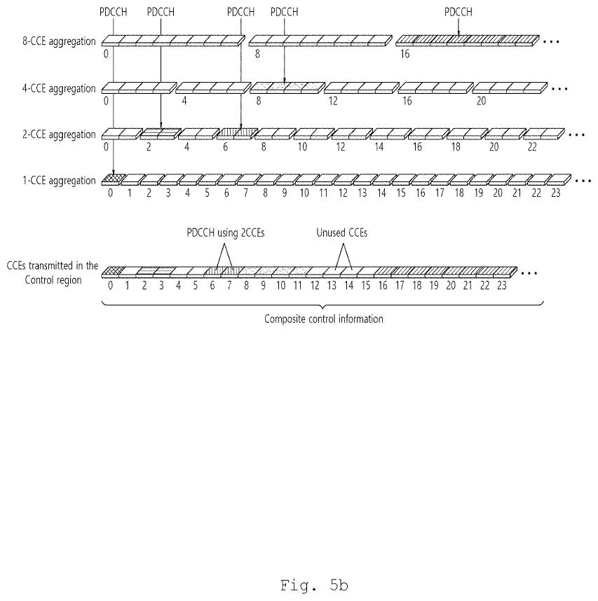

FIGS. 5a and 5b illustrate a procedure for transmitting control information and a control channel in a 3GPP NR system. Referring to FIG. 5a, the base station may add a cyclic redundancy check (CRC) masked (e.g., an XOR operation) with a radio network temporary identifier (RNTI) to control information (e.g., downlink control information (DCI)) (S202). The base station may scramble the CRC with an RNTI value determined according to the purpose/target of each control information. The common RNTI used by one or more UEs can include at least one of a system information RNTI (SI-RNTI), a paging RNTI (P-RNTI), a random access RNTI (RA-RNTI), and a transmit power control RNTI (TPC-RNTI). In addition, the UE-specific RNTI may include at least one of a cell temporary RNTI (C-RNTI), and the CS-RNTI. Thereafter, the base station may perform rate-matching (S206) according to the amount of resource(s) used for PDCCH transmission after performing channel encoding (e.g., polar coding) (S204). Thereafter, the base station may multiplex the DCI(s) based on the control channel element (CCE) based PDCCH structure (S208). In addition, the base station may apply an additional process (S210) such as scrambling, modulation (e.g., QPSK), interleaving, and the like to the multiplexed DCI(s), and then map the DCI(s) to the resource to be transmitted. The CCE is a basic resource unit for the PDCCH, and one CCE may include a plurality (e.g., six) of resource element groups (REGs). One REG may be configured with a plurality (e.g., 12) of REs. The number of CCEs used for one PDCCH may be defined as an aggregation level. In the 3GPP NR system, an aggregation level of 1, 2, 4, 8, or 16 may be used. FIG. 5b is a diagram related to a CCE aggregation level and the multiplexing of a PDCCH and illustrates the type of a CCE aggregation level used for one PDCCH and CCE(s) transmitted in the control area according thereto.

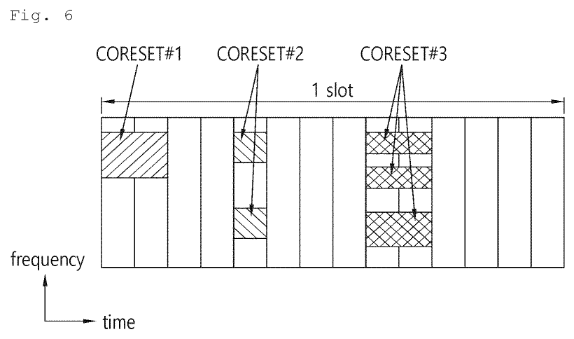

FIG. 6 illustrates a control resource set (CORESET) in which a physical downlink control channel (PDCCH) may be transmitted in a 3GPP NR system.

The CORESET is a time-frequency resource in which PDCCH, that is, a control signal for the UE, is transmitted. In addition, a search space to be described later may be mapped to one CORESET. Therefore, the UE may monitor the time-frequency domain designated as CORESET instead of monitoring all frequency bands for PDCCH reception, and decode the PDCCH mapped to CORESET. The base station may configure one or more CORESETs for each cell to the UE. The CORESET may be configured with up to three consecutive symbols on the time axis. In addition, the CORESET may be configured in units of six consecutive PRBs on the frequency axis. In the embodiment of FIG. 6, CORESET #1 is configured with consecutive PRBs, and CORESET #2 and CORESET #3 are configured with discontinuous PRBs. The CORESET can be located in any symbol in the slot. For example, in the embodiment of FIG. 5, CORESET #1 starts at the first symbol of the slot, CORESET #2 starts at the fifth symbol of the slot, and CORESET #9 starts at the ninth symbol of the slot.

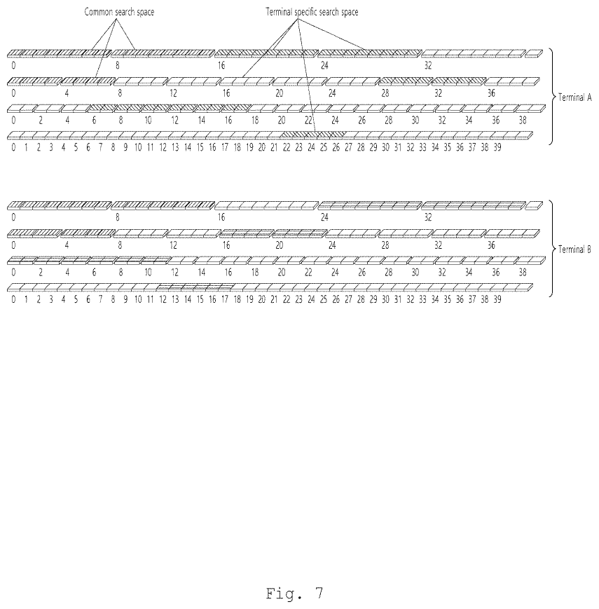

FIG. 7 illustrates a method for setting a PDCCH search space in a 3GPP NR system.

In order to transmit the PDCCH to the UE, each CORESET may have at least one search space. In the embodiment of the present disclosure, the search space is a set of all time-frequency resources (hereinafter, PDCCH candidates) through which the PDCCH of the UE is capable of being transmitted. The search space may include a common search space that the UE of the 3GPP NR is required to commonly search and a Terminal-specific or a UE-specific search space that a specific UE is required to search. In the common search space, UE may monitor the PDCCH that is set so that all UEs in the cell belonging to the same base station commonly search. In addition, the UE-specific search space may be set for each UE so that UEs monitor the PDCCH allocated to each UE at different search space position according to the UE. In the case of the UE-specific search space, the search space between the UEs may be partially overlapped and allocated due to the limited control area in which the PDCCH may be allocated. Monitoring the PDCCH includes blind decoding for PDCCH candidates in the search space. When the blind decoding is successful, it may be expressed that the PDCCH is (successfully) detected/received and when the blind decoding fails, it may be expressed that the PDCCH is not detected/not received, or is not successfully detected/received.

For convenience of explanation, a PDCCH scrambled with a group common (GC) RNTI previously known to UEs so as to transmit DL control information to the one or more UEs is referred to as a group common (GC) PDCCH or a common PDCCH. In addition, a PDCCH scrambled with a specific-terminal RNTI that a specific UE already knows so as to transmit UL scheduling information or DL scheduling information to the specific UE is referred to as a specific-UE PDCCH. The common PDCCH may be included in a common search space, and the UE-specific PDCCH may be included in a common search space or a UE-specific PDCCH.

The base station may signal each UE or UE group through a PDCCH about information (i.e., DL Grant) related to resource allocation of a paging channel (PCH) and a downlink-shared channel (DL-SCH) that are a transmission channel or information (i.e., UL grant) related to resource allocation of a uplink-shared channel (UL-SCH) and a hybrid automatic repeat request (HARQ). The base station may transmit the PCH transport block and the DL-SCH transport block through the PDSCH. The base station may transmit data excluding specific control information or specific service data through the PDSCH. In addition, the UE may receive data excluding specific control information or specific service data through the PDSCH.

The base station may include, in the PDCCH, information on to which UE (one or a plurality of UEs) PDSCH data is transmitted and how the PDSCH data is to be received and decoded by the corresponding UE, and transmit the PDCCH. For example, it is assumed that the DCI transmitted on a specific PDCCH is CRC masked with an RNTI of “A”, and the DCI indicates that PDSCH is allocated to a radio resource (e.g., frequency location) of “B” and indicates transmission format information (e.g., transport block size, modulation scheme, coding information, etc.) of “C”. The UE monitors the PDCCH using the RNTI information that the UE has. In this case, if there is a UE which performs blind decoding the PDCCH using the “A” RNTI, the UE receives the PDCCH, and receives the PDSCH indicated by “B” and “C” through the received PDCCH information.

Table 3 shows an embodiment of a physical uplink control channel (PUCCH) used in a wireless communication system.

TABLE 3

| PUCCH format | Length in OFDM symbols | Number of bits |
|---|---|---|
| 0 | 1-2 | ≤2 |
| 1 | 4-14 | ≤2 |
| 2 | 1-2 | >2 |
| 3 | 4-14 | >2 |
| 4 | 4-14 | >2 |

PUCCH may be used to transmit the following UL control information (UCI).
Scheduling Request (SR) Information used for requesting a UL UL-SCH resource.
HARQ-ACK: A Response to PDCCH (indicating DL SPS release) and/or a response to DL transport block (TB) on PDSCH. HARQ-ACK indicates whether information transmitted on the PDCCH or PDSCH is received. The HARQ-ACK response includes positive ACK (simply ACK), negative ACK (hereinafter NACK), Discontinuous Transmission (DTX), or NACK/DTX. Here, the term HARQ-ACK is used mixed with HARQ-ACK/NACK and ACK/NACK. In general, ACK may be represented by bit value 1 and NACK may be represented by bit value 0.
Channel State Information (CSI): Feedback information on the DL channel. The UE generates it based on the CSI-Reference Signal (RS) transmitted by the base station. Multiple Input Multiple Output (MIMO)-related feedback information includes a Rank Indicator (RI) and a Precoding Matrix Indicator (PMI). CSI can be divided into CSI part 1 and CSI part 2 according to the information indicated by CSI.

In the 3GPP NR system, five PUCCH formats may be used to support various service scenarios, various channel environments, and frame structures.

PUCCH format 0 is a format capable of transmitting 1-bit or 2-bit HARQ-ACK information or SR. PUCCH format 0 can be transmitted through one or two OFDM symbols on the time axis and one PRB on the frequency axis. When PUCCH format 0 is transmitted in two OFDM symbols, the same sequence to the two symbols may be transmitted through different RBs. In this case, the sequence may be a cyclic shift (CS) sequence from the base sequence used for PUCCH format 0. Through this, the UE can obtain a frequency diversity gain. Specifically, the UE may determine a cyclic shift (CS) value mcs according to the Mbit bit UCI (Mbit=1 or 2). In addition, a sequence in which a base sequence of length 12 is cyclically shifted based on a predetermined CS value mcs may be mapped to 1 OFDM symbol and 12 REs of 1 RB and transmitted. When the number of cyclic shifts available to the UE is 12 and Mbit=1, 1 bit UCI 0 and 1 may be mapped to two cyclic shifted sequences having a difference of 6 cyclic shift values, respectively. In addition, when Mbit=2, 2 bits UCI 00, 01, 11, and 10 may be mapped to four cyclic shifted sequences in which the difference in cyclic shift values is 3, respectively.

PUCCH format 1 may deliver 1-bit or 2-bit HARQ-ACK information or SR. PUCCH format 1 may be transmitted through consecutive OFDM symbols on the time axis and one PRB on the frequency axis. Here, the number of OFDM symbols occupied by PUCCH format 1 may be one of 4 to 14. More specifically, UCI, which is Mbit=1, may be BPSK-modulated. The UE may modulate UCI, which is Mbit=2, with quadrature phase shift keying (QPSK). A signal is obtained by multiplying a modulated complex valued symbol d(0) by a sequence of length 12. In this case, the sequence may be a base sequence used for PUCCH format 0. The UE spreads the even-numbered OFDM symbols to which PUCCH format 1 is allocated through the time axis orthogonal cover code (OCC) to transmit the obtained signal. PUCCH format 1 determines the maximum number of different UEs multiplexed in the one RB according to the length of the OCC to be used. A demodulation reference signal (DMRS) may be spread with OCC and mapped to the odd-numbered OFDM symbols of PUCCH format 1.

PUCCH format 2 may deliver UCI exceeding 2 bits. PUCCH format 2 may be transmitted through one or two OFDM symbols on the time axis and one or a plurality of RBs on the frequency axis. When PUCCH format 2 is transmitted in two OFDM symbols, the sequences which are transmitted in different RBs through the two OFDM symbols may be same each other. Here, the sequence may be a plurality of modulated complex valued symbols d(0), . . . , d(Msymbol-1). Here, Msymbol may be Mbit/2. Through this, the UE may obtain a frequency diversity gain. More specifically, Mbit bit UCI (Mbit>2) is bit-level scrambled, QPSK modulated, and mapped to RB(s) of one or two OFDM symbol(s). Here, the number of RBs may be one of 1 to 16.

PUCCH format 3 or PUCCH format 4 may deliver UCI exceeding 2 bits. PUCCH format 3 or PUCCH format 4 may be transmitted through consecutive OFDM symbols on the time axis and one PRB on the frequency axis. The number of OFDM symbols occupied by PUCCH format 3 or PUCCH format 4 may be one of 4 to 14. Specifically, the UE modulates Mbit bits UCI (Mbit>2) with n/2-Binary Phase Shift Keying (BPSK) or QPSK to generate a complex valued symbol d(0) to d(Msymb-1). Here, when using r/2-BPSK, Msymb=Mbit, and when using QPSK, Msymb=Mbit/2. The UE may not apply block-unit spreading to the PUCCH format 3. However, the UE may apply block-unit spreading to one RB (i.e., 12 subcarriers) using PreDFT-OCC of a length of 12 such that PUCCH format 4 may have two or four multiplexing capacities. The UE performs transmit precoding (or DFT-precoding) on the spread signal and maps it to each RE to transmit the spread signal.

In this case, the number of RBs occupied by PUCCH format 2, PUCCH format 3, or PUCCH format 4 may be determined according to the length and maximum code rate of the UCI transmitted by the UE. When the UE uses PUCCH format 2, the UE may transmit HARQ-ACK information and CSI information together through the PUCCH. When the number of RBs that the UE may transmit is greater than the maximum number of RBs that PUCCH format 2, or PUCCH format 3, or PUCCH format 4 may use, the UE may transmit only the remaining UCI information without transmitting some UCI information according to the priority of the UCI information.

PUCCH format 1, PUCCH format 3, or PUCCH format 4 may be configured through the RRC signal to indicate frequency hopping in a slot. When frequency hopping is configured, the index of the RB to be frequency hopped may be configured with an RRC signal. When PUCCH format 1, PUCCH format 3, or PUCCH format 4 is transmitted through N OFDM symbols on the time axis, the first hop may have floor (N/2) OFDM symbols and the second hop may have ceiling(N/2) OFDM symbols.

PUCCH format 1, PUCCH format 3, or PUCCH format 4 may be configured to be repeatedly transmitted in a plurality of slots. In this case, the number K of slots in which the PUCCH is repeatedly transmitted may be configured by the RRC signal. The repeatedly transmitted PUCCHs must start at an OFDM symbol of the constant position in each slot, and have the constant length. When one OFDM symbol among OFDM symbols of a slot in which a UE should transmit a PUCCH is indicated as a DL symbol by an RRC signal, the UE may not transmit the PUCCH in a corresponding slot and delay the transmission of the PUCCH to the next slot to transmit the PUCCH.

Meanwhile, in the 3GPP NR system, the UE may perform transmission/reception using a bandwidth less than or equal to the bandwidth of the carrier (or cell). To this end, the UE may be configured with a bandwidth part (BWP) consisting of a continuous bandwidth of a portion of the bandwidth of the carrier. A UE operating according to TDD or operating in an unpaired spectrum may receive up to four DL/UL BWP pairs for one carrier (or cell). In addition, the UE may activate one DL/UL BWP pair. A UE operating according to FDD or operating in a paired spectrum may receive up to 4 DL BWPs on a downlink carrier (or cell) and up to 4 UL BWPs on an uplink carrier (or cell). The UE may activate one DL BWP and UL BWP for each carrier (or cell). The UE may not receive or transmit in time-frequency resources other than the activated BWP. The activated BWP may be referred to as an active BWP.

The base station may indicate an activated BWP among the BWPs configured by the UE through downlink control information (DCI). The BWP indicated through DCI is activated, and other configured BWP(s) are deactivated. In a carrier (or cell) operating in TDD, the base station may include a bandwidth part indicator (BPI) indicating the BWP activated in the DCI scheduling the PDSCH or PUSCH to change the DL/UL BWP pair of the UE. The UE may receive a DCI scheduling a PDSCH or a PUSCH and may identify a DL/UL BWP pair activated based on the BPI. In the case of a downlink carrier (or cell) operating in FDD, the base station may include a BPI indicating the activated BWP in the DCI scheduling the PDSCH to change the DL BWP of the UE. In the case of an uplink carrier (or cell) operating in FDD, the base station may include a BPI indicating the activated BWP in the DCI scheduling the PUSCH to change the UL BWP of the UE.

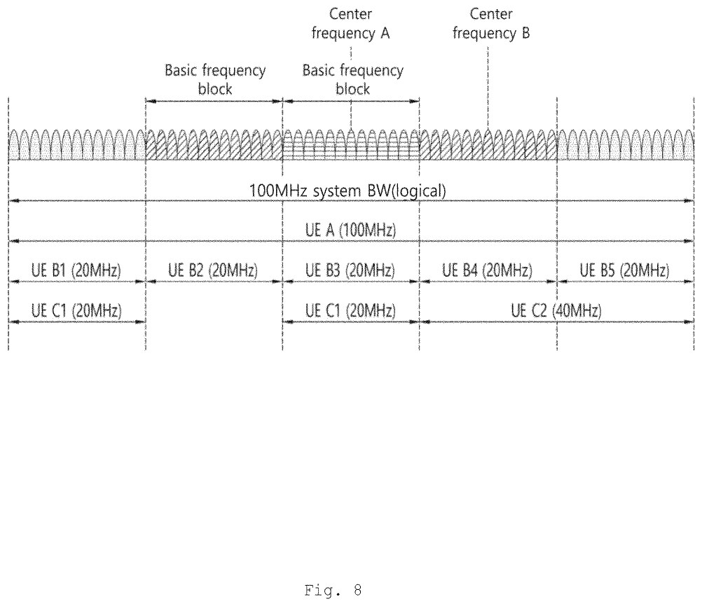

FIG. 8 is a conceptual diagram illustrating carrier aggregation.

The carrier aggregation is a method in which the UE uses a plurality of frequency blocks or cells (in the logical sense) configured with UL resources (or component carriers) and/or DL resources (or component carriers) as one large logical frequency band in order for a wireless communication system to use a wider frequency band. One component carrier may also be referred to as a term called a Primary cell (PCell) or a Secondary cell (SCell), or a Primary SCell (PScell). However, hereinafter, for convenience of description, the term “component carrier” is used.

Referring to FIG. 8, as an example of a 3GPP NR system, the entire system band may include up to 16 component carriers, and each component carrier may have a bandwidth of up to 400 MHz. The component carrier may include one or more physically consecutive subcarriers. Although it is shown in FIG. 8 that each of the component carriers has the same bandwidth, this is merely an example, and each component carrier may have a different bandwidth. Also, although each component carrier is shown as being adjacent to each other in the frequency axis, the drawings are shown in a logical concept, and each component carrier may be physically adjacent to one another, or may be spaced apart.

Different center frequencies may be used for each component carrier. Also, one common center frequency may be used in physically adjacent component carriers. Assuming that all the component carriers are physically adjacent in the embodiment of FIG. 8, center frequency A may be used in all the component carriers. Further, assuming that the respective component carriers are not physically adjacent to each other, center frequency A and the center frequency B can be used in each of the component carriers.

When the total system band is extended by carrier aggregation, the frequency band used for communication with each UE can be defined in units of a component carrier. UE A may use 100 MHz, which is the total system band, and performs communication using all five component carriers. UEs B1~B5 can use only a 20 MHz bandwidth and perform communication using one component carrier. UEs C1 and C2 may use a 40 MHz bandwidth and perform communication using two component carriers, respectively. The two component carriers may be logically/physically adjacent or non-adjacent. UE Cl represents the case of using two non-adjacent component carriers, and UE C2 represents the case of using two adjacent component carriers.

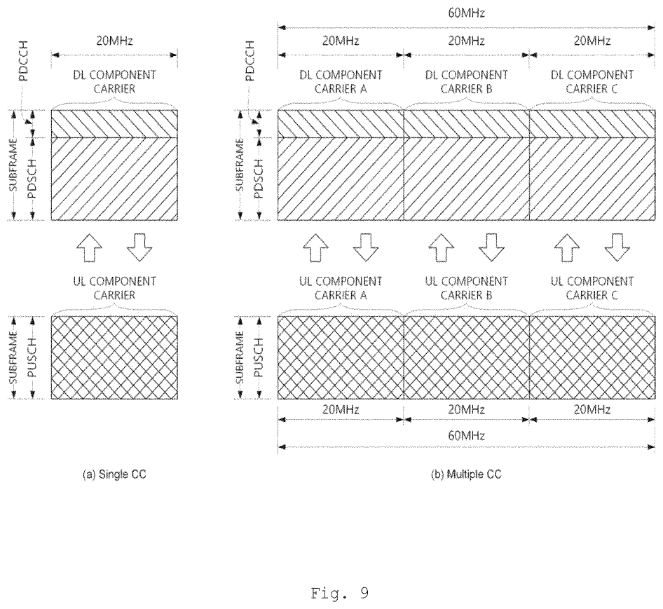

FIG. 9 is a drawing for explaining signal carrier communication and multiple carrier communication. Particularly, FIG. 9(a) shows a single carrier subframe structure and FIG. 9(b) shows a multi-carrier subframe structure.

Referring to FIG. 9(a), in an FDD mode, a general wireless communication system may perform data transmission or reception through one DL band and one UL band corresponding thereto. In another specific embodiment, in a TDD mode, the wireless communication system may divide a radio frame into a UL time unit and a DL time unit in a time domain, and perform data transmission or reception through a UL/DL time unit. Referring to FIG. 9(b), three 20 MHz component carriers (CCs) can be aggregated into each of UL and DL, so that a bandwidth of 60 MHz can be supported. Each CC may be adjacent or non-adjacent to one another in the frequency domain. FIG. 9(b) shows a case where the bandwidth of the UL CC and the bandwidth of the DL CC are the same and symmetric, but the bandwidth of each CC can be determined independently. In addition, asymmetric carrier aggregation with different number of UL CCs and DL CCs is possible. A DL/UL CC allocated/configured to a specific UE through RRC may be called as a serving DL/UL CC of the specific UE.

The base station may perform communication with the UE by activating some or all of the serving CCs of the UE or deactivating some CCs. The base station can change the CC to be activated/deactivated, and change the number of CCs to be activated/deactivated. If the base station allocates a CC available for the UE as to be cell-specific or UE-specific, at least one of the allocated CCs can be deactivated, unless the CC allocation for the UE is completely reconfigured or the UE is handed over. One CC that is not deactivated by the UE is called as a Primary CC (PCC) or a primary cell (PCell), and a CC that the base station can freely activate/deactivate is called as a Secondary CC (SCC) or a secondary cell (SCell).

Meanwhile, 3GPP NR uses the concept of a cell to manage radio resources. A cell is defined as a combination of DL resources and UL resources, that is, a combination of DL CC and UL CC. A cell may be configured with DL resources alone, or a combination of DL resources and UL resources. When the carrier aggregation is supported, the linkage between the carrier frequency of the DL resource (or DL CC) and the carrier frequency of the UL resource (or UL CC) may be indicated by system information. The carrier frequency refers to the center frequency of each cell or CC. A cell corresponding to the PCC is referred to as a PCell, and a cell corresponding to the SCC is referred to as an SCell. The carrier corresponding to the PCell in the DL is the DL PCC, and the carrier corresponding to the PCell in the UL is the UL PCC. Similarly, the carrier corresponding to the SCell in the DL is the DL SCC and the carrier corresponding to the SCell in the UL is the UL SCC. According to UE capability, the serving cell(s) may be configured with one PCell and zero or more SCells. In the case of UEs that are in the RRC CONNECTED state but not configured for carrier aggregation or that do not support carrier aggregation, there is only one serving cell configured only with PCell.

As mentioned above, the term “cell” used in carrier aggregation is distinguished from the term “cell” which refers to a certain geographical area in which a communication service is provided by one base station or one antenna group. That is, one component carrier may also be referred to as a scheduling cell, a scheduled cell, a primary cell (PCell), a secondary cell (SCell), or a primary SCell (PScell). However, in order to distinguish between a cell referring to a certain geographical area and a cell of carrier aggregation, in the present disclosure, a cell of a carrier aggregation is referred to as a CC, and a cell of a geographical area is referred to as a cell.

FIG. 10 is a diagram showing an example in which a cross carrier scheduling technique is applied. When cross carrier scheduling is set, the control channel transmitted through the first CC may schedule a data channel transmitted through the first CC or the second CC using a carrier indicator field (CIF). The CIF is included in the DCI. In other words, a scheduling cell is set, and the DL grant/UL grant transmitted in the PDCCH area of the scheduling cell schedules the PDSCH/PUSCH of the scheduled cell. That is, a search area for the plurality of component carriers exists in the PDCCH area of the scheduling cell. A PCell may be basically a scheduling cell, and a specific SCell may be designated as a scheduling cell by an upper layer.

In the embodiment of FIG. 10, it is assumed that three DL CCs are merged. Here, it is assumed that DL component carrier #0 is DL PCC (or PCell), and DL component carrier #1 and DL component carrier #2 are DL SCCs (or SCell). In addition, it is assumed that the DL PCC is set to the PDCCH monitoring CC. When cross-carrier scheduling is not configured by UE-specific (or UE-group-specific or cell-specific) higher layer signaling, a CIF is disabled, and each DL CC can transmit only a PDCCH for scheduling its PDSCH without the CIF according to an NR PDCCH rule (non-cross-carrier scheduling, self-carrier scheduling). Meanwhile, if cross-carrier scheduling is configured by UE-specific (or UE-group-specific or cell-specific) higher layer signaling, a CIF is enabled, and a specific CC (e.g., DL PCC) may transmit not only the PDCCH for scheduling the PDSCH of the DL CC A using the CIF but also the PDCCH for scheduling the PDSCH of another CC (cross-carrier scheduling). On the other hand, a PDCCH is not transmitted in another DL CC. Accordingly, the UE monitors the PDCCH not including the CIF to receive a self-carrier scheduled PDSCH depending on whether the cross-carrier scheduling is configured for the UE, or monitors the PDCCH including the CIF to receive the cross-carrier scheduled PDSCH.

On the other hand, FIGS. 9 and 10 illustrate the subframe structure of the 3GPP LTE-A system, and the same or similar configuration may be applied to the 3GPP NR system. However, in the 3GPP NR system, the subframes of FIGS. 9 and 10 may be replaced with slots.

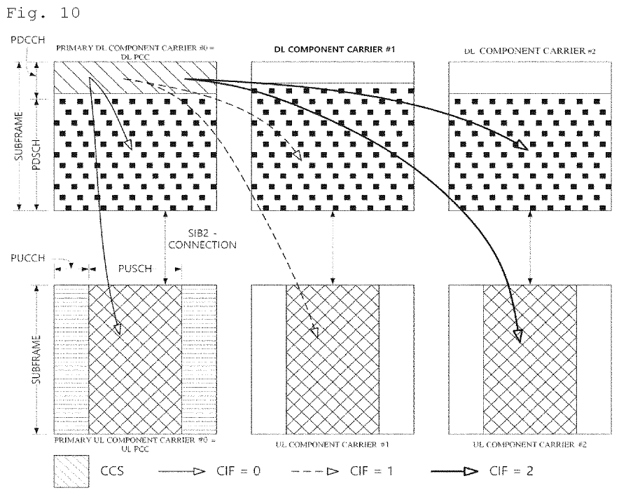

FIG. 11 is a block diagram showing the configurations of a UE and a base station according to an embodiment of the present disclosure.

In an embodiment of the present disclosure, the UE may be implemented with various types of wireless communication devices or computing devices that are guaranteed to be portable and mobile. The UE may be referred to as a User Equipment (UE), a Station (STA), a Mobile Subscriber (MS), or the like. In addition, in an embodiment of the present disclosure, the base station controls and manages a cell (e.g., a macro cell, a femto cell, a pico cell, etc.) corresponding to a service area, and performs functions of a signal transmission, a channel designation, a channel monitoring, a self diagnosis, a relay, or the like. The base station may be referred to as next Generation NodeB (gNB) or Access Point (AP).

As shown in the drawing, a UE 100 according to an embodiment of the present disclosure may include a processor 110, a communication module 120, a memory 130, a user interface 140, and a display unit 150.

First, the processor 110 may execute various instructions or programs and process data within the UE 100. In addition, the processor 110 may control the entire operation including each unit of the UE 100, and may control the transmission/reception of data between the units. Here, the processor 110 may be configured to perform an operation according to the embodiments described in the present disclosure. For example, the processor 110 may receive slot configuration information, determine a slot configuration based on the slot configuration information, and perform communication according to the determined slot configuration.

Next, the communication module 120 may be an integrated module that performs wireless communication using a wireless communication network and a wireless LAN access using a wireless LAN. For this, the communication module 120 may include a plurality of network interface cards (NICs) such as cellular communication interface cards 121 and 122 and an unlicensed band communication interface card 123 in an internal or external form. In the drawing, the communication module 120 is shown as an integral integration module, but unlike the drawing, each network interface card can be independently arranged according to a circuit configuration or usage.

The cellular communication interface card 121 may transmit or receive a radio signal with at least one of the base station 200, an external device, and a server by using a mobile communication network and provide a cellular communication service in a first frequency band based on the instructions from the processor 110. According to an embodiment, the cellular communication interface card 121 may include at least one NIC module using a frequency band of less than 6 GHz. At least one NIC module of the cellular communication interface card 121 may independently perform cellular communication with at least one of the base station 200, an external device, and a server in accordance with cellular communication standards or protocols in the frequency bands below 6 GHz supported by the corresponding NIC module.

The cellular communication interface card 122 may transmit or receive a radio signal with at least one of the base station 200, an external device, and a server by using a mobile communication network and provide a cellular communication service in a second frequency band based on the instructions from the processor 110. According to an embodiment, the cellular communication interface card 122 may include at least one NIC module using a frequency band of more than 6 GHz. At least one NIC module of the cellular communication interface card 122 may independently perform cellular communication with at least one of the base station 200, an external device, and a server in accordance with cellular communication standards or protocols in the frequency bands of 6 GHz or more supported by the corresponding NIC module.

The unlicensed band communication interface card 123 transmits or receives a radio signal with at least one of the base station 200, an external device, and a server by using a third frequency band which is an unlicensed band, and provides an unlicensed band communication service based on the instructions from the processor 110. The unlicensed band communication interface card 123 may include at least one NIC module using an unlicensed band. For example, the unlicensed band may be a band of 2.4 GHz, 5 GHz, 6 GHz, 7 GHz, or above 52.6 GHz. At least one NIC module of the unlicensed band communication interface card 123 may independently or dependently perform wireless communication with at least one of the base station 200, an external device, and a server according to the unlicensed band communication standard or protocol of the frequency band supported by the corresponding NIC module.

The memory 130 stores a control program used in the UE 100 and various kinds of data therefor. Such a control program may include a prescribed program required for performing wireless communication with at least one among the base station 200, an external device, and a server.

Next, the user interface 140 includes various kinds of input/output means provided in the UE 100. In other words, the user interface 140 may receive a user input using various input means, and the processor 110 may control the UE 100 based on the received user input. In addition, the user interface 140 may perform an output based on instructions from the processor 110 using various kinds of output means.

Next, the display unit 150 outputs various images on a display screen. The display unit 150 may output various display objects such as content executed by the processor 110 or a user interface based on control instructions from the processor 110.

In addition, the base station 200 according to an embodiment of the present disclosure may include a processor 210, a communication module 220, and a memory 230.

First, the processor 210 may execute various instructions or programs, and process internal data of the base station 200. In addition, the processor 210 may control the entire operations of units in the base station 200, and control data transmission and reception between the units. Here, the processor 210 may be configured to perform operations according to embodiments described in the present disclosure. For example, the processor 210 may signal slot configuration and perform communication according to the signaled slot configuration.

Next, the communication module 220 may be an integrated module that performs wireless communication using a wireless communication network and a wireless LAN access using a wireless LAN. For this, the communication module 220 may include a plurality of network interface cards such as cellular communication interface cards 221 and 222 and an unlicensed band communication interface card 223 in an internal or external form. In the drawing, the communication module 220 is shown as an integral integration module, but unlike the drawing, each network interface card can be independently arranged according to a circuit configuration or usage.

The cellular communication interface card 221 may transmit or receive a radio signal with at least one of the UE 100, an external device, and a server by using a mobile communication network and provide a cellular communication service in the first frequency band based on the instructions from the processor 210. According to an embodiment, the cellular communication interface card 221 may include at least one NIC module using a frequency band of less than 6 GHz. The at least one NIC module of the cellular communication interface card 221 may independently perform cellular communication with at least one of the UE 100, an external device, and a server in accordance with the cellular communication standards or protocols in the frequency bands less than 6 GHz supported by the corresponding NIC module.

The cellular communication interface card 222 may transmit or receive a radio signal with at least one of the UE 100, an external device, and a server by using a mobile communication network and provide a cellular communication service in the second frequency band based on the instructions from the processor 210. According to an embodiment, the cellular communication interface card 222 may include at least one NIC module using a frequency band of 6 GHz or more. The at least one NIC module of the cellular communication interface card 222 may independently perform cellular communication with at least one of the base station 100, an external device, and a server in accordance with the cellular communication standards or protocols in the frequency bands 6 GHz or more supported by the corresponding NIC module.

The unlicensed band communication interface card 223 transmits or receives a radio signal with at least one of the base station 100, an external device, and a server by using the third frequency band which is an unlicensed band, and provides an unlicensed band communication service based on the instructions from the processor 210. The unlicensed band communication interface card 223 may include at least one NIC module using an unlicensed band. For example, the unlicensed band may be a band of 2.4 GHz, 5 GHz, 6 GHz, 7 GHz, or above 52.6 GHz. At least one NIC module of the unlicensed band communication interface card 223 may independently or dependently perform wireless communication with at least one of the UE 100, an external device, and a server according to the unlicensed band communication standards or protocols of the frequency band supported by the corresponding NIC module.

FIG. 11 is a block diagram illustrating the UE 100 and the base station 200 according to an embodiment of the present disclosure, and blocks separately shown are logically divided elements of a device. Accordingly, the aforementioned elements of the device may be mounted in a single chip or a plurality of chips according to the design of the device. In addition, a part of the configuration of the UE 100, for example, a user interface 140, a display unit 150 and the like may be selectively provided in the UE 100. In addition, the user interface 140, the display unit 150 and the like may be additionally provided in the base station 200, if necessary.

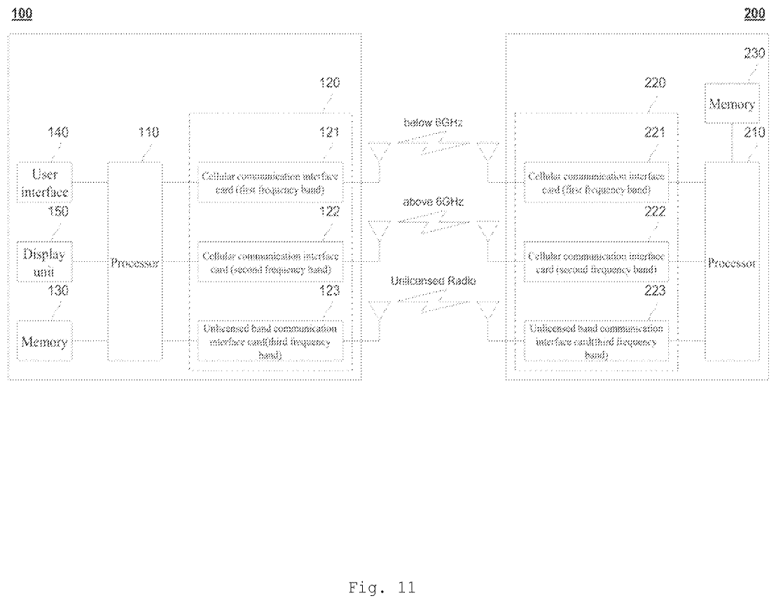

FIG. 12 illustrates a method of scheduling a physical uplink shared channel in a time domain according to an embodiment of the present disclosure.

A terminal may transmit uplink data to a base station through a PUSCH. The base station may schedule (PUSCH scheduling), for the terminal, to transmit uplink data through the PUSCH. i) In a dynamic grant (DG) method, the base station may perform PUSCH scheduling via DCI included in a PDCCH. Alternatively, ii) in a configured grant (CG) method, the terminal may transmit uplink data to the base station through a PUSCH according to a resource and a transmission method preconfigured for the terminal by the base station.

In this case, DCI included in a PDCCH may include PUSCH scheduling information. For example, the DCI may include time domain information (time-domain resource assignment (TDRA)) and frequency domain information (frequency-domain resource assignment (FDRA)). The terminal may receive DCI transmitted in a control resource set and a search space, and may perform operations (e.g., uplink data transmission through the PUSCH) indicated via the DCI. In this case, a DCI format for PUSCH scheduling may be DCI formats 0_0, 0_1, and 0_2. DCI of DCI formats 0_0, 0_1, and 0_2 may include a TDRA field including time domain information of the PUSCH. In this case, the time domain information may include K2, which is an offset value between a slot in which the PDCCH is transmitted from the base station and a slot in which the terminal transmits the PUSCH. In addition, the DCI may include a start and length indication value (SLIV) which is a joint-coded value of a starting symbol index (S) of the PUSCH and a symbol length (L, number) of the PUSCH in a slot indicated by K2. If the terminal receives the DCI in slot n, a slot in which the PUSCH is scheduled may be a floor(n*2μPUSCH/n*2μPDCCH)+K2 slot. μPUSCH and μPDCCH may refer to a subcarrier spacing (SCS) of a cell in which the PUSCH is scheduled and a cell in which the terminal receives the PDCCH, respectively. floor(x) is a function that returns a largest integer among integers equal to or smaller than x. In the present specification, slot n may refer to a slot indexed with index n.

Referring to FIG. 12(a), a subcarrier spacing of a cell in which the terminal receives a PDCCH and a cell in which a PUSCH is scheduled may be the same. In this case, if the terminal receives the PDCCH in slot n and is indicated that K2 is 4, a slot in which the PUSCH is scheduled may be slot n+K2, that is, slot n+4.

As for a PUSCH scheduling type, there may be two mapping types of PUSCH mapping type A and PUSCH mapping type B. Depending on a PUSCH mapping type, the range of possible values for a starting symbol index and an SLIV of the PUSCH may vary. In PUSCH mapping type A, only resource allocation including a DMRS symbol is possible, and the DMRS symbol may be located in a third or fourth symbol of a slot according to a value indicated by a higher layer. That is, in the case of PUSCH mapping type A, an index (S) of a starting symbol of the PUSCH may be 0, and a length (L) of the PUSCH may have one of values from 4 to 14 (12 for an extended CP) according to a DMRS symbol position. In PUSCH mapping type B, a first symbol of the PUSCH may be a DMRS symbol. Accordingly, S may have a value from 0 to 13 (11 for an extended CP), and L may have one of values from 1 to 14 (12 for an extended CP). In addition, since one PUSCH cannot cross a slot boundary, the sum of S and L should be smaller than or equal to 14 (12 for an extended CP).

Referring to FIG. 12(b), the base station may schedule PUSCH mapping type A in which a third symbol is a DMRS symbol, an index (S) of a starting symbol is 0, and a length (L) is 7, may schedule PUSCH mapping type A in which a fourth symbol is a DMRS symbol, an index (S) of a starting symbol is 0, and a length (L) is 7, and may schedule PUSCH mapping type B in which a first symbol is a DMRS symbol, an index (S) of a starting symbol is 5, and a length (L) is 5. In this case, frequency domain information of the PUSCH indicated in the FDRA field of DCI format 0_0, 0_1, or 0_2 may be divided into two types according to frequency resource allocation types.

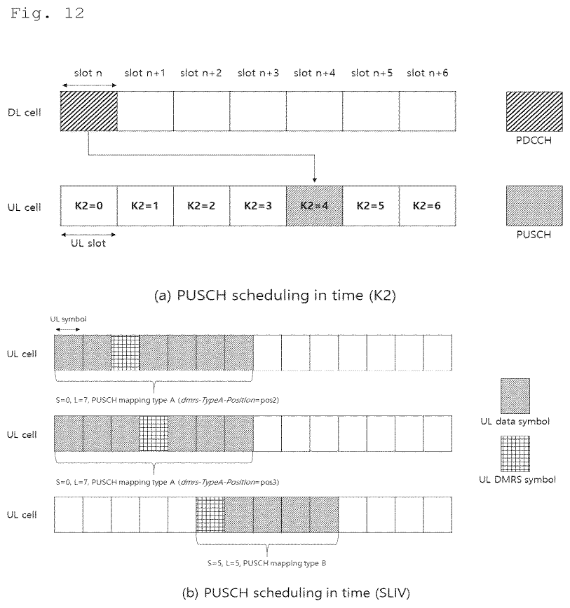

FIG. 13 illustrates a method of scheduling a physical uplink shared channel in a frequency domain according to an embodiment of the present disclosure.

Hereinafter, a frequency resource allocation type will be described with reference to FIG. 13.

i) Frequency resource allocation type 0 which is a first type may be a type in which an RBG is configured by bundling a certain number of PRBs according to the number of RBs included in a BWP configured (set) for a terminal, and whether to use the RBG is indicated via a bitmap in units of RBGs. That is, the terminal may determine whether to use a corresponding RBG via a bitmap transmitted from a base station. The number of PRBs included in one RBG may be set (configured) from a higher layer, and as the larger the number of RBs included in a BWP are set (configured) for the terminal, the more PRBs may be set (configured). Referring to FIG. 13(a), a BWP size set (configured) for the terminal may be 72 PRBs, and one RBG may include 4 PRBs. In this case, the terminal may determine four PRBs as one RBG in ascending order from PRB 0, and each RBG may be indexed from 0. That is, an RBG including PRBs 0 to PRB 3 may be indexed as RBG 0, and an RBG including PRBs 4 through PRB 7 may be indexed as RBG 1. Up to RBG 17 may be indexed in the same manner, wherein the base station may transmit 1 bit (0 or 1) per RBG, i.e., a total of 18 bits, to the terminal, and the terminal may determine, based on the received 18 bits, whether to use PRBs constituting a corresponding RBG. In this case, if a bit value is 0, the terminal may determine that a PUSCH is not scheduled for any PRB among the PRBs constituting the corresponding RBG. If the bit value is 1, the terminal may determine that a PUSCH is scheduled for all PRBs in the corresponding RBG. In this case, the bit value may be applied in reverse. ii) Frequency resource allocation type 1 which is a second type may be a type indicating information on consecutive PRBs allocated according to a size of an active BWP or an initial BWP of the terminal. The information on consecutive PRBs may be a resource indication value (RIV) value in which a start index (S) and a length (L) of the consecutive PRBs are jointly coded. Referring to FIG. 13(b), when a BWP size is 50 PRBs, and a PUSCH is scheduled for the terminal from PRB 2 to PRB 11 among the 50 PRBs, a start index of consecutive PRBs may be 2 and a length may be 10. That is, the terminal may determine the start index and the length of consecutive PRBs in which the PUSCH is scheduled, based on an RIV value received from the base station. Specifically, the RIV may be calculated by NsizeBWP*(L−1)+S. NsizeBWP may be the size of BWP configured for the terminal. For example, if the RIV value received by the terminal is 452, calculation of 452 is based on 452=50*(10−1)+2, and therefore the terminal may determine that the start index of consecutive PRBs in which the PUSCH is scheduled is 2 and the length is 10.

Via DCI of DCI format 0_1 or 0_2 for scheduling of the PUSCH, the terminal may be configured, from a higher layer, to use only one of the aforementioned two frequency resource allocation types or dynamically use both the two types. If the terminal is configured to dynamically use the two types, the terminal may determine a type to be used, via 1 bit of a most significant bit (MSB) of an FDRA field of the DCI.

There may be an uplink shared channel transmission method based on a configured grant for URLLC transmission, etc. The uplink shared channel transmission method based on a configured grant may be described as grant-free transmission. The uplink shared channel transmission method based on a configured grant may be a method in which, if the base station configures, for the terminal, available resources for uplink transmission via a higher layer (i.e., RRC signaling), the terminal may transmit an uplink shared channel by using the configured resources. The uplink shared channel transmission method based on a configured grant may be classified into two types depending on whether DCI indicates activation and release. i) Type 1 of the uplink shared channel transmission method based on a configured grant may be a method of configuring a transmission method and resources in advance via a higher layer. ii) Type 2 of the uplink shared channel transmission method based on a configured grant may be a method of configuring configured grant-based transmission via a higher layer, and configuring, via DCI, a method and resources for actual transmission.

The uplink transmission method based on a configured grant may support URLLC transmission. Accordingly, uplink transmission may be repeatedly performed on multiple slots to ensure high reliability. In this case, a redundancy version (RV) sequence may be one of {0, 0, 0, 0}, {0, 2, 3, 1}, and {0, 3, 0, 3}, and an RV corresponding to a (mod(n−1, 4)+1)th value may be used in an nth repeated transmission. That is, an RV corresponding to a value obtained by adding 1 to a remainder of dividing n−1 by 4 may be used. In addition, the terminal configured to repeatedly transmit an uplink channel may start repeated transmission only in a slot having an RV value of 0. However, if an RV sequence is {0, 0, 0, 0} and an uplink channel is configured to be repeatedly transmitted in 8 slots, the terminal may not start repeated transmission in an 8th slot. The terminal may terminate repeated transmission when a UL grant having the same HARQ process ID is received or when the number of repeated transmissions configured via a higher layer is reached or a periodicity is exceeded. The UL grant may refer to DCI for PUSCH scheduling.

As described above, in order to improve PUSCH transmission/reception reliability between a base station and a terminal in a wireless communication system, the base station may configure for the terminal to repeatedly transmit a PUSCH.

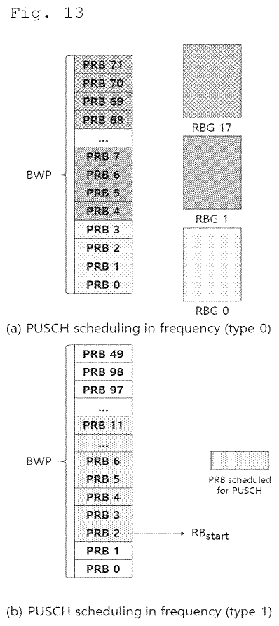

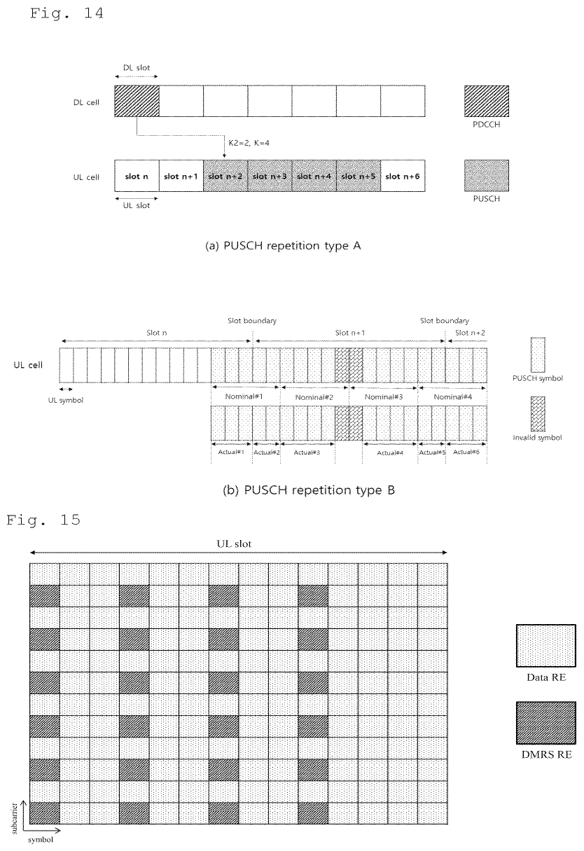

FIG. 14 illustrates repeated transmission of a physical uplink shared channel according to an embodiment of the present disclosure.

Repeated PUSCH transmission performed by a terminal may be of two types. i) First, repeated PUSCH transmission type A will be described. When a terminal receives DCI of DCI format 0_1 or 0_2 included in a PDCCH for PUSCH scheduling from a base station, the terminal may repeatedly transmit a PUSCH on K consecutive slots. A K value may be configured from a higher layer or may be a value included in a TDRA field of the DCI so as to be configured for the terminal. For example, referring to FIG. 14A, the terminal may receive the PDCCH for PUSCH scheduling in slot n, and a K2 value may be configured from DCI included in the received PDCCH. In this case, if the K2 value is 2 and the K value is 4, the terminal may start repeated PUSCH transmission in slot n+K2, and may repeatedly transmit a PUSCH until slot n+K2+K-1. That is, the terminal starts repeated PUSCH transmission in slot n+2 and repeatedly transmits a PUSCH until slot n+5. In this case, time and frequency domain resources in which the PUSCH is transmitted in each slot may be the same as those indicated in the DCI. That is, the PUSCH may be transmitted in the same symbol and PRB(s) within a slot. ii) Next, repeated PUSCH transmission type B will be described. Repeated PUSCH transmission type B may be a type used for the terminal to perform low-latency repeated PUSCH transmission in order to satisfy URLLC requirements, etc. The terminal may be configured with a symbol (S) in which repeated PUSCH transmission starts and a length (L) of the repeated PUSCH transmission, via the TDRA field of the DCI transmitted by the base station. In this case, the starting symbol (S) and the length (L) may be for a temporarily obtained nominal PUSCH rather than an actual PUSCH actually transmitted by the terminal. A separate symbol may not exist between nominal PUSCHs configured to be repeatedly transmitted. That is, nominal PUSCHs may be consecutive in the time domain. The terminal may determine an actual PUSCH from the nominal PUSCHs. One nominal PUSCH may be determined to be one or multiple actual PUSCHs. The base station may configure, for the terminal, symbols unavailable for repeated PUSCH transmission type B. Symbols unavailable for repeated PUSCH transmission type B may be described as invalid symbols. The terminal may exclude invalid symbols from among resources configured to transmit nominal PUSCHs. As described above, nominal PUSCHs are configured to be repeatedly transmitted on consecutive symbols, but if invalid symbols are excluded, resources for nominal PUSCH transmission become inconsecutive. An actual PUSCH may be configured to be transmitted on consecutive symbols configured for one nominal PUSCH transmission except for invalid symbols. In this case, if consecutive symbols cross a slot boundary, an actual PUSCH actually transmitted based on the slot boundary may be divided. Invalid symbols may include downlink symbols configured for the terminal by the base station. Referring to FIG. 14B, the terminal may be scheduled with PUSCH transmission having a length of 5 symbols starting from a 12th symbol of a first slot (slot n), and may be configured with 4 times of type B repeated transmission. In this case, resources scheduled for a first nominal PUSCH (nominal #1) may include symbol (n,11), symbol (n,12), symbol (n,13), symbol (n+1,0), and symbol (n+1,1). Resources scheduled for a second nominal PUSCH (nominal #2) may include symbol (n+1,2), symbol (n+1,3), symbol (n+1,4), symbol (n+1,5), and symbol (n+1,6). Resources scheduled for a third nominal PUSCH (nominal #3) may include symbol (n+1,7), symbol (n+1,8), symbol (n+1,9), symbol (n+1,10), and symbol (n+1,11). Resources scheduled for a fourth nominal PUSCH (nominal #4) may include symbol (n+1,12), symbol (n+1,13), symbol (n+2,0), symbol (n+2,1), and symbol (n+2,2). In this case, symbol (n, k) represents symbol k of slot n. That is, k may be a value starting from 0 to 13 for a normal CP, and may be a value from 0 to 11 for an extended CP. Invalid symbols may be configured to be symbols 6 and 7 of slot n+1. In this case, in order to determine an actual PUSCH, a last symbol of the second nominal PUSCH (nominal #2) may be excluded, and a first symbol of the third nominal PUSCH (nominal #3) may be excluded. The first nominal PUSCH (nominal #1) may be divided into two actually transmitted actual PUSCHs (actual #1 and actual #2) by a slot boundary. Each of the second nominal PUSCH (nominal #2) and the third nominal PUSCH (nominal #3) may be distinguished into one actual PUSCH (actual #3 and actual #4) by combining consecutive symbols except for an invalid symbol. Finally, the fourth nominal PUSCH (nominal #4) is divided into two actually transmitted (actual) PUSCHs (actual #5 and actual #6) by a slot boundary. The terminal finally transmits actually transmitted (actual) PUSCHs. One actual PUSCH should include at least one DMRS symbol. Accordingly, when repeated PUSCH transmission type B is configure, if a total length of the actual PUSCH is one symbol, the actual PUSCH may be omitted without being transmitted. This is because the actual PUSCH with one symbol may not include information other than a DMRS.

In order to obtain diversity gain in the frequency domain, frequency hopping may be configured for uplink channel transmission.

For repeated PUSCH transmission type A, one of intra-slot frequency hopping, in which frequency hopping is performed within a slot, and inter-slot frequency hopping, in which frequency hopping is performed in each slot, may be configured for the terminal. If intra-slot frequency hopping is configured for the terminal, the terminal may divide the PUSCH in half in the time domain in a slot for transmitting the PUSCH and transmit one half of the PUSCH in a scheduled PRB, and may transmit the other half in a PRB obtained by adding an offset value to the scheduled PRB. In this case, two or four offset values may be configured according to an active BWP size via a higher layer, and one of the values may be configured for (indicated to) the terminal via DCI. If inter-slot frequency hopping is configured for the terminal, the terminal may transmit the PUSCH in a scheduled PRB in a slot having an even-numbered slot index, and may transmit the PUSCH in a PRB obtained by adding an offset value to the scheduled PRB in an odd-numbered slot.

For repeated PUSCH transmission type B, one of inter-repetition frequency hopping, in which frequency hopping is performed at a nominal PUSCH boundary, and inter-slot frequency hopping, in which frequency hopping is performed in every slot, may be configured for the terminal. If inter-repetition frequency hopping is configured for the terminal, the terminal may transmit actual PUSCH(s) corresponding to an odd-numbered nominal PUSCH on a scheduled PRB, and the terminal may transmit actual PUSCH(s) corresponding to an even-numbered nominal PUSCH on a PRB obtained by adding an offset value to the scheduled PRB. In this case, two or four offset values may be configured according to an active BWP size via a higher layer, and one of the values may be configured for (indicated to) the terminal via DCI. If inter-slot frequency hopping is configured for the terminal, the terminal may transmit the PUSCH in a scheduled PRB in a slot having an even-numbered slot index, and may transmit the PUSCH in a PRB obtained by adding an offset value to the scheduled PRB in an odd-numbered slot.

When the terminal performs repeated PUSCH transmission, if a symbol scheduled for PUSCH transmission in a specific slot overlaps with a semi-statically configured DL symbol or a symbol configured for reception of an SS/PBCH block, the terminal may not transmit an overlapping PUSCH on a slot including the overlapping symbol. In addition, the overlapping PUSCH may be delayed and may not be transmitted even on a subsequent slot.

If the terminal receives DCI of DCI format 1_0, 1_1, or 1_2 for PUCCH scheduling, the terminal needs to transmit a PUCCH to the base station. In this case, the PUCCH may include uplink control information (UCI), and UCI may include at least one of HARQ-ACK, a scheduling request (SR), and channel state information (CSI). HARQ-ACK may be HARQ-ACK indicating whether the terminal has successfully received two types of channels. A first type may be HARQ-ACK for a PDSCH when the terminal is scheduled with the PDSCH via DCI of DCI format 1_0, 1_1, or 1_2. A second type may be HARQ-ACK for DCI when the DCI of DCI format 1_0, 1_1, or 1_2 is DCI indicating release of a semi-persistently scheduled (SPS) PDSCH. For PUCCH transmission including HARQ-ACK, a “PDSCH-to-HARQ feedback timing indicator” field of DCI may indicate K1 which is information (value) for a slot in which the scheduled PUCCH is transmitted. Here, K1 may be a non-negative integer value. DCI of DCI format 1_0 may indicate one of {0, 1, 2, 3, 4, 5, 6, 7}as a K1 value. The K1 value that can be indicated in DCI of DCI format 1_1 or 1_2 may be set (configured) from a higher layer.

A method of determining a slot in which a PUCCH including a first type HARQ-ACK is transmitted will be described. An uplink slot overlapping with a last symbol in which a PDSCH corresponding to HARQ-ACK is transmitted may exist. In this case, if an index of the overlapping uplink slot is m, the terminal may transmit a PUCCH including HARQ-ACK on slot m+K1. The index of the uplink slot may be a value determined based on a subcarrier spacing of a BWP in which the PUCCH is transmitted. If the terminal is configured with downlink slot aggregation, a last symbol in which a PDSCH is transmitted may refer to a last scheduled symbol within a last slot among slots in which the PDSCH is transmitted.

### Method of Determining a Transport Block Size (TBS) For PUSCH Transmission>

FIG. 15 and FIG. 16 illustrate RE mapping of a physical uplink shared channel according to an embodiment of the present disclosure.

PUSCH transmission may be scheduled for a UE by a base station via one of the following methods.
PUSCH scheduled by random-access response (PAR) UL grant of a UE
PUSCH scheduled by fall-back RAR UL grant
PUSCH scheduled by DCI format 0_0 having a CRC scrambled by a C-RNTI, an MCS-C-RNTI, a TC-RNTI, or a CS-RNTI
PUSCH scheduled by DCI format 0_1/DCI format 0_2 having a CRC scrambled by a C-RNTI, an MCS-C-RNTI, or a CS-RNTI
PUSCH by configured grant
MsgA PUSCH

For such a PUSCH, one value among indexes of a modulation and coding scheme (MCS) table may be configured or indicated as I_{MCS} for the UE by the base station.

In the following cases, the UE may acquire a TBS via a method described below.
a case where a configured or indicated MCS table index value satisfies 0<=I_{MCS}<=27, transform precoding is “disable”, and MCS table 5.1.3.1-2 of 3GPP TS38.214 v16.3.0 (2020-09) is used
a case where 0<=I_{MCS}<=28, transform precoding is “disable”, and an MCS table other than table 5.1.3.1-2 of 3GPP TS38.214 v16.3.0 (2020-09) is used
a case where 0<=I_{MCS}<=27, and transform precoding is “enable”

According to the following procedures, the UE may determine the number of resource elements (REs) in one slot for a PUSCH when a repetitive transmission type for repetitive PUSCH transmission is configured to be type A, and may determine the number of REs in one nominal PUSCH when repetitive PUSCH transmission type B is configured.

First, the UE may calculate the number N′_{RE} of REs per PRB of an allocated PUSCH according to the following equation.

$${N}_{RE}^{′} = {N}_{SC}^{NB} * {N}_{symb}^{sh} - {N}_{DMRS}^{PRB} - {N}_{oh}^{PRB} ,$$

Here, N^{RB}_{SC}(=12) denotes the number of subcarriers per physical resource block (PRB) in the frequency domain, N^{sh}_{symb} denotes the number L of PUSCH symbols allocated in the time domain, N^{PRB}_{DMRS} denotes the number of DMRS REs per PRB, and N^{PRB}ₒₕ denotes the number of overhead REs configured from a higher layer, which is the same as a value (xOverhead) configured by the base station. Here, the value (xOverhead) configured by the base station may include one number among 0, 6, 12, and 18 per uplink or downlink.

For example, as illustrated in FIG. 15, when configuration is performed for the UE so that the number (L) of symbols is 14, a PUSCH mapping type is type B, one symbol DMRS is used, the number of additional DMRS symbols is 3, and a DMRS configuration type is type 1 (delta shift=0), and repetitive transmission and frequency hopping are not configured, the UE may calculate, via an RE mapping pattern of FIG. 15, the number of DMRS REs and PUSCH data per PRB as N′_{RE}=12*14-24-N^{PRB}ₒₕ. Here, when it is assumed that the number of overhead REs configured via a higher layer is assumed to be N^{PRB}ₒₕ=12, the number of PUSCH REs per PRB may be calculated as N_{RE}=12*14-24−12=132.

When the base station configures, for the UE, a value (xOverhead) indicating the number of overhead REs, a unit to which the value is applied may be at least one of the followings.
1) Overhead per RE or symbol: This may be interpreted as overhead per predetermined RE or symbol. Here, a predetermined RE or symbol may be a resource in a unit smaller than one slot or one nominal PUSCH. That is, the UE may determine that a value (xOverhead) indicating the number of overhead REs configured per predetermined RE or symbol in a time domain resource to which one TB has been assigned is applied.
2) Overhead per symbol set: This may be interpreted as overhead per single symbol set. Here, for repetitive PUSCH transmission type A, one symbol set may be one slot, and for repetitive PUSCH transmission type B, one symbol set may be one nominal PUSCH. That is, the UE may determine that a value (xOverhead) indicating the number of overhead REs configured per time domain resource to which one TB has been assigned is applied.
3) Overhead per slot: This may be interpreted as overhead per slot. The UE may determine that a value (xOverhead) indicating the number of overhead REs configured per slot in a time domain resource to which one TB has been assigned is applied.
4) Overhead per PUSCH for transmission of a TB: This may be interpreted as overhead per PUSCH for transmission of one TB. The UE may determine that a value (xOverhead) indicating the number of overhead REs configured for all time domain resources of a PUSCH to which one TB has been assigned is applied.
5) Overhead of a maximum PUSCH for transmission of a TB: This may be interpreted as overhead of a maximum PUSCH for transmission of one TB. Here, the maximum PUSCH for transmission of one TB refers to scheduling of a largest PUSCH via which the UE transmits one TB in the time domain. That is, the UE may determine that a value (xOverhead) indicating the number of overhead REs is applied as overhead for maximum PUSCH scheduling that may be configured.

Subsequently, the UE may calculate, using the following equation, the number of REs for transmission of the entire PUSCH in the frequency domain.

N_{RE}=min(156, N′_{RE})*n_{PRB}

Here, n_{PRB} denotes the number of PRBs for PUSCH transmission, which are allocated to the UE by the base station in the frequency domain. For example, as illustrated in FIG. 16, when the number of PUSCH PRBs allocated to the UE in the frequency domain is n_{PRB}=8, the UE may calculate a total number of PUSCH REs in the frequency domain as N_{RE}=min(156, 132)*8=1056.

Subsequently, the UE may calculate the number N_{info} of unquantized information bits, based on the following equation.

N_{info}=N_{RE}*R*Qₘ*v, where, R denotes a code rate, Qₘ denotes a modulation order, and v denotes the number of layers. The UE may determine a TBS according to a method different depending on a condition of the calculated N_{info}.

If N_{info}<=3824, the UE may calculates the number of quantized information bits as N′_{info}=max(24, 2ⁿ*floor (N_{info}/2ⁿ)). Here, n=max(3, floor(log₂(N_{info}))-6). Subsequently, the UE may determine, using Table 4 below, the TBS of the PUSCH to be a TBS value which is closest to but not smaller than N′info.

TABLE 4

| Index | TBS |
|---|---|
| 1 | 24 |
| 2 | 32 |
| 3 | 40 |
| 4 | 48 |
| 5 | 56 |
| 6 | 64 |
| 7 | 72 |
| 8 | 80 |
| 9 | 88 |
| 10 | 96 |
| 11 | 104 |
| 12 | 112 |
| 13 | 120 |
| 14 | 128 |
| 15 | 136 |
| 16 | 144 |
| 17 | 152 |
| 18 | 160 |
| 19 | 168 |
| 20 | 176 |
| 21 | 184 |
| 22 | 192 |
| 23 | 208 |
| 24 | 224 |
| 25 | 240 |
| 26 | 256 |
| 27 | 272 |
| 28 | 288 |
| 29 | 304 |
| 30 | 320 |
| 31 | 336 |
| 32 | 352 |
| 33 | 368 |
| 34 | 384 |
| 35 | 408 |
| 36 | 432 |
| 37 | 456 |
| 38 | 480 |
| 39 | 504 |
| 40 | 528 |
| 41 | 552 |
| 42 | 576 |
| 43 | 608 |
| 44 | 640 |
| 45 | 672 |
| 46 | 704 |
| 47 | 736 |
| 48 | 768 |
| 49 | 808 |
| 50 | 848 |
| 51 | 888 |
| 52 | 928 |
| 53 | 984 |
| 54 | 1032 |
| 55 | 1064 |
| 56 | 1128 |
| 57 | 1160 |
| 58 | 1192 |
| 59 | 1224 |
| 60 | 1256 |
| 61 | 1288 |
| 62 | 1320 |
| 63 | 1352 |
| 64 | 1416 |
| 65 | 1480 |
| 66 | 1544 |
| 67 | 1608 |
| 68 | 1672 |
| 69 | 1736 |
| 70 | 1800 |
| 71 | 1864 |
| 72 | 1928 |
| 73 | 2024 |
| 74 | 2088 |
| 75 | 2152 |
| 76 | 2216 |
| 77 | 2280 |
| 78 | 2408 |
| 79 | 2472 |
| 80 | 2536 |
| 81 | 2600 |
| 82 | 2664 |
| 83 | 2728 |
| 84 | 2792 |
| 85 | 2856 |
| 86 | 2976 |
| 87 | 3104 |
| 88 | 3240 |
| 89 | 3368 |
| 90 | 3496 |
| 91 | 3624 |
| 92 | 3752 |
| 93 | 3824 |

Table 4 shows an example of a TBS when N_{info}<=3824.

If N_{info}>3824, the UE calculates the number of quantized information bits as N′_{info}=max(3840, 2ⁿ*round ((N_{info}−24)/2ⁿ)). Here, n=floor (log₂(N_{info}−24))−5.

When a configured or indicated code rate R of the PUSCH is smaller than or equal to ¼, the UE determines a PUSCH TBS based on the following equation.

$$TBS = 8 * C * ceil ( ( {N}_{info}^{′} + 24 ) / 8 * C ) - 24$$

Here, C=ceil ((N′_{info}+24)/3816). ceil (x) denotes a smallest integer among numbers larger than or equal to x. When the configured or indicated code rate R of the PUSCH is greater than ¼, the UE determines a PUSCH TBS based on the following equation.

$$If {N}_{info}^{′} > 8424 , TBS = 8 * C * ceil ( ( {N}_{info}^{′} + 24 ) / 8 * C ) - 24. Here ,$$

$$C = ceil ( ( {N}_{info}^{′} + 24 ) / 8424.$$

$$If {N}_{info}^{′} <= 8424 , TBS = 8 * ceil ( ( {N}_{info}^{′} + 24 ) / 8 ) - 24.$$

If an MCS table index value configured or indicated by the base station satisfies 28<=I_{MCS}<=31, transform precoding is “disable”, and MCS table 5.1.3.1-2 of 3GPP TS38.214 v16.3.0 (2020-09) is used, or if 28<=I_{MCS}<=31 and transform precoding is “enable”, a TBS determination method is as follows.

The UE may consider that a TBS is determined in DCI received via the most recent PDCCH for the same TB where 0<=I_{MCS}<=27.

If a PDCCH for the same TB where 0<=I_{MCS}<=27 is not received, and initial PUSCH transmission for the same TB is based on a configured grant, a TBS is determined based on the following conditions. For a configured grant Type-1 PUSCH, the UE determines, as a TBS, a value configured from a higher layer. For a configured grant Type-2 PUSCH, the UE determines a TBS based on information in the most recently received PDCCH for scheduling of the configured grant Type-2 PUSCH.

When an I_{MCS} which is a configured or indicated MCS table index value, whether transform precoding is “enable”, and an applied MCS table are not included in the above-described conditions, a TBS may be determined according to the following method.

The UE may consider that a TBS is determined in DCI received via the most recent PDCCH for the same TB where 0<=I_{MCS}<=28.

If a PDCCH for the same TB where 0<=I_{MCS}<=28 is not received, and initial PUSCH transmission for the same TB is based on a configured grant, the UE determines a TBS based on each condition as follows.
For a configured grant Type-1 PUSCH, the UE may determine, as a TBS, a value configured from a higher layer.
For a configured grant Type-2 PUSCH, the UE determines a TBS based on information in the most recently received PDCCH for scheduling of the configured grant Type-2 PUSCH.

As illustrated above, for repetitive PUSCH transmission type A, the UE may determine a TBS according to a configured overhead amount, the number of REs used for a DMRS, and the number of symbols indicated or configured for transmission in each slot. The UE may repeatedly transmit, in each slot, one TB determined by the TBS. Here, the TB transmitted in each slot may have an identical redundancy version (RV) value or different RV values.

In addition, for repetitive PUSCH transmission type B, the UE may determine a TBS based on the number of symbols occupied by each nominal repetition, the number of REs used for a DMRS according to the number of symbols for the nominal repetition, or a configured overhead amount. The UE may repeatedly transmit one TB determined based on the TBS in each symbol(s) considered for actual repetition. Here, the TB transmitted in each symbol(s) considered for actual repetition may have an identical redundancy version (RV) value or different RV values. Here, the nominal repetition may be divided as one actual repetition or multiple actual repetitions, which has been described with reference to FIG. 14B.

Problem solving in the present disclosure is to solve problems that occur in the TBS determination method and repetitive TB transmission scheme. More specifically, for the repetitive PUSCH transmission type A or repetitive PUSCH transmission type B, a TBS is determined based on one slot or one nominal repetition, and a TB based on the TBS is repetitively transmitted in multiple slots or symbol(s) considered for multiple actual repetitions, respectively. In this case, the TBS for the PUSCH is small, and the UE repetitively transmits the small-sized TB multiple times. However, in a specific case, this scheme may cause a problem. For example, due to insufficient uplink coverage of the UE, the base station may allocate a small number of PRBs to the UE so that the UE transmits a PUSCH at high power per RE. In this case, since the TBS for the UE is very small, it is difficult to obtain sufficient coding gain. Therefore, repetitive transmission of the very small TBS may be inefficient.

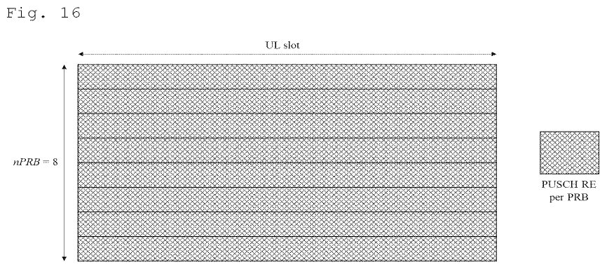

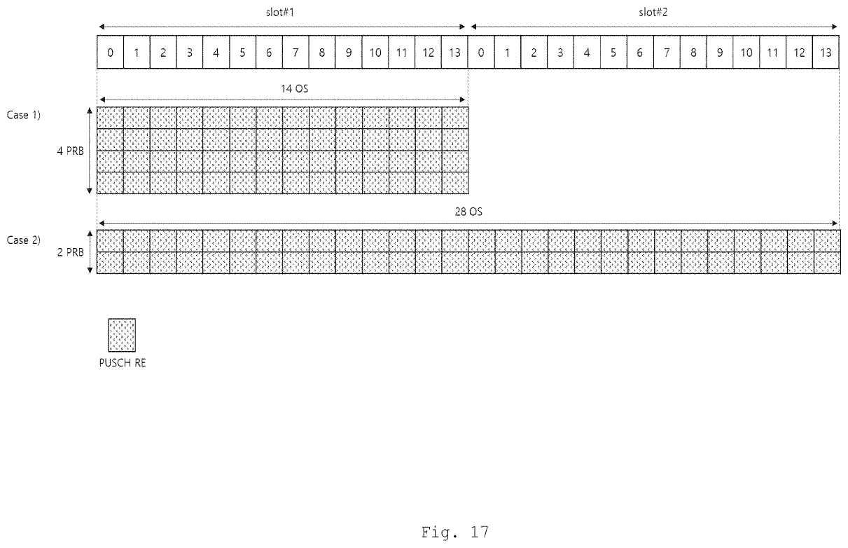

FIG. 17 illustrates a method of determining a transport block size (TBS) by a UE, based on one slot or one nominal PUSCH.

FIG. 17 illustrates resource allocation for PUSCH transmission. In case 1 of FIG. 17, one slot (14 symbols) in the time domain and 4 PRBs in the frequency domain are allocated to a UE for PUSCH transmission. In case 2, two slots (28 symbols) in the time domain and 2 PRBs in the frequency domain are allocated to the UE for PUSCH transmission. The number of REs in case 1 and the number of REs in case 2 (disregarding the number of REs used for a DM-RS and the number of REs used for overhead) are the same, which corresponds 12*14*4=12*28*2=12*56=672. However, in case 1, a larger number of PRBs are allocated in the frequency domain, and thus the maximum power per RE for case 2 may be higher than that for case 1. That is, case 2 may have higher coverage than case 1.

However, as described above, a TBS is generated based on one slot or one nominal repetition. In case 1 of FIG. 17, one slot (14 symbols) is used for PUSCH transmission, and in case 2, two slots (14*2 symbols) are used for PUSCH transmission. Therefore, the number of REs for determination of a TBS (disregarding the number of REs used for a DMRS and the number of REs used for overhead) may be given as 12*14*4 for case 1, and may be given as 12*14*2 for case 2. Accordingly, for case 2, a lower TBS is given compared to case 1. Therefore, it is impossible to obtain higher coverage while maintaining the same TBS.

Hereinafter, a description will be provided for a TBS calculation method to overcome such a problem. In this case, for repetitive PUSCH transmission type A or repetitive PUSCH transmission type B, the UE may determine a TBS based on multiple slots or multiple nominal repetitions, may generate a TB based on the TBS, and may map the TB to the multiple slots or multiple nominal repetitions to perform transmission. Here, the generated TB may be additionally repeated and transmitted. Hereinafter, unless otherwise mentioned, a description of repetitive transmission may be omitted in the present disclosure.

Hereinafter, a repetitive PUSCH transmission method will be described.

FIG. 18 illustrates resource allocation for multiple slots based on repetitive PUSCH transmission type A according to an embodiment of the present disclosure.

Referring to FIG. 18, a UE may repetitively transmit a PUSCH to a base station via a slot configured based on repetitive PUSCH transmission type A.

Specifically, the UE may be configured or indicated with a symbol length and an index of a start symbol to be used for PUSCH transmission in each slot. In addition, the UE may be configured or indicated with the number of slots to be used for PUSCH transmission. For example, as illustrated in FIG. 18, the UE may be configured or indicated so that a start symbol to be used for PUSCH transmission in each slot is 0, a symbol length is 10, and the number of slots to be used for PUSCH transmission is 2.

For reference, the number of slots to be used for PUSCH transmission may be the same as or different from the number of repetition slots in repetitive PUSCH transmission type A. If the number of repetition slots for repetitive PUSCH transmission type A is the same as the number of slots to be used for the PUSCH transmission, the UE may transmit a PUSCH according to the number of slots to be used for the PUSCH transmission. If the number of repetition slots of repetitive PUSCH transmission type A is greater than the number of slots to be used for transmission of the PUSCH, the UE may repeatedly transmit the PUSCH according to the number of slots to be used for the PUSCH transmission. In this case, the number of slots used for repetitive transmission may be the same as the number of repetition slots for repetitive PUSCH transmission type A.

Based on an indication or configuration, the UE may determine a symbol set available for each slot. That is, based on the number of slots for PUSCH transmission, the start symbol, and the symbol length in each slot, which are configured by the base station, the UE may recognize a set of symbols to be used in each symbol for PUSCH transmission.

For example, as illustrated in FIG. 18, when the number of slots for PUSCH transmission is “2”, an index of a start symbol is “0”, and a symbol length is “10”, the UE may determine that 10 symbols from a first symbol in a first slot is a first symbol set for the PUSCH transmission, and then 10 symbols from a first symbol in a second slot is a second symbol set for the PUSCH transmission.

The UE may perform PUSCH transmission based on the determined symbol sets of respective slots. That is, the UE may perform repetitive PUSCH transmission using symbols allocated in the first slot and the second slot.

Detailed PUSCH transmission operations may include at least the following operations.

In operation 1, the UE may determine a TBS based on the symbols sets of the slots.

In operation 2, the UE may generate a TB based on the determined TBS.

In operation 3, the UE may arrange (map), on the symbol sets, modulation symbols generated by encoding the TB.

In operation 4, the UE may transmit the arranged (mapped) modulation symbols according to a CP-OFDM or DFT-s-OFDM scheme.

Here, for each symbol set in each slot, a DM-RS symbol may be selected based on a length of a corresponding symbol set. A DM-RS may be arranged (mapped) on REs of the DM-RS symbol.

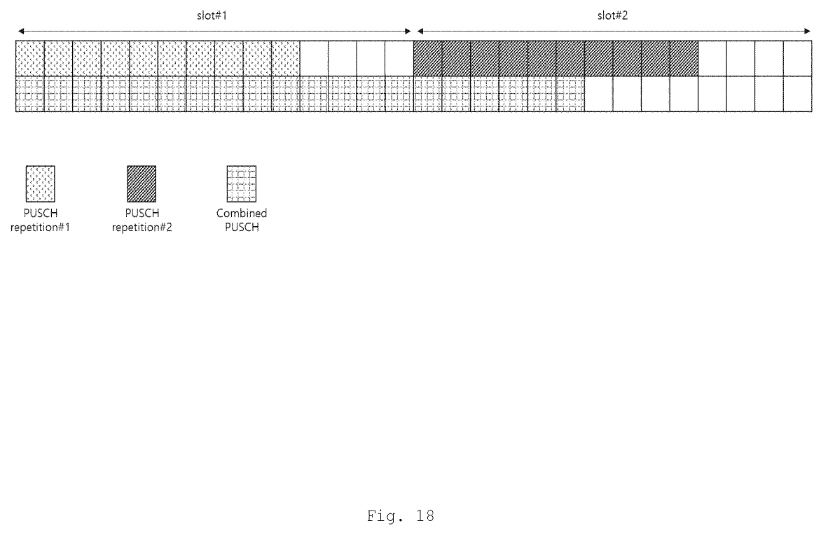

FIG. 19 illustrates resource allocation for multiple nominal PUSCHs based on repetitive PUSCH transmission type B according to an embodiment of the present disclosure.

Referring to FIG. 19, a UE may perform repetitive PUSCH transmission to a base station via a slot configured based on repetitive PUSCH transmission type B.

The UE may be configured or indicated with an index of a start symbol and a symbol length for a first nominal repetition. In addition, the number of nominal repetitions to be used for PUSCH transmission may be configured or indicated for the UE. For example, as illustrated in FIG. 19, the UE may be configured or indicated with a start symbol, a symbol length, and the number of repetitive transmissions (and/or the number of slots for repetitive transmission, etc.) for repetitive PUSCH transmission, by a base station via RRC configuration information and/or downlink control information (DCI) of a PDCCH. FIG. 19 illustrates symbols that each nominal repetition occupies when it is configured or indicated that a first nominal repetition starts at a sixth symbol, a length of symbols is 4, and the number of nominal repetitions is 4.

For reference, the number of nominal repetitions to be used for PUSCH transmission may be the same as or different from the number of nominal repetitions in repetitive PUSCH transmission type B. If the number of nominal repetitions in repetitive PUSCH transmission type B is the same as the number of nominal repetitions to be used for the PUSCH transmission, the UE may transmit a PUSCH according to the number of nominal repetitions to be used for the PUSCH transmission. If the number of nominal repetitions of repetitive PUSCH transmission type B is greater than the number of nominal repetitions to be used for the PUSCH transmission, the UE may transmit the PUSCH according to the number of nominal repetitions to be used for the PUSCH transmission. In this case, the number of nominal repetitions used for repetitive transmission may be the same as the number of repetitions of repetitive PUSCH transmission type B.

Based on the indication or configuration, the UE may determine a symbol set to be used for each nominal repetition. For example, as illustrated in FIG. 19, 4 symbols from a sixth symbol in a first slot (slot #1) is a first symbol set, 4 symbols from a tenth symbol is a second symbol set, 4 symbols from a fourteenth symbol is a third symbol set, and 4 symbols from a fourth symbol in a second slot (slot #2) is a fourth symbol set. Here, when a symbol that a nominal repetition occupies is an invalid symbol, the symbol(s) may be excluded from a valid symbol set.

The UE may perform PUSCH transmission based on the symbol sets of the nominal repetitions. Detailed PUSCH transmission operations may include at least the following operations.

In operation 1, the UE may determine a TBS based on symbols sets of the nominal repetitions.

In operation 2, the UE may generate a TB based on the determined TBS.

In operation 3, the UE may arrange (map), on each symbol set, modulation symbols generated by encoding the TB.

In operation 4, the UE may transmit the arranged (mapped) modulation symbols according to a CP-OFDM or DFT-s-OFDM scheme.

Here, for each symbol set in each nominal repetition, a DM-RS symbol may be selected based on a length of a corresponding symbol set. Alternatively, each symbol set in each nominal repetition may be divided again into symbol sets including consecutive symbols, and based on a length of this symbol set, a DM-RS symbol may be selected. Here, the procedure of dividing a symbol set again into symbol sets including consecutive symbols, may be the same as the procedure of dividing a nominal repetition into actual repetitions, which has been described with reference to FIG. 14B. A DM-RS may be arranged (mapped) on REs of the DM-RS symbol.

Subsequently, a description is provided for a detailed embodiment in which a UE determines a TBS in PUSCH transmission based on repetitive PUSCH transmission type A and in PUSCH transmission based on repetitive PUSCH transmission type B. This corresponds to operation 1 described above.

A first embodiment of the present disclosure is provided as follows.

For repetitive PUSCH transmission type A, the UE may determine a TBS based on symbol sets of slots in which a PUSCH is transmitted, when calculating the number of REs per PRB (N′_{RE}=N^{RB}_{SC}*N^{sh}_{symb}-N^{PRB}_{DMRS}-N^{PRB}ₒₕ). For repetitive PUSCH transmission type B, the UE may determine a TBS based on symbol sets of nominal repetitions in which a PUSCH is transmitted, when calculating the number of REs per PRB (N′_{RE}=N^{RB}_{SC}*N^{sh}_{symb}-N^{PRB}_{DMRS}-N^{PRB}ₒₕ). Hereinafter, the number of REs per PRB, which is used for determining a TBS based on symbol sets, is referred to as N′_{RE,total}. A method of calculating N′_{RE,total} by the UE may include the following.

According to a zeroth method, the UE may obtain the number of REs per PRB, which is based on a first symbol set among multiple symbol sets. More specifically, calculation may be performed as N′_{RE,total}=N^{RB}_{SC}*N^{sh}_{symb}-N^{PRB}_{DMRS}N^{PRB}ₒₕ. Here, N^{RB}_{SC}=12, N^{sh}_{symb} denotes the number of symbols included in the first symbol set, N^{PRB}_{DMRS} denotes the number of DMRS REs included in the first symbol set, and N^{PRB}ₒₕ denotes an overhead value.

Here, the first symbol set may be the foremost symbol set among the multiple symbol sets. For reference, in the first method, although any one of the multiple symbol sets is considered as the first symbol set, N′_{RE,total} may have the same value.

For reference, when the first symbol set is the foremost symbol set among the multiple symbol sets, N′_{RE,total} may be the same as N′_{RE} described above.

According to a first method, the UE may obtain N′_{RE,total} by scaling the number of REs per PRB, which is obtained based on the first symbol set among the multiple symbol sets. Here, during the scaling, an overhead value may be included. More specifically, calculation may be performed as N′_{RE,total}=N′_{RE}*K=(N^{RB}_{SC}*N^{sh}_{symb} (1)−N^{PRB}_{DMRS} (1) N^{PRB}ₒₕ(1))*K.

Here, N^{RB}_{SC}=12, N^{sh}_{symb}(1) denotes the number of symbols included in the first symbol set, N^{PRB}_{DMRS} (1) denotes the number of DMRS REs included in the first symbol set, and N^{PRB}ₒₕ(1) denotes an overhead value of the first symbol set.

Here, the number of symbols included in the first symbol set is the same as the number of symbols allocated in one slot for PUSCH transmission in case of repetitive PUSCH transmission type A, and the number of symbols included in the first symbol set is the same as the number of symbols allocated in one nominal repetition in case of repetitive PUSCH transmission type B.

Here, the first symbol set may be the foremost symbol set among the multiple symbol sets. For reference, in the first method, although any one of the multiple symbol sets is considered as the first symbol set, N′_{RE,total} may have the same value.

Here, K denotes the number of slots to be used for PUSCH transmission in case of repetitive PUSCH transmission type A, and K denotes the number of nominal repetitions to be used for PUSCH transmission in case of repetitive PUSCH transmission type B.

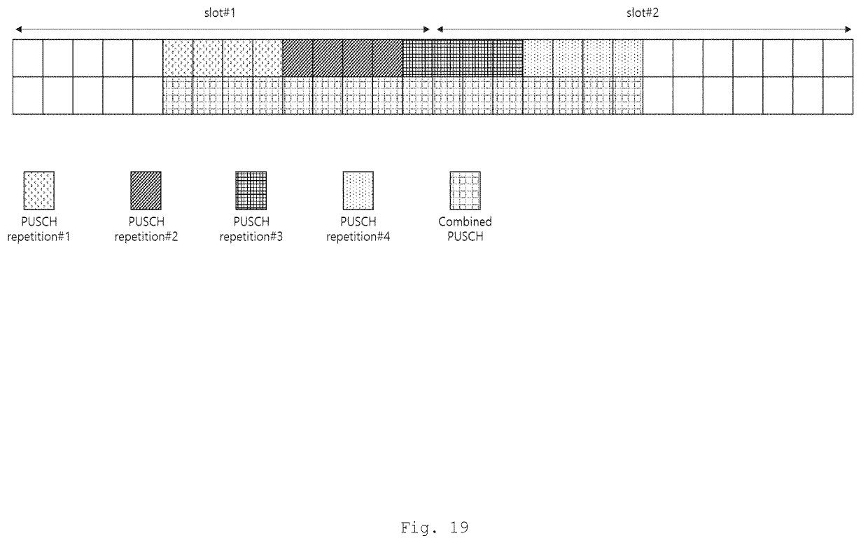

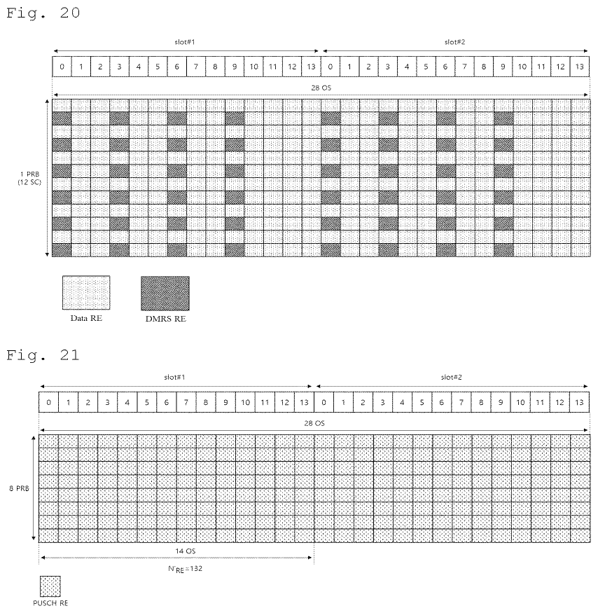

FIG. 20 and FIG. 21 illustrate a method of determining a TBS for multiple slots or multiple nominal PUSCHs according to an embodiment of the present disclosure.

FIG. 20 and FIG. 21 illustrate a method of determining a TBS for a nominal PUSCH when a repetitive PUSCH transmission type is A. In FIG. 20 and FIG. 21, K is “2”, a first symbol set is 14 symbols in a first slot (slot #1), and a second symbol set is 14 symbol sets in a second slot (slot #2). When it is assumed that the first symbol set is used as a symbol set to be used first and N^{PRB}ₒₕ=12, N′_{RE,total}=(N^{RB}_{SC}*N^{sh}_{symb} (1)−N^{PRB}_{DMRS} (1) N^{PRB}ₒₕ(1))*K=(12*14-24-12)*2=264 may be satisfied.

In this case, N^{PRB}ₒₕ(1) may be obtained via the following methods.

According to a (1-0)th method, N^{PRB}ₒₕ (1) may be a value configured for a UE by a base station. For example, the base station may configure, for the UE, one value among 6, 12, 18, and the like, and the UE may consider the value as N^{PRB}ₒₕ (1).

According to a (1-1)st method, an overhead value (N^{PRB}ₒₕ(1)) of the first symbol set may be obtained by separately scaling a value (xOverhead) configured for the UE by the base station. A scaling method may differ depending on a unit to which the value (xOverhead) configured for the UE by the base station is applied. The unit may be at least one of overhead per specific RE or symbol, overhead per symbol set, overhead per slot, overhead per TB, and overhead of maximum PUSCH scheduling per TB.

1) Overhead per RE or symbol: The UE may consider a value (xOverhead) configured for the UE by the base station, as an overhead value per RE or symbol.

If consideration is made as an overhead value per symbol, N^{PRB}ₒₕ (1)=f(xOverhead*N^{sh}_{symb} (1)) may be determined. This is based on scaling xOverhead by using the number (N^{sh}_{symb}(1)) of symbols in the first symbol set.

If consideration is made as an overhead value per RE, N^{PRB}ₒₕ (1)=f(xOverhead*(N^{RB}_{SC}*N^{sh}_{symb} (1))) may be determined. This is based on scaling xOverhead by using the number (N^{RB}_{SC}*N^{sh}_{symb}(1)) of REs in the first symbol set.

If consideration is made as an overhead value per RE excluding a DMRS, N^{PRB}ₒₕ (1)=f(xOverhead*(N^{RB}_{SC}*N^{sh}_{symb} (1)-N^{PRB}_{DMRS} (1))) may be determined. This is based on scaling xOverhead by using the number (N^{RB}_{SC}*N^{sh}_{symb} (1)−N^{PRB}_{DMRS} (1)) of REs excluding a DMRS in the first symbol set.

2) Overhead per symbol set: The UE may consider a value (xOverhead) configured for the UE by the base station, as an overhead value of a symbol set in which a PUSCH is transmitted.

In this case, for N^{PRB}ₒₕ(1), the overhead value of the symbol set may be used. That is, N^{PRB}ₒₕ (1)=xOverhead may be satisfied.

In this case, for N^{PRB}ₒₕ(1), the overhead value of the symbol set may be converted to an overhead value of a slot so as to be used. That is, when the first symbol set includes N^{sh}_{symb} (1) symbols, N^{PRB}ₒₕ (1) f(xOverhead*N^{slot}_{symb}/N^{sh}_{symb}(1)) may be determined. Here, N^{slot}_{symb} denotes the number of symbols included in one slot.

3) Overhead per slot: The UE may consider a value (xOverhead) configured for the UE by the base station, as an overhead value of a slot.

In this case, for N^{PRB}ₒₕ(1), the overhead value of the symbol set may be used. That is, N^{PRB}ₒₕ(1)=xOverhead may be satisfied.

In this case, for N^{PRB}ₒₕ(1), the overhead value of the slot may be converted to an overhead value of a symbol set so as to be used. That is, when the first symbol set includes N^{sh}_{symb} (1) symbols, N^{PRB}ₒₕ (1) f(xOverhead*N^{sh}_{symb} (1)/N^{slot}_{symb}) may be determined.

4) Overhead per PUSCH for transmission of a TB: The UE may consider a value (xOverhead) configured for the UE by the base station, as an overhead value of a PUSCH for transmission of a TB.

When it is assumed that all symbol sets have the same number of symbols, the overhead value (N^{PRB}ₒₕ (1)) of the first symbol set may be obtained by dividing the value (xOverhead), which the base station configures for the UE, by the number of symbol sets. When the total number of symbol sets is K, N^{PRB}ₒₕ (1)=f(xOverhead/K) may be determined.

When it is assumed that each symbol set has a different number of symbols, the overhead value (N^{PRB}ₒₕ(1)) of the first symbol set may be determined based on the value (xOverhead) configured for the UE by the base station and a ratio of the number of symbols included in the first symbol set to the total number of symbols. Here, when is the number of symbols included in symbol set i, the total number of symbols may be. Therefore, N^{PRB}ₒₕ(1) may be calculated via Equation 1 below.

$${N}_{oh}^{PRB} ( 1 ) = f ( xOverhead * ( {N}_{symb}^{sh} ( 1 ) ) / ( {\sum }_{i = 1}^{K} {N}_{symb}^{sh} ( i ) ) ) \qquad [ Equation 1 ]$$

The UE may consider a value (xOverhead) configured for the UE by the base station, as an overhead value of REs excluding a DMRS of a PUSCH for transmission of a TB. The overhead value (N^{PRB}ₒₕ (1)) of the first symbol set may be determined based on the value (xOverhead) configured for the UE by the base station and a ratio of the number of REs included in the first symbol set excluding a DMRS to the total number of REs of all symbol sets excluding a DMRS. The number of REs included in the first symbol set excluding a DRMS is N^{RB}_{SC}*N^{sh}_{symb} (1)−N^{PRB}_{DMRS} (1), and the total number of REs of all symbol sets excluding a DMRS is

$${\sum }_{i = 1}^{K} ( {N}_{SC}^{RB} * {N}_{symb}^{sh} ( i ) - {N}_{DMRS}^{PRB} ( i ) ) .$$

Therefore, in this case, N^{PRB}ₒₕ(1) may be calculated via Equation 2 below.

$${N}_{oh}^{PRB} ( 1 ) = f ( xOverhead * ( {N}_{SC}^{RB} * {N}_{symb}^{sh} ( 1 ) - {N}_{DMRS}^{PRB} ( 1 ) ) / {\sum }_{i = 1}^{K} {N}_{SC}^{RB} * {N}_{symb}^{sh} ( i ) - {N}_{DMRS}^{PRB} ( i ) ) ) \qquad [ Equation 2 ]$$

may be determined.

5) Overhead of a maximum PUSCH for transmission of a TB: The UE may consider a value (xOverhead) configured for the UE by the base station, as an overhead value of a maximum PUSCH for transmission of a TB.

When it is assumed that all symbol sets have the same number of symbols, the overhead value (N^{PRB}ₒₕ (1)) of the first symbol set may be obtained by dividing the value (xOverhead), which the base station configures for the UE, by the maximum number of symbol sets. Here, the maximum number of symbol sets may be the maximum number of symbol sets which may be scheduled during PUSCH scheduling. When the maximum number of symbol sets is Kₘₐₓ, N^{PRB}ₒₕ (1) may be calculated via Equation 3 below.

$${N}_{oh}^{PRB} ( 1 ) = f ( xOverhead / {K}_{max} ) \qquad [ Equation 3 ]$$

When it is assumed that each symbol set has a different number of symbols, the overhead value (N^{PRB}ₒₕ (1)) of the first symbol set may be determined based on the value (xOverhead) configured for the UE by the base station and a ratio of the number of symbols included in the first symbol set to the maximum number of symbols. Here, the maximum number of symbols may be the maximum number of symbols included in a symbol set which may be scheduled during PUSCH scheduling. When the maximum number of symbols is N^{sh}_{symb,max}, N^{PRB}ₒₕ (1) may be calculated via Equation 4 below.

$${N}_{oh}^{PRB} ( 1 ) = f ( xOverhead * {N}_{symb}^{sh} ( 1 ) / {N}_{symb , max}^{sh} ) \qquad [ Equation 4 ]$$

The UE may consider a value (xOverhead) configured for the UE by the base station, as an overhead value of REs excluding a DMRS of a PUSCH for transmission of a TB. The overhead value (N^{PRB}ₒₕ (1)) of the first symbol set may be determined based on the value (xOverhead) configured for the UE by the base station and a ratio of the number of REs included in the first symbol set excluding a DMRS to the maximum number of REs of all symbol sets excluding a DMRS. The number of REs included in the first symbol set, excluding a DMRS, may be N^{RB}_{SC}*N^{sh}_{symb} (1)−N^{PRB}_{DMRS} (1) Here, the maximum number of REs of all symbol sets excluding a DMRS may be the maximum number of REs included in a symbol set which may be scheduled, excluding a DMRS, during PUSCH scheduling. When the maximum number of REs is N_{RE,max}, N^{PRB}ₒₕ (1) may be calculated via Equation 5 below.

$${N}_{oh}^{PRB} ( 1 ) = f ( xOverhead * ( {N}_{SC}^{RB} * {N}_{symb}^{sh} ( 1 ) - {N}_{DMRS}^{PRB} ( 1 ) ) / {N}_{RE , max} ) \qquad [ Equation 5 ]$$

In the present disclosure, f(x) is at least one of ceil(x), floor(x), or round (x). ceil(x) indicates a smallest integer among numbers larger than or equal to x. floor(x) indicates a largest integer among numbers smaller than or equal to x. round(x) indicates an integer obtained by rounding off x.

According to the first method, when the overhead value configured for the UE can be fixed to 0, xOverhead may not be separately configured. In this case, N^{PRB}ₒₕ (1)=0 may be determined.

According to a second method, the UE may obtain N′_{RE,total} by scaling the number of REs per PRB, which is obtained based on the first symbol set among multiple symbol sets. Here, during the scaling, an overhead value (N^{PRB}ₒₕ) may be excluded. More specifically, calculation may be performed as N′_{RE,total}=(N^{RB}_{SC}*N^{sh}_{symb} (1)−N^{PRB}_{DMRS} (1))*K-N^{PRB}ₒₕ. Here, N^{RB}_{SC}=12, N^{sh}_{symb}(1) denotes the number of symbols included in the first symbol set, N^{PRB}_{DMRS} (1) denotes the number of DMRS REs included in the first symbol set, and N^{PRB}ₒₕ(1) denotes an overhead value of the first symbol set. For example, as illustrated in FIG. 20, when N^{PRB}ₒₕ=12, N′_{RE,total} may be calculated via Equation 6 below.

$${N}_{RE , total}^{′} = ( {N}_{SC}^{RB} * {N}_{symb}^{sh} ( 1 ) - {N}_{DMRS}^{PRB} ( 1 ) ) * K - {N}_{oh}^{PRB} = ( 12 * 14 - 24 ) * 2 - 12 = 276 \qquad [ Equation 6 ]$$

A method of obtaining N^{PRB}ₒₕ is as follows.

According to a (2-0)th method, N^{PRB}ₒₕ may be a value (xOverhead) configured for the UE by the base station. For example, the base station may configure one value among 6, 12, 18, and the like for the UE, and the UE may consider the value as N^{PRB}ₒₕ. For reference, the range of the value (xOverhead) configured by the base station may differ according to the number of slots scheduled by the base station, the number of symbol sets, the number of symbols included in a symbol set, or the like. For example, the value (xOverhead) configured by the base station may include values, such as 24, 30, and 36, in addition to 6, 12, and 18.

According to a (2-1)st method, an overhead value (N^{PRB}ₒₕ) may be obtained by separately scaling a value (xOverhead) configured for the UE by the base station. In the second method, it is indicated that an overhead value (N^{PRB}ₒₕ) is excluded during the scaling. However, this may indicate that scaling of the overhead value of the first symbol set is skipped. That is, the overhead value N^{PRB}ₒₕ may be obtained by performing scaling according to a method other than scaling of the first symbol set. A scaling method may differ depending on a unit to which the value (xOverhead) configured for the UE by the base station is applied. The unit may be at least one of overhead per specific RE or symbol, overhead per symbol set, overhead per slot, overhead per TB, or overhead of maximum PUSCH scheduling per TB.

1) Overhead per RE or symbol: The UE may consider a value (xOverhead) configured for the UE by the base station, as an overhead value per RE or symbol.

If the value is considered as an overhead value per symbol,

$${N}_{oh}^{PRB} = {\sum }_{i = 1}^{K} f ( xOverhead * {N}_{symb}^{sh} ( i ) )$$

$$or f ( {\sum }_{i = 1}^{K} xOverhead * {N}_{symb}^{sh} ( i ) )$$

may be determined. Here, K denotes the total number of symbol sets.

If the value is considered as an overhead value per RE,

$${N}_{oh}^{PRB} = {\sum }_{i = 1}^{K} f ( xOverhead * {N}_{SC}^{RB} * {N}_{symb}^{sh} ( i ) ) or$$

$$f ( {\sum }_{i = 1}^{K} xOverhead * {N}_{SC}^{RB} * {N}_{symb}^{sh} ( i ) )$$

may be determined.

If the value is considered as an overhead value per RE excluding a DMRS,

$${N}_{oh}^{PRB} = {\sum }_{i = 1}^{K} f ( xOverhead * ( {N}_{SC}^{RB} * {N}_{symb}^{sh} ( i ) - {N}_{DMRS}^{PRB} ) ) ) or$$

$$f ( {\sum }_{i = 1}^{K} xOverhead * ( {N}_{SC}^{RB} * {N}_{symb}^{sh} ( i ) - {N}_{DMRS}^{PRB} ( i ) ) )$$

may be determined.

2) Overhead per symbol set: The UE may consider a value (xOverhead) configured for the UE by the base station, as an overhead value of a symbol set in which a PUSCH is transmitted.

In this case, the overhead value (N^{PRB}ₒₕ) may be obtained by multiplying the value (xOverhead), which the base station configures for the UE, by the number of symbol sets. When the total number of symbol sets is K, N^{PRB}ₒₕ=f(xOverhead*K) may be determined.

In this case, for the overhead value (N^{PRB}ₒₕ), an overhead value of a symbol set may be converted to an overhead value of a slot so as to be used. That is,

$${N}_{oh}^{PRB} = {\sum }_{i = 1}^{K} f ( xOverhead * {N}_{symb}^{slot} / {N}_{symb}^{sh} ( i ) ) or$$

$$f ( {\sum }_{i = 1}^{K} xOverhead * {N}_{symb}^{slot} / {N}_{symb}^{sh} ( i ) )$$

may be determined. Here, N^{slot}_{symb} denotes the number of symbols included in one slot.

3) Overhead per slot: The UE may consider a value (xOverhead) configured for the UE by the base station, as an overhead value of a slot.

In this case, the overhead value (N^{PRB}ₒₕ) may be obtained by multiplying the value (xOverhead), which the base station configures for the UE, by the number of slots occupied by a PUSCH, via which a corresponding TB is transmitted, in the time domain. When the number of slots occupied in the time domain is K, N^{PRB}ₒₕ=f(xOverhead*K) may be determined.

In this case, for the overhead value (N^{PRB}ₒₕ), an overhead value of a slot may be converted to an overhead value of a symbol set so as to be used. That is,

$${N}_{oh}^{PRB} = {\sum }_{i = 1}^{K} f ( xOverhead * {N}_{symb}^{sh} ( i ) / {N}_{symb}^{slot} )$$

$$or f ( {\sum }_{i = 1}^{K} xOverhead * {N}_{symb}^{sh} ( i ) / {N}_{symb}^{slot} )$$

may be determined. Here, N^{slot}_{symb} denotes the number of symbols included in one slot.

4) Overhead per PUSCH for transmission of a TB: The UE may consider a value (xOverhead) configured for the UE by the base station, as an overhead value of a PUSCH for transmission of a TB.

In this case, for N^{PRB}ₒₕ, the overhead value of the PUSCH for transmission of a TB may be used. That is, N^{PRB}ₒₕ=xOverhead may be satisfied.

5) Overhead of a maximum PUSCH for transmission of a TB: The UE may consider a value (xOverhead) configured for the UE by the base station, as an overhead value of a maximum PUSCH for transmission of a TB.

When it is assumed that all symbol sets have the same number of symbols, the overhead value (N^{PRB}ₒₕ) may be obtained by dividing the value (xOverhead), which the base station configures for the UE, by the maximum number of symbol sets. Here, the maximum number of symbol sets may be the maximum number of symbol sets which may be scheduled during PUSCH scheduling. When the maximum number of symbol sets is Kₘₐₓ, N^{PRB}ₒₕ=f(xOverhead/Kₘₐₓ) may be determined.

When it is assumed that each symbol set has a different number of symbols, the overhead value (N^{PRB}ₒₕ) may be determined based on the value (xOverhead) configured for the UE by the base station and a ratio of an average number

$${\sum }_{i = 1}^{K} {N}_{symb}^{sh} ( i ) / K$$

of symbols included in each symbol set to the maximum number of symbols. Here, the maximum number of symbols may be the maximum number of symbols included in a symbol set which may be scheduled during PUSCH scheduling. When the maximum number of symbols is

$${N}_{symb , max}^{sh} , {N}_{oh}^{PRB} = f ( xOverhead * ( {\sum }_{i = 1}^{K} {\sum }_{symb}^{sh} ( i ) ) / K * {N}_{symb , max}^{sh} ) )$$

may be determined.

The UE may consider the value (xOverhead) configured for the UE by the base station, as an overhead value of REs excluding a DMRS of a PUSCH for transmission of a TB. The overhead value (N^{PRB}ₒₕ) may be determined based on the value (xOverhead) configured for the UE by the base station and a ratio of an average number of REs included in each symbol set excluding a DMRS to the maximum number of REs of all symbol sets excluding a DMRS. The average number of REs included in each symbol set, excluding a DMRS, may be

$${\sum }_{i = 1}^{K} ( {N}_{SC}^{RB} * {N}_{symb}^{sh} ( i ) - {N}_{DMRS}^{PRB} ( i ) ) / {N}_{SC}^{RB} * K ) .$$

Here, the maximum number of REs of all symbol sets excluding a DMRS may be the maximum number of REs included in a symbol set which may be scheduled, excluding a DMRS, during PUSCH scheduling. When the maximum number of REs is,

$${N}_{oh}^{PRB} = f ( xOverhead * {\sum }_{i = 1}^{K} ( {N}_{SC}^{RB} * {N}_{symb}^{sh} ( i ) - {N}_{DMRS}^{PRB} ( i ) ) / {N}_{SC}^{RB} * K * {N}_{RE , max} )$$

may be determined.

According to a (2-2)nd method, an overhead value based on the number of symbol sets used for PUSCH transmission may be configured for the UE by the base station. When the number of symbol sets is K, and the configured overhead value is

$${N}_{oh , K}^{PRB} ,$$

$${N}_{RE}^{′} = ( {N}_{SC}^{RB} * {N}_{symb}^{sh} ( 1 ) - {N}_{DMRS}^{PRB} ( 1 ) ) * K - {N}_{oh , K}^{PRB} K - {N}_{oh , K}^{PRB}$$

may be given. That is, here, each of

$${N}_{oh , 1}^{PRB} , {N}_{oh , 2}^{PRB} , … , {N}_{oh , K}^{PRB}$$

may be configured as a separate value by the base station.

According to a (2-3)rd method, an overhead value based on the number of symbols per symbol set used for PUSCH transmission may be configured for the UE by the base station. When the number of symbol sets is K, the number of symbols per symbol set is L, and a configured overhead value based on the number of symbols of each symbol set is

$${N}_{oh , K , L}^{PRB} , {N}_{RE}^{′} = ( {N}_{SC}^{RB} * {N}_{symb}^{sh} ( 1 ) - {N}_{DMRS}^{PRB} ( 1 ) ) * K - {N}_{oh , K , L}^{PRB}$$

may be given. That is, here, each of

$${N}_{oh , 1 , 1}^{PRB} , {N}_{oh , 1 , 2}^{PRB} , … , {N}_{oh , K , L}^{PRB}$$

may be configured as a separate value by the base station.

According to the second method, when the overhead value configured for the UE can be fixed to 0, xOverhead may not be separately configured. In this case, N^{PRB}ₒₕ=0 may be determined.

According to a third method, for N′_{RE,total}, the number of REs per PRB, which is obtained based on multiple symbol sets, may be obtained. More specifically, when the number of symbols included in an i-th symbol set is N^{sh}_{symb}(i), the number of DMRS REs of the i-th symbol set is N^{PRB}_{DMRS}(i), and an overhead value of the i-th symbol set is N^{PRB}ₒₕ(i),

$${N}_{RE , total}^{′} = {\sum }_{i = 1}^{K} ( {N}_{SC}^{RB} * {N}_{symb}^{sh} ( i ) - {N}_{DMRS}^{PRB} ( i ) - {N}_{oh}^{PRB} ( i ) )$$

may be calculated. Here, the overhead value N^{PRB}ₒₕ(i) may be the same in all symbol sets or may be different for each symbol set.

Here, K denotes the number of slots to be used for PUSCH transmission in case of repetitive PUSCH transmission type A, and K denotes the number of nominal repetitions to be used for PUSCH transmission in case of repetitive PUSCH transmission type B.

For reference, in the third method, when the number of symbols included in each symbol set is the same, that is, N^{sh}_{symb}(i)=N^{sh}_{symb}, the number of DMRS REs included in each symbol set is the same, that is, N^{PRB}_{DMRS}(i)=N^{PRB}_{DMRS}, and an overhead value of each symbol set is the same, that is, N^{PRB}ₒₕ(i)=N^{PRB}ₒₕ, this may be expressed as N′_{RE,total}=(N^{RB}_{SC}*N^{sh}_{symb}-N^{PRB}_{DMRS}-N^{PRB}ₒₕ)*K, which is the same as the first method. Therefore, the third method may be applicable when the number of symbols included in each symbol set is different, the number of DMRS REs included in each symbol set is different, or an overhead value of each symbol set is different.

For reference, in the third method, respective symbol sets may have different overhead values from each other. A method of determining a different overhead value N^{PRB}ₒₕ(i) of the i-th symbol set is as follows.

According to a (3-0)th method, an overhead value independent for each symbol set may be configured or indicated. In order to determine an overhead value N^{PRB}ₒₕ(i) of each symbol set for one PUSCH, an overhead value of each symbol set may be separately configured or indicated for the UE by the base station. That is, for K symbol sets, N^{PRB}ₒₕ (1), N^{PRB}ₒₕ (2), . . . , N^{PRB}ₒₕ (K) may be configured or indicated for the UE by the base station.

According to a (3-1)st method, an overhead value (N^{PRB}ₒₕ(i)) of the i-th symbol set may be obtained by separately scaling a value (xOverhead) configured for the UE by the base station. A scaling method may differ depending on a unit to which the value (xOverhead) configured for the UE by the base station is applied. The unit may be at least one of overhead per specific RE or symbol, overhead per symbol set, overhead per slot, overhead per TB, and overhead of maximum PUSCH scheduling per TB.

1) Overhead per RE or symbol: The UE may consider a value (xOverhead) configured for the UE by the base station, as an overhead value per RE or symbol.

If consideration is made as an overhead value per symbol, N^{PRB}ₒₕ (i)=f(xOverhead*N^{sh}_{symb} (i)) may be determined. This may be obtained by scaling xOverhead by using the number of symbols (N^{sh}_{symb}(i)) in the i-th symbol set.

If consideration is made as an overhead value per RE, N^{PRB}ₒₕ (i)=f(xOverhead*(N^{RB}_{SC}*N^{sh}_{symb} (i))) may be determined. This may be obtained by scaling xOverhead by using the number of REs (N^{RB}_{SC}*N^{sh}_{symb}(i)) in the i-th symbol set.

If consideration is made as an overhead value per RE excluding a DMRS, N^{PRB}ₒₕ (i)=f(xOverhead*(N^{RB}_{SC}*N^{sh}_{symb} (i)-N^{PRB}_{DMRS} (i))) may be determined. This may be obtained by scaling xOverhead by using the number of REs (N^{RB}_{SC}*N^{sh}_{symb}(i)-N^{PRB}_{DMRS}(i))), excluding a DMRS, in the i-th symbol set.

2) Overhead per symbol set: The UE may consider a value (xOverhead) configured for the UE by the base station, as an overhead value of a symbol set in which a PUSCH is transmitted.

In this case, for N^{PRB}ₒₕ(i), the overhead value of the symbol set may be used. That is, N^{sh}_{symb}(i)=xOverhead may be satisfied.

In this case, for N^{PRB}ₒₕ(i), the overhead value of the symbol set may be converted to an overhead value of a slot so as to be used. That is, when the i-th symbol set includes N^{sh}_{symb} (i) symbols, N^{PRB}ₒₕ (i)=f(xOverhead*N^{slot}_{symb}/N^{sh}_{symb}(i)) may be determined. In this case, N^{slot}_{symb} denotes the number of symbols included in one slot.

3) Overhead per slot: The UE may consider a value (xOverhead) configured for the UE by the base station, as an overhead value of a slot.

In this case, for N^{PRB}ₒₕ(i), the overhead value of the symbol set may be used. That is, N^{PRB}ₒₕ(i)=xOverhead may be satisfied.

In this case, for N^{PRB}ₒₕ(i), the overhead value of the slot may be converted to an overhead value of a symbol set so as to be used. That is, when the i-th symbol set includes N^{sh}_{symb}(i) symbols, N^{PRB}ₒₕ(i)=f(xOverhead*N^{sh}_{symb} (i)/N^{slot}_{symb}) may be determined.

4) Overhead per PUSCH for transmission of a TB: The UE may consider a value (xOverhead) configured for the UE by the base station, as an overhead value of a PUSCH for transmission of a TB.

When it is assumed that all symbol sets include the same number of symbols, the overhead value (N^{PRB}ₒₕ(i)) of the i-th symbol set may be obtained by dividing the value (xOverhead), which the base station configures for the UE, by the number of symbol sets. When the total number of symbol sets is K, N^{PRB}ₒₕ(i)=f(xOverhead/K) may be determined.

When it is assumed that each symbol set has a different number of symbols, the overhead value (N^{PRB}ₒₕ(i)) of the i-th symbol set may be determined based on the value (xOverhead) configured for the UE by the base station and a ratio of the number of symbols included in the i-th symbol set to the total number of symbols. Here, when is the number of symbols included in the i-th symbol set, the total number of symbols may be

$${\sum }_{n = 1}^{K} {N}_{symb}^{sh} ( n ) .$$

$$Therefore , {N}_{oh}^{PRB} ( i ) = f ( xOverhead * ( {N}_{symb}^{sh} ( i ) ) / ( {\sum }_{n = 1}^{K} {N}_{symb}^{sh} ( n ) ) )$$

may be determined.

The UE may consider the value (xOverhead) configured for the UE by the base station, as an overhead value of REs excluding a DMRS of a PUSCH for transmission of a TB. The overhead value (N^{PRB}ₒₕ(i)) of the i-th symbol set may be determined based on the value (xOverhead) configured for the UE by the base station and a ratio of the number of REs included in the i-th symbol set excluding a DMRS to the total number of REs of all symbol sets excluding a DMRS. The number of REs included in the i-th symbol set excluding a DRMS is N^{RB}_{SC}*N^{sh}_{symb} (i)−N^{PRB}_{DMRS} (i), and the total number of REs of all symbol sets excluding a DMRS is

$${\sum }_{n = 1}^{K} ( {N}_{SC}^{RB} * {N}_{symb}^{sh} ( n ) - {N}_{DMRS}^{PRB} ( n ) ) . Therfore ,$$

$${N}_{oh}^{PRB} ( i ) = f ( xOverhead * ( {N}_{SC}^{RB} * {N}_{symb}^{sh} ( i ) - {N}_{DMRS}^{PRB} ( i ) ) / {\sum }_{n = 1}^{K} {N}_{SC}^{RB} * {N}_{symb}^{sh} ( n ) - {N}_{DMRS}^{PRB} ( n ) ) )$$

may be determined.

5) Overhead of a maximum PUSCH for transmission of a TB: The UE may consider a value (xOverhead) configured for the UE by the base station, as an overhead value of a maximum PUSCH for transmission of a TB.

When it is assumed that all symbol sets include the same number of symbols, the overhead value (N^{PRB}ₒₕ(i)) of the i-th symbol set may be obtained by dividing the value (xOverhead), which the base station configures for the UE, by the maximum number of symbol sets. Here, the maximum number of symbol sets may be the maximum number of symbol sets which may be scheduled during PUSCH scheduling. When the maximum number of symbol sets is Kₘₐₓ, N^{PRB}ₒₕ(i) f(xOverhead/Kₘₐₓ) may be determined.

When it is assumed that each symbol set has a different number of symbols, the overhead value (N^{PRB}ₒₕ(i) of the i-th symbol set may be determined based on the value (xOverhead) configured for the UE by the base station and a ratio of the number of symbols included in the i-th symbol set to the maximum number of symbols. Here, the maximum number of symbols may be the maximum number of symbols included in a symbol set which may be scheduled during PUSCH scheduling. When the maximum number of symbols is N^{sh}_{symb},max, N^{PRB}ₒₕ(i) f(xOverhead*N^{sh}_{symb} (i)/N^{sh}_{symb,max}) may be determined.

The UE may consider the value (xOverhead) configured for the UE by the base station, as an overhead value of REs excluding a DMRS of a PUSCH for transmission of a TB. The overhead value (N^{PRB}ₒₕ (i)) of the i-th symbol set may be determined based on the value (xOverhead) configured for the UE by the base station and a ratio of the number of REs included in the i-th symbol set excluding a DMRS to the maximum number of REs of all symbol sets excluding a DMRS. The number of REs included in the i-th symbol set, excluding a DMRS, may be N^{RB}_{SC}*N^{sh}_{symb} (i)−N^{PRB}_{DMRS} (i). Here, the maximum number of REs of all symbol sets excluding a DMRS may be the maximum number of REs included in a symbol set which may be scheduled, excluding a DMRS, during PUSCH scheduling. When the maximum number of REs is

$${N}_{RE , max} , {N}_{oh}^{PRB} ( i ) = f ( xOverhead * ( {N}_{SC}^{RB} * {N}_{symb}^{sh} ( i ) - {N}_{DMRS}^{PRB} ( i ) ) / {N}_{RE , max} )$$

may be determined.

According to a (3-2)nd method, an overhead value based on the number of symbol sets used for PUSCH transmission may be configured for the UE by the base station. When the number of symbol sets is K and a configured overhead value is

$${N}_{oh , K}^{PRB} , {N}_{RE}^{′} = {\sum }_{i = 1}^{K} ( {N}_{SC}^{RB} * {N}_{symb}^{sh} ( i ) - {N}_{DMRS}^{PRB} ( i ) ) - {N}_{oh , K}^{PRB}$$

may be given. That is, here, each of

$${N}_{oh , 1}^{PRB} , {N}_{oh , 2}^{PRB} , … , {N}_{oh , K}^{PRB}$$

May be configured as a separate value by the base station.

According to a (3-3)rd method, an overhead value based on the number of symbols per symbol set used for PUSCH transmission may be configured for the UE by the base station. In this case, the UE may apply a different overhead value to each symbol set. When the number of symbol sets is K, and the number of symbols in a symbol set is L, and when the configured overhead value of the i-th symbol set is

$${N}_{oh , K , L}^{PRB} ( i ) , {N}_{RE}^{′} = {\sum }_{i = 1}^{K} ( {N}_{SC}^{RB} * {N}_{symb}^{sh} ( i ) - {N}_{DMRS}^{PRB} ( i ) - {N}_{oh , K , L}^{PRB} ( i ) )$$

may be given. When the number of symbols in each symbol set is the same,

$${N}_{oh , K , L}^{PRB}$$

may be configured. Therefore,

$${N}_{RE}^{′} = {\sum }_{i = 1}^{K} ( {N}_{SC}^{RB} * {N}_{symb}^{sh} ( i ) - {N}_{DMRS}^{PRB} ( i ) ) - {N}_{oh , K , L}^{PRB}$$

may be given. That is, here, each of

$${N}_{oh , 1 , 1}^{PRB} , {N}_{oh , 1 , 2}^{PRB} , … , {N}_{oh , K , L}^{PRB}$$

may be configured as a separate value by the base station.

According to the third method, when the overhead value configured for the UE can be fixed to 0, xOverhead may not be separately configured. In this case, N^{PRB}ₒₕ(i)=0 may be determined.

Although an overhead value for the UE to determine a TBS has been obtained according to the third method, subsequent TBS calculation may follow another method. For example, an overhead value in the number N′_{RE} of REs per PRB has been obtained according to the third method, but subsequent calculation may be performed according to the second method. That is, when calculating N′_{RE}=(N^{RB}_{SC}*N^{sh}_{symb}(1)−N^{PRB}_{DMRS}(1))*K−N^{PRB}ₒₕ according to the second method, N^{PRB}ₒₕ may be

$${\sum }_{i = 1}^{K} {N}_{oh}^{PRB} ( i )$$

which is the sum of overhead values of all symbol sets obtained according to the third method, and the remaining values may be values obtained by scaling values obtained based on the first symbol set. Therefore, the number of REs per PRB may be calculated based on

$${N}_{RE}^{′} = ( {N}_{SC}^{RB} * {N}_{symb}^{sh} ( 1 ) - {N}_{DMRS}^{PRB} ( 1 ) ) ⋆ K - {\sum }_{i = 1}^{K} {N}_{oh}^{PRB} ( i ) .$$

Although different overhead values N^{PRB}ₒₕ(i) are applied to respective symbol sets in the third method, one overhead value may be scaled and applied in a fourth method. That is,

$${N}_{RE , total}^{′} = {\sum }_{i = 1}^{K} ( {N}_{SC}^{RB} * {N}_{symb}^{sh} ( i ) - {N}_{DMRS}^{PRB} ( i ) ) - K * {N}_{oh}^{PRB}$$

may be calculated. Here, scaling may be based on K.

According to a fifth method, an overhead value based on the number of symbol sets used for PUSCH transmission may be configured for the UE by the base station. When the number of symbol sets is K and a configured overhead value is

$${N}_{oh , K}^{PRB} , {N}_{RE , total}^{′} = {\sum }_{i = 1}^{K} ( {N}_{SC}^{RB} * {N}_{symb}^{sh} ( i ) - {N}_{DMRS}^{PRB} ( i ) ) - {N}_{oh , K}^{PRB}$$

may be given. For reference, the number of symbol sets may be changed to the number of symbols included in the symbol sets so as to be applied.

According to a second embodiment, calculation of the number (N_{RE}=min(156, N′_{RE})*n_{PRB}) of REs for all PRBs allocated for PUSCH transmission based on N′_{RE,total} may be modified as follows.

According to a (2-1)st embodiment, calculation may be performed by replacing N′_{RE} with N′_{RE,total} obtained in the first embodiment above. That is, the number of REs for all PRBs allocated for PUSCH transmission may be calculated as N_{RE}=min (156, N′_{RE_total})*n_{PRB}.

According to a (2-2)nd embodiment, calculation may be performed by scaling the value of N_{RE} obtained in the (2-1)st embodiment. More specifically, equation N_{RE}=min(156, N′_{RE_total})*n_{PRB}*K may be performed.

Here, K denotes the number of slots to be used for PUSCH transmission in case of repetitive PUSCH transmission type A, and K denotes the number of nominal repetitions to be used for PUSCH transmission in case of repetitive PUSCH transmission type B.

According to the (2-2)nd embodiment, N′_{RE_total} may be determined preferably according to the zeroth method of the first embodiment. That is, according to the zeroth method, N′_{RE_total}=N^{RB}_{SC}*N^{sh}_{symb}-N^{PRB}_{DMRS}-N^{PRB}ₒₕ may be calculated.

For example, referring to FIG. 21, when it is assumed that K=2, N^{PRB}ₒₕ=12, and N′_{RE_total}=132, the UE may calculate N_{RE}=min(156, N′_{RE_total})*n_{PRB}*K=min(156, 132)*8*2=2112.

In the (2-2)nd embodiment, when the zeroth method of the first embodiment is used to obtain the value of N′_{RE_total}, the value of N′_{RE_total} may be 14(symbols)*12(subcarriers)=168 for a normal CP and the value of N′_{RE_total} may be smaller than or equal to 12(symbols)*12(subcarriers)=144 for an extended CP. However, in the (2-2)nd embodiment, when the first to fifth methods of the first embodiment are used to obtain the value of N′_{RE_total}, the value of N′_{RE_total} may be increased according to K. For example, referring to FIG. 20, the value of N′_{RE_total} of the first method may be given as 264. Therefore, although there are a large number of actually valid REs (i.e., although N′_{RE_total} has a larger number), a value greater than 156 may not be obtained due to the result of min(156, N′_{RE_total}) in the (2-1)st embodiment or the (2-2)nd embodiment. When the number of symbols occupied in PUSCH transmission increases and thus N′_{RE_total}>156, it is required, for obtaining a larger TBS, to adjust 156 that is the maximum number of REs determinable per PRB. Hereinafter, embodiments are disclosed for a method of adjusting 156 that is the maximum number of REs determinable per PRB.

According to a third embodiment, the UE may scale and apply the maximum number of REs determinable per PRB. More specifically, in the (2-1)st embodiment or the (2-2)nd embodiment, min(156, N′_{RE_total}) may be replaced with min (156*K, N′_{RE,total})

Here, K denotes the number of slots to be used for PUSCH transmission in case of repetitive PUSCH transmission type A, and K denotes the number of nominal repetitions to be used for PUSCH transmission in case of repetitive PUSCH transmission type B.

When the third embodiment is applied to the (2-1)st embodiment, the number of REs for all PRBs allocated for PUSCH transmission may be given as N_{RE}=min(156*K, N′_{RE_total})*n_{PRB}.

For example, referring to FIG. 20, when the first method of the first embodiment is applied, on the assumption that K=2 and N^{PRB}ₒₕ=12, N′_{RE,total}=(N^{RB}_{SC}*N^{sh}_{symb}−N^{PRB}_{DMRS}−N^{PRB}ₒₕ)*K=(12*14−24−12)*2=264 may be calculated. min (156, N′_{RE,total})=min (156, 264)=156 according to the existing scheme, while min (156*2, N′_{RE,total}) min (312, 264)=264 according to the third embodiment, so that the UE may determine a TBS for a larger number of REs.

According to a fourth embodiment, the UE may apply a predetermined value, which is configured or indicated, as the maximum number of REs determinable per PRB. That is, in the (2-1)st embodiment or the (2-2)nd embodiment, min (156, N′_{RE_total}) may be replaced with min (REₘₐₓ, N′_{RE,total}), and a predetermined value may be given as REₘₐₓ.

For example, the maximum number of REs determinable per PRB, which is based on the number of PUSCH REs including a DMRS and an overhead RE, may be calculated as REₘₐₓ=N^{RB}_{SC}*N^{sh}_{symb}. Here, N^{sh}_{symb} is the value given in the first embodiment. Referring to FIG. 20, the number of symbols occupied by a PUSCH in the time domain is 28. Therefore, REₘₐₓ=N^{RB}_{SC}*N^{sh}_{symb}=12*28336, and the number of REs for all PRBs allocated for PUSCH transmission may be calculated using equation N_{RE}=min (336, N′_{RE,total})*n_{PRB}.

As another example, the maximum number of REs determinable per PRB, which is based on the number of PUSCH REs including a DMRS and an overhead RE, may be calculated as REₘₐₓ=N^{RB}_{SC}*N^{sh}_{symb}−X. Here, N^{sh}_{symb} is the value given in the first embodiment, and X may be a value configured from a higher layer or may be a value fixed at X=12.

As another example, REₘₐₓ may be determined based on the following information.

As first information, the UE may apply a value configured from a higher layer, as REₘₐₓ that is the maximum number of REs determinable per PRB. The UE may expect to be configured with an appropriate value as REₘₐₓ by the base station, when a TBS for multiple slots or multiple nominal PUSCHs is determined.

As second information, the UE may apply a value, which is indicated by DCI in a PDCCH for scheduling of a PUSCH, as REₘₐₓ that is the maximum number of REs determinable per PRB. When determining a TBS for multiple slots or multiple nominal PUSCHs, the UE may expect to be indicated with an appropriate value as REₘₐₓ from DCI in a PDCCH for scheduling of a PUSCH.

When a PUSCH and a PUCCH transmitted in one slot overlap in at least one symbol, the UE may not be able to transmit the PUSCH and the PUCCH at the same time. In this case, the UE may multiplex UCI of the PUCCH on the PUSCH to perform transmission. Here, multiplexing indicates transmission of the UCI via the PUSCH.

In order to multiplex the UCI on the PUSCH, a resource to be used for UCI transmission among resources for the PUSCH needs to be determined. This is referred to as the number of modulation symbols (the number of REs) for UCI transmission. According to TS 38.212, the UE determines the number of modulation symbols per layer for HARQ-ACK, CSI part 1, or CSI part 2 transmission, which is to be mapped to a PUSCH, according to Equation 7 to Equation 9 below.

When a repetitive PUSCH transmission type is not type B and a UL-SCH is included, the number of modulation symbols per layer for HARQ-ACK transmission, which are to be mapped to a PUSCH, may be obtained via Equation 7 below.

$${Q}_{ACK}^{′} = min \{ ⌈ \frac{( {O}_{ACK} + {L}_{ACK} ) \cdot {β}_{offset}^{PUSCH} \cdot {\sum }_{i = 0}^{{N}_{symb , all}^{PUSCH} - 1} {M}_{sc}^{UCI} ( l )}{{\sum }_{r = 0}^{{C}_{UL - SCH} - 1} {K}_{r}} ⌋ , \\ ⌈ α \cdot {\sum }_{l = {l}_{0}}^{{N}_{symb , all}^{PUSCH} - 1} {M}_{sc}^{UCI} ( l ) ⌉ \} \qquad [ Equation 7 ]$$

Where, O_{ACK} denotes the number of HARQ-ACK bits;

L_{ACK} denotes the number of CRC bits of HARQ-ACK;

β^{PUSCH}_{offset}=β^{HARQ-ACK}_{offset} denotes an offset value configured or indicated by the base station in order to determine the number of resources for mapping of HARQ-ACK to the PUSCH;

C_{UL-SCH} denotes the number of code blocks (CBs) of a UL-SCH;

Kᵣ denotes an r-th CB size of an UL-SCH;

M^{UCI}_{SC}(l) denotes the number of REs available for UCI transmission in an 1-th PUSCH symbol;

N^{PUSCH}_{symb,all} denotes the total number of symbols including a DMRS, which are used for PUSCH transmission;

α denotes a scaling value configured from a higher layer; and

l₀ denotes an index of a first PUSCH symbol other than a DMRS, after a first DMRS symbol.

If a DMRS is transmitted in the 1-th symbol, M^{UCI}_{SC}(l)=0, otherwise, M^{UCI}_{sc} (1)=M^{PUSCH}_{sc}−M^{PT-RS}_{sc} (1). Here, M^{PUSCH}_{SC} denotes the number of subcarriers scheduled for a PUSCH in the frequency domain, and M^{PT-RS}_{SC} (l) denotes the number of subcarriers of the 1-th PUSCH symbol including a PTRS.

The UE may multiplex UCI on the PUSCH, based on Q′_{ACK} modulation symbols (the number of REs) obtained from Equation 7.

When a repetitive PUSCH transmission type is not type B and a UL-SCH is included, the UE determines, via Equation 8 below, the number of modulation symbols per layer for CSI part 1 transmission, which are to be mapped to the PUSCH.

$${Q}_{CSI - 1}^{′} = min \{ ⌈ \frac{( {O}_{CSI - 1} + {L}_{CSI - 1} ) \cdot {β}_{offset}^{PUSCH} \cdot {\sum }_{i = 0}^{{N}_{symb , all}^{PUSCH} - 1} {M}_{sc}^{UCI} ( l )}{{\sum }_{r = 0}^{{C}_{UL - SCH} - 1} {K}_{r}} ⌋ , \\ ⌈ α \cdot {\sum }_{l = 0}^{{N}_{symb , all}^{PUSCH} - 1} {M}_{sc}^{UCI} ( l ) ⌉ - {Q}_{ACK}^{′} \} . \qquad [ Equation 8 ]$$

Here,

O_{CSI} denotes the number of bits of CSI part 1;

If O_{CSI}≥360 L_{CSI}=11; otherwise, L_{CSI} is the number of CRC bits of CSI part 1;

$${β}_{offset}^{PUSCH} = {β}_{offset}^{CSI - part 1}$$

is an offset value configured or indicated by the base station in order to determine the number of resources for mapping of CSI part 1 to the PUSCH;
When HARQ-ACK is greater than 2 bits, Q′_{ACK} denotes the number of modulation symbols per layer for HARQ-ACK transmission, and when HARQ-ACK is 2 bits or less,

$${Q}_{ACK}^{′} = {\sum }_{l = l}^{{N}_{symb , all}^{PUSCH} - 1} {M}_{sc , rvd}^{ACK} ( l ) .$$

In this case,

$${M}_{sc , rvd}^{ACK} ( l )$$

denotes the number of reversed resource elements for potential HARQ-ACK transmission in OFDM symbol 1;

When a repetitive PUSCH transmission type is not type B and a UL-SCH is included, the UE may determine, via Equation 9 below, the number of modulation symbols per layer for CSI part 2 transmission, which are to be mapped to the PUSCH.

$${Q}_{CSI - 2}^{′} = min \{ ⌈ \frac{( {O}_{CSI - 2} + {L}_{CSI - 2} ) \cdot {β}_{offset}^{PUSCH} \cdot {\sum }_{i = 0}^{{N}_{symb , all}^{PUSCH} - 1} {M}_{sc}^{UCI} ( l )}{{\sum }_{r = 0}^{{C}_{UL - SCH} - 1} {K}_{r}} ⌋ , \\ ⌈ α \cdot {\sum }_{l = {l}_{0}}^{{N}_{symb , all}^{PUSCH} - 1} {M}_{sc}^{UCI} ( l ) ⌉ - {Q}_{ACK}^{′} - {Q}_{CSI - 1}^{′} \} \qquad [ Equation 9 ]$$

O_{CSI-2} denotes the number of bits of CSI part 2;
If O_{CSI-1}≥360, L_{CSI-2}=11; otherwise, L_{CSI2} is the number of CRC bits of CSI part 2;

$${β}_{offset}^{PUSCH} = {β}_{offset}^{CSI - part 2}$$

is an offset value configured or indicated by the base station in order to determine the number of resources for mapping of CSI part 2 to the PUSCH;

$${β}_{offset}^{PUSCH} = {β}_{offset}^{CSI - part 2} ;$$

Q′_{CSI-1} denotes the number of modulation symbols per layer for CSI part 1 transmitted in the PUSCH.

Via Equation 7 to Equation 9 described above, the UE may determine the number of modulation symbols (Q′_{ACK}) for HARQ-ACK transmission, the number of modulation symbols (Q′_{CSI-1}) for CSI part 1 transmission, and the number of modulation symbols (Q′_{CSI-2}) for CSI part 2 transmission in the PUSCH. Based on the equations, the followings may be identified.

The equation for determining the number of modulation symbols is in the form of min{X,Y}. That is, the number of modulation symbols is less than X, and is less than Y.

Here, X determines the number of modulation symbols required for transmitting UCI in a PUSCH. For example, the number of modulation symbols required for transmitting HARQ-ACK may be determined as

$$⌈ \frac{( {O}_{ACK} + {L}_{ACK} ) \cdot {β}_{offset}^{PUSCH} \cdot {\sum }_{i = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ .$$

The number of modulation symbols is determined according to

$${β}_{offset}^{PUSCH} .$$

That is, the greater

$${β}_{offset}^{PUSCH}$$

is, the more modulation symbols are required for UCI transmission.
Here, Y determines the maximum number of modulation symbols required for transmitting UCI in a PUSCH. The maximum number of modulation symbols may be adjusted according to an a value. That is, the base station may configure an appropriate a value to determine the maximum number of modulation symbols for transmitting UCI in the PUSCH and the minimum number of modulation symbols for transmitting a UL-SCH in the PUSCH.

For example, when HARQ-ACK is transmitted in a PUSCH, the maximum number of modulation symbols for HARQ-ACK transmission is

$$⌈ α \cdot {\sum }_{l = {l}_{0}}^{{N}_{symb , all}^{PUSCH} - 1} {M}_{sc}^{UCI} ( l ) ⌉ . Here , {\sum }_{l = {l}_{0}}^{{N}_{symb , all}^{PUSCH} - 1} {M}_{sc}^{UCI} ( l )$$

denotes the number of REs to which HARQ-ACK may be mapped among REs of the PUSCH. For reference, the HARQ-ACK is mapped after a first DM-RS of the PUSCH, and therefore l=l₀.
When CSI part 1 is transmitted in a PUSCH, the maximum number of modulation symbols for transmitting CSI part 1 is

$$⌈ α \cdot {\sum }_{l = 0}^{{N}_{symb , all}^{PUSCH} - 1} {M}_{SC}^{UCI} ( l ) ⌉ - {Q}_{ACK}^{′} . Here ,$$

$${\sum }_{l = 0}^{{N}_{symb , all}^{PUSCH} - 1} {M}_{SC}^{UCI} ( l )$$

denotes the number of REs to which CSI part 1 may be mapped among REs of the PUSCH. For reference, CSI part 1 is mapped from a first symbol of the PUSCH, and therefore l=0. According to a configured by the base station,

$$⌈ α \cdot {\sum }_{l = 0}^{{N}_{symb , all}^{PUSCH} - 1} {M}_{SC}^{UCI} ( l ) ⌉$$

REs may be used for CSI part 1. However, since modulation symbols (Q′_{ACK}) of the HARQ-ACK are mapped to some of the REs, the number (Q′_{ACK}) of the modulation symbols of the HARQ-ACK needs to be excluded.
When CSI part 2 is transmitted in a PUSCH, the maximum number of modulation symbols for transmitting CSI part 2 is

$$⌈ α \cdot {\sum }_{l = 0}^{{N}_{symb , all}^{PUSCH} - 1} {M}_{SC}^{UCI} ( l ) ⌉ - {Q}_{ACK}^{′} - {Q}_{CSI - 1}^{′} . Here ,$$

$${\sum }_{l = 0}^{{N}_{symb , all}^{PUSCH} - 1} {M}_{SC}^{UCI} ( l )$$

denotes the number of REs to which CSI part 2 may be mapped among REs of the PUSCH. For reference, CSI part 2 is mapped from a first symbol of the PUSCH, and therefore l=0. According to a configured by the base station,

$$⌈ α \cdot {\sum }_{l = 0}^{{N}_{symb , all}^{PUSCH} - 1} {M}_{SC}^{UCI} ( l ) ⌉$$

REs may be used for CSI part 2. However, modulation symbols (Q′_{ACK}) of the HARQ-ACK and modulation symbols (Q′_{CSI-1}) of CSI part 1 are mapped to some of the REs, and thus the number (Q′_{ACK}) of modulation symbols of the HARQ-ACK and the number of modulation symbols (Q′_{CSI-1}) of the CSI part 1 need to be excluded.

Equation 7 to Equation 9 are applicable when a PUSCH transmits a TB in one slot. That is, parameters of Equation 7 to Equation 9 are values defined in one slot. For example, N^{PUSCH}_{symb,all} denotes the total number of symbols used for PUSCH transmission in one slot. In addition, C_{UL}-SCH denotes the number of CBs included in a UL-SCH of a PUSCH transmitted in the single slot.

In addition, the equation is applicable when a PUSCH is repeatedly transmitted in multiple slots (repetitive PUSCH transmission type A). In this case, the parameters of Equation 7 to Equation 9 are values defined in a slot where a PUCCH overlaps. For example, N^{PUSCH}_{symb,all} denotes the total number of symbols used for PUSCH transmission in a slot where a PUCCH overlaps. In addition, C_{UL-SCH} denotes the number of CBs included in a UL-SCH of a PUSCH transmitted in a slot where a PUCCH overlaps.

As another example, the UE may perform one UCI multiplexing in one transmission occasion. In this case, Equation 7 to Equation 9 are applicable when a PUSCH transmits a TB in one transmission occasion. That is, the parameters of Equation 7 to Equation 9 may be values defined in one transmission occasion. For example, N^{PUSCH}_{symb,all} denotes the total number of symbols used for PUSCH transmission in one transmission occasion. In addition, C_{UL-SCH} denotes the number of CBs included in a UL-SCH of a PUSCH transmitted in one transmission occasion.

In addition, the equation is applicable when a PUSCH is repeatedly transmitted in multiple transmission occasions. In this case, the parameters of Equation 7 to Equation 9 are values defined in a transmission occasion where a PUCCH overlaps. For example, N^{PUSCH}_{symb,all} denotes the total number of symbols used for PUSCH transmission in a transmission occasion where a PUCCH overlaps. In addition, C_{UL-SCH} denotes the number of CBs included in a UL-SCH of a PUSCH transmitted in a transmission occasion where a PUCCH overlaps.

For reference, in the present disclosure, a transmission occasion may be the same as a symbol set described above. That is, a symbol set of repetitive PUSCH transmission type A is a PUSCH transmitted in one slot, and a symbol set of repetitive PUSCH transmission type B is a PUSCH transmitted via one nominal repetition.

<Method of Multiplexing a PUSCH and a PUCCH when a TB is Transmitted Via Multiple Slots>

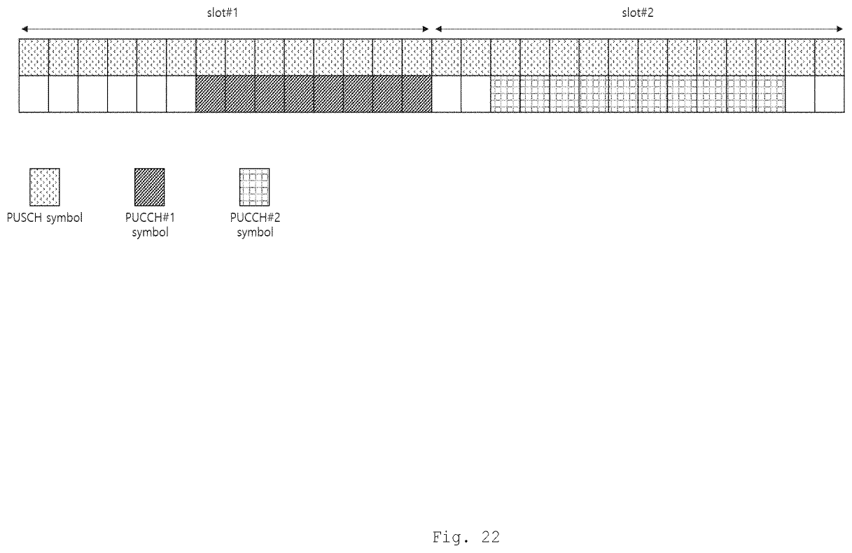

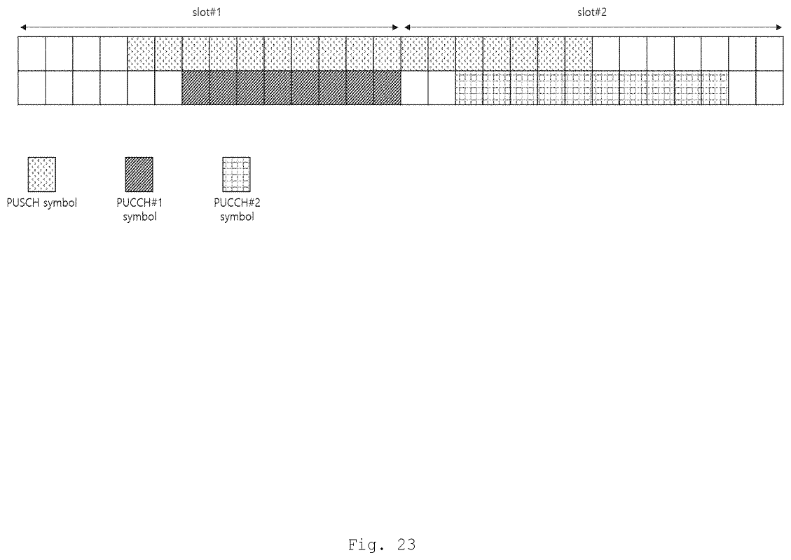

FIG. 22 and FIG. 23 illustrate examples of a collision between multiple PUCCHs and a PUSCH for which a TBS has been determined based on multiple slots or multiple nominal PUSCHs.

Referring to FIG. 22 and FIG. 23, when a TB of a PUSCH is transmitted via multiple slots, each slot in which the TB is transmitted and a slot for PUCCH transmission may overlap, in which case, the PUSCH and the PUCCH may be multiplexed and transmitted. In this case, the PUSCH may be transmitted using repetitive transmission type A or repetitive transmission type B according to the embodiment described above. That is, a TBS of the PUSCH may be determined based on multiple symbol sets. For convenience, when a TBS is determined based on multiple symbol sets (or slots), a TB generated based on the TBS may be referred to as a TB over multiple symbol sets or a TB over multiple slots (TBoMSs). In addition, a PUSCH used for TBoMS transmission may be referred to as a TBoMS PUSCH.

Hereinafter, unless otherwise mentioned, a description will be provided with reference to repetitive PUSCH transmission type A. However, the following embodiments may be also applicable to repetitive PUSCH transmission type B as well as repetitive PUSCH transmission type A.

Specifically, when a TB is transmitted via a PUSCH, the TB may be transmitted in one slot, but the TB may be transmitted in multiple slots when the size of a TB is large. In this case, one TB may be configured by at least one code block, and may be repeatedly transmitted in every multiple slots.

In this case, each slot in which one TB is transmitted and each slot for transmitting UCI of a PUCCH may overlap, in which case, UCI of the PUCCH for UCI transmission and a PUSCH for TB transmission in each slot may be multiplexed on the PUSCH and transmitted. That is, when the size of a TB is large, the TB may be transmitted via multiple slots, and the UCI of the PUCCH may be transmitted in each slot. In this case, a symbol to which the TB is mapped and a symbol to which the UCI of the PUCCH is mapped may overlap in each slot, and the UE may multiplex the UCI of the PUCCH on the PUSCH in each slot and transmit the same to the base station.

For example, as illustrated in FIG. 21 and FIG. 22, the UE may determine a TBS for one PUSCH, based on symbol sets of two slots (slot #1, slot #2). The UE may be indicated or configured with different PUCCH transmission in each symbol set of the two determined slots by the base station. That is, transmission of a first PUCCH (PUCCH #1) in a first slot (slot #1) and transmission of a second PUCCH (PUCCH #2) in a second slot (slot #2) may be indicated or configured. Problems that may occur from this are as follows.

First, when a PUSCH resource collides with multiple PUCCH resources, the UE may select only one of the multiple PUCCH resources and map UCI of a corresponding PUCCH to the PUSCH resource.

In this case, one resource for transmitting the UCI of the PUCCH may be selected via one of the following methods.
One PUCCH may be a PUCCH including higher priority UCI among the multiple PUCCHs. For example, priority may be given in order of HARQ-ACK>CSI part I>CSI part 2. When the first PUCCH includes HARQ-ACK and the second PUCCH includes CSI part 1 or CSI part 2, the UE may select the first PUCCH, map the UCI (i.e., HARQ-ACK) of the PUCCH to the PUSCH resource, and transmit the same.
Alternatively, one PUCCH may be determined according to a signal or channel on which the PUCCH is scheduled. For example, when the first PUCCH is scheduled via DCI, and the second PUCCH is scheduled via an RRC signal or a higher-layer signal, the UE may select the PUCCH scheduled via DCI. In addition, the UCI of the PUCCH may be mapped to the PUSCH resource and transmitted. This is because the UCI transmitted by the PUCCH scheduled via DCI may be more important.
Alternatively, one PUCCH may be determined according to a time order of a slot or symbols in which the PUCCH is scheduled. For example, in the first PUCCH and the second PUCCH, the earlier PUCCH in time may be selected. This is because it may be important to first transmit the first PUCCH which is indicated for quick transmission. As another example, in the first PUCCH and the second PUCCH, the later PUCCH in time may be selected. This is because the latest PUCCH provides the longest processing time, so that the UCI of the PUCCH may be transmitted via a PUSCH.
Alternatively, one PUCCH may be determined based on a resource occupied by a PUCCH. For example, one PUCCH may be a PUCCH resource including a small number of resources. The resource may include the number of symbols in the time domain, the number of PRBs in the frequency domain, or the number of REs in the time/frequency domain. For example, the UE may select a PUCCH resource having a small number of REs so as to use more resources for data transmission via a PUSCH.
Alternatively, one PUCCH may be a PUCCH resource including a large number of resources. The resource may include the number of symbols in the time domain, the number of PRBs in the frequency domain, or the number of REs in the time/frequency domain. For example, when a large number of REs are allocated to a PUCCH resource, the main purpose may be coverage extension or reliable UCI transmission, so that transmission may be preferentially performed via a PUSCH.
Alternatively, one PUCCH may be a resource indicated or configured to multiplex UCI on a PUSCH. For example, for flexible PUCCH resource selection according to a channel condition, the UE may receive, from the base station, an indication of a specific PUCCH resource for UCI multiplexing on a PUSCH from among multiple PUCCH resources where a collision has occurred.

In the embodiment above, the number of modulation symbols (the number of REs) for UCI transmission may be determined based on a length of UCI of the selected PUCCH and a resource occupied by a PUSCH in a slot of the selected PUCCH.

However, in the method of selecting one PUCCH, it is impossible to multiplex UCI of multiple PUCCH resources separately on the PUSCH. In this case, when UCI of a PUCCH, which is not multiplexed on the PUSCH and is not transmitted, is HARQ-ACK, a problem of an increase of latency of the HARQ-ACK may occur. Preferably, in an NR system, the reliability of a PUCCH is considered more important than the reliability of a PUSCH, so that PUCCH transmission may be prioritized. However, in the situation described above, there occurs a problem that a specific PUCCH cannot be transmitted, which needs to be resolved.

According to an embodiment of the present disclosure, the UE may select one slot among multiple slots in which a PUSCH is transmitted, and may collect and multiplex UCI of PUCCHs overlapping the PUSCH in the selected slot.

Here, one slot may be determined as follows. In order to secure time for processing UCI with the PUSCH, the UE may multiplex the UCI in the last slot among the slots in which the PUSCH is transmitted. In this case, UCI is always multiplexed in the last slot of the PUSCH, and the PUSCH is not multiplexed in the remaining slots. Therefore, when transmitting the PUSCH in the last slot, the UE may transmit the PUSCH in consideration of the UCI. However, this scheme may cause additional latency due to UCI being transmitted in a slot later than a slot indicated for PUCCH transmission. As another example, in order to secure time for processing UCI with the PUSCH, the UE may multiplex the UCI in the last slot of slots overlapping with the PUCCH among the slots in which the PUSCH is transmitted. That is, since the UCI is transmitted in the last slot overlapping with the PUCCH, latency may be reduced. However, the UCI needs to be multiplexed during PUSCH transmission.

In the embodiment above, the number of modulation symbols (the number of REs) for UCI transmission may be determined based on a length of collected UCI of overlapping PUCCHs and a resource occupied by a PUSCH in a slot in which the UCI is to be multiplexed. That is, O_{ACK} in Equation 7 denotes the number of bits of HARQ-ACK in the collected UCI. O_{CSI-1} in Equation 8 denotes the number of bits of CSI part 1 in the collected UCI. O_{CSI-2} in Equation 9 denotes the number of bits of CSI part 2 in the collected UCI.

According to an embodiment of the present disclosure, in each slot overlapping with a PUCCH among multiple slots in which the PUSCH is transmitted, the UE may multiplex UCI of the overlapping PUCCH on the PUSCH.

Specifically, when a TBS that is a size of a TB is determined based on multiple slots, and UCI of different PUCCHs is transmitted in respective slots of the PUSCH for transmission of the TB, the PUSCH and the PUCCHs may be multiplexed and transmitted in respective slots. In this case, the size (the number of symbols or bits) of each parameter of the multiplexed UCI needs to be calculated in each slot.

However, the size of each parameter of the multiplexed UCI is calculated based on the TBS in each slot, wherein, since the TBS has been determined based on multiple slots, the TBS needs to be scaled based on the respective slots in order to calculate the size of each parameter of the multiplexed UCI. Alternatively, the size of each parameter of the UCI may be determined based on a TBS that is not scaled.

For example, as illustrated in FIG. 22, when the UE transmits a PUSCH in a first slot (slot #1) and a second slot (slot #2), the PUSCH may overlap with the first PUCCH (PUCCH #1) in the first slot and with the second PUCCH (PUCCH #2) in the second slot. Here, first UCI of the first PUCCH may be multiplexed on the PUSCH in the first slot, and second UCI of the second PUCCH may be multiplexed on the PUSCH in the second slot.

In this case, the number of modulation symbols (the number of REs) occupied by UCI of a PUCCH in each slot in which the PUCCH is multiplexed needs to be determined. In order to multiplex the first UCI in the first slot (slot #1), Q′_{ACK}(1) modulation symbols in the first slot is required. In addition, in order to multiplex the second UCI in the second slot (slot #2), Q′_{ACK}(2) modulation symbols in the second slot is required.

Referring to Equation 7 to Equation 9, in order to obtain Q′_{ACK}(1) modulation symbols of the first slot, the number of bits of a TB(UL-SCH) included in the first slot needs to be determined. In addition, in order to obtain Q′_{ACK}(2) modulation symbols of the second slot, the number of bits of a TB(UL-SCH) included in the second slot may need to be determined. In the present disclosure, a method of obtaining Q′_{ACK}(1) or Q′_{ACK}(2) is disclosed.

In this embodiment, the UE may arrange (map) one TB in a symbol set of multiple slots. Accordingly, a part of one TB may be included in one slot. Furthermore, when one TB includes one or more CBs, one CB may be arranged in (mapped to) a symbol set of multiple slots. Accordingly, it is difficult to determine the number of CBs in a slot where the UE wishes to multiplex UCI.

To solve the problems described above, various embodiments of the present disclosure are disclosed.

### First Embodiment: Calculating the Number of Modulation Symbols by Scaling a TBS>

According to the first embodiment, when one TB is transmitted in multiple slots, that is, one slot includes a part of the TB, the UE may determine the number of modulation symbols by adjusting (or scaling), based on one slot, a TBS of the TB mapped to the multiple slots. That is, when the TB is transmitted in one slot, the UE may scale the TBS and calculate the number of modulation symbols of UCI of a PUCCH, which is to be multiplexed on a PUSCH.

In other words, the UE may calculate the number of modulation symbols (the number of REs) for transmitting UCI of each PUCCH, by scaling the sum of the CB sizes (Kᵣ) of a UL-SCH, which is the TB. That is, when there are N PUCCHs that collide with a PUSCH, it is assumed that Q′_{ACK}of each PUCCH is Q′_{ACK}(1), Q′_{ACK}(2), . . . , Q′_{ACK}(N), Q′_{CSI-1} is Q′_{CSI-1}(1), Q′_{CSI-1}(2), . . . , Q′_{CSI-1}(N), and Q′_{CSI-2} is Q′_{CSI-2} (1), Q′_{CSI-2} (2), . . . , Q′_{CSI-2} (N). In this case, scaling values P (1), P (2), . . . , P (N) may be determined based on the following information. In general, the number of modulation symbols according to the present disclosure may be obtained according to Equation 10 to Equation 12 below.

Equation 10 represents an example of the number of modulation symbols for HARQ-ACK/NACK of UCI.

$$[ Equation 10 ]$$

$${Q}_{ACK}^{′} ( i ) = min \{ ⌈ \frac{\begin{matrix}( {O}_{ACK} ( i ) + {L}_{ACK} ( i ) \cdot {β}_{offset}^{PUSCH} \cdot \\ {\sum }_{l = 0}^{{N}_{symb , all}^{PUSCH} ( i ) - 1} {M}_{SC}^{UCI} ( i , l )\end{matrix}}{P ( i ) \cdot {\sum }_{r = 0}^{{C}_{UL - SCH} - 1} {K}_{r}} ⌉ , ⌈ α \cdot {\sum }_{l = {l}_{0} ( i )}^{{N}_{symb , all}^{PUSCH} ( l ) - 1} {M}_{SC}^{UCI} ( i , l ) ⌉ \}$$

In Equation 10, respective parameters are as follows.
i is an index of a slot on which HARQ-ACK is to be multiplexed;
O_{ACK}(i) denotes the number of HARQ-ACK bits in slot i;
L_{ACK(i)} denotes the number of CRC bits in slot i;

$${M}_{SC}^{UCI} ( i , l )$$

denotes the number of REs available for UCI transmission in an 1-th PUSCH symbol in slot i;

$${N}_{symb , all}^{PUSCH} \qquad ( i )$$

denotes the total number of symbols including a DMRS of slot i, which are used for PUSCH transmission;
l₀(i) denotes an index of a first PUSCH symbol other than a DMRS, after a first DMRS symbol.

Equation 11 represents an example of the number of modulation symbols of CSI part 1 of UCI.

$${Q}_{CSI - 1}^{′} = min \{ \begin{matrix}⌈ \frac{\begin{matrix}{O}_{CSI - 1} ( i ) + {L}_{CSI - 1} ( i ) ) \cdot {β}_{offset}^{PUSCH} \cdot \\ {\sum }_{l = 0}^{{N}_{symb , all}^{PUSCH} ( i ) - 1} {M}_{SC}^{UCI} ( i , l )\end{matrix}}{P ( i ) \cdot {\sum }_{r = 0}^{{C}_{UL - SCH} - 1} {K}_{r}} ⌉ , \\ ⌈ α \cdot {\sum }_{l = {l}_{0} ( i )}^{{N}_{symb , all}^{PUSCH} ( i ) - 1} {M}_{SC}^{UCI} ( i , l ) ⌉ - {Q}_{ACK}^{′} ( l )\end{matrix} \} \qquad [ Equation 11 ]$$

In Equation 11, respective parameters are as follows.

O_{CSI-1}(i) denotes the number of bits of CSI part 1 of slot i;

If O_{CSI_1}(i)≥360, L_{CSI-1}(i)=1; otherwise, L_{CSI-1}(i) is the number of CRC bits of CSI part 1 of slot i;

Equation 12 represents an example of the number of modulation symbols of CSI part 2 of UCI.

$$[ Equation 12 ]$$

$${Q}_{CSI - 2}^{′} ( i ) = min \{ \begin{matrix}⌈ \frac{\begin{matrix}{O}_{CSI - 2} ( i ) + {L}_{CSI - 2} ( i ) ) \cdot {β}_{offset}^{PUSCH} \cdot \\ {\sum }_{l = 0}^{{N}_{symb , all}^{PUSCH} ( i ) - 1} {M}_{SC}^{UCI} ( i , l )\end{matrix}}{P ( i ) \cdot {\sum }_{r = 0}^{{C}_{UL - SCH} - 1} {K}_{r}} ⌉ , \\ ⌈ α \cdot {\sum }_{l = 0}^{{N}_{symb , all}^{PUSCH} ( i ) - 1} {M}_{SC}^{UCI} ( i , l ) ⌉ - {Q}_{ACK}^{′} ( i ) - {Q}_{CSI - 1}^{′} ( i )\end{matrix} \}$$

In Equation 12, respective parameters are as follows.
O_{CSI-2}(i) denotes the number of bits of CSI part 2 of slot i;
If O_{CSI-2}(i)≥360, L_{CSI-2}(i)=11; otherwise, L_{CSI-2}(i) is the number of CRC bits of CSI part 2 of slot i;

When comparing Equations 10 to 12 with Equations 7 to 9, the UE may determine

$$P ( i ) \cdot {\sum }_{r = 0}^{{C}_{UL - SCH} - 1} {K}_{r}$$

as the number of bits of a UL-SCH(TB) of a PUSCH in an i-th slot. Here, a PUSCH in which the number of bits of a UL-SCH(TB) is

$${\sum }_{r = 0}^{{C}_{UL - SCH} - 1} {K}_{r}$$

is transmitted in K slots, and therefore the number of bits of the UL-SCH(TB) transmitted in one slot may not be

$${\sum }_{r = 0}^{{C}_{UL - SCH} - 1} {K}_{r}$$

but have a smaller value.

In this case, a method of determining P(i) that is a scaling value of a TBS is described with reference to Equation 10 to Equation 12.

According to a zeroth method, P(i)=1. That is, even if a PUSCH in one slot includes a part of the UL-SCH(TB), it is regarded as if the entire UL-SCH(TB) is transmitted. According to the zeroth method, a size larger than the size of the UL-SCH(TB) that is actually transmitted in one slot is considered, and thus a small number of modulation symbols may be used for UCI transmission. Accordingly, this may affect the reliability of UCI.

According to a first method, the number of bits of the entire UL-SCH (TB) may be scaled based on a value (K) which serves as a reference for the UE to determine a TBS. Here, the value (K) denotes the number of slots to 5 be used for PUSCH transmission in case of repetitive PUSCH transmission type A, and denotes the number of nominal repetitions to be used for PUSCH transmission in case of repetitive PUSCH transmission type B. A scaling value based on the value (K) may be determined to be P(i)=1/K. This is because, since a PUSCH in which the number of bits of a UL-SCH(TB) is

$${\sum }_{r = 0}^{{C}_{UL - SCH} - 1} {K}_{r}$$

is transmitted in K slots, the number of bits of the UL-SCH(TB) transmitted in one slot is, on average, 1/K of the number of bits of the entire UL-SCH (TB).
According to a (1-1)st method, a value (K′) which serves as a reference for the UE to determine a TBS may be the number of specific slot sets. Here, a specific slot set may include a slot in which collision occurs, and slots consecutive to the slot in the time domain. That is, a slot in which a PUCCH and a PUSCH collide, and K′ slots consecutive to the slot in the time domain may be included. Here, K′ consecutive slots in the time domain may include slots available for PUSCH transmission. A scaling value based on the K′ value may be determined as P(i)=1/K′. This is because, since a PUSCH in which the number of bits of a UL-SCH (TB) is

$${\sum }_{r = 0}^{{C}_{UL - SCH} - 1} {K}_{r}$$

is transmitted in K′ slots, the number of bits of the UL-SCH(TB) transmitted in one slot is, on average, 1/K′ of the number of bits of the entire UL-SCH (TB).
According to a second method, the number of bits of the entire UL-SCH(TB) may be scaled based on a PUCCH resource that collides with a PUSCH in each slot. More specifically, the number of bits of the entire UL-SCH(TB) may be scaled based on a ratio of PUCCH resources that collide with a PUSCH in each slot. A PUCCH resource that collides with a PUSCH may include the number of symbols in the time domain, the number of subcarriers in the frequency domain, or the number of REs. For example, referring to FIG. 23, the number of symbols of PUCCH #1 that collides with a PUSCH is N1=8, and the number of symbols of PUCCH #2 that collides a PUSCH is N2=5. In this case, a scaling value may be P(1)=N1/(N1+N2), P(2)=N2/(N1+N2).
According to a third method, the number of bits of the entire UL-SCH(TB) may be scaled based on a PUCCH resource. More specifically, the number of bits of the entire UL-SCH(TB) may be scaled based on a ratio of PUCCH resources. A PUCCH resource may include the number of symbols in the time domain, the number of subcarriers in the frequency domain, or the number of REs. For example, referring to FIG. 23, when a repetitive PUSCH transmission type is not type B and the UE is based on the number of symbols of each PUCCH, the number of symbols of PUCCH #1 is N1=8, and the number of symbols of PUCCH #2 that collides a PUSCH is N2=10. In this case, a scaling value may be P(1)=N1/(N1+N2), P(2)=N2/(N1+N2).
According to a fourth method, the number of bits of the entire UL-SCH(TB) may be scaled based on a PUSCH resource of each slot. More specifically, the number of bits of the entire UL-SCH(TB) may be scaled based on a ratio of PUSCH resources. A PUSCH resource may include the number of symbols in the time domain, the number of subcarriers in the frequency domain, or the number of REs. For example, referring to FIG. 23, the number of symbols PUSCH of a PUSCH in slot #1 is

$${N}_{symb , all}^{PUSCH} ( 1 ) = 10 ,$$

and the number of symbols of a PUSCH in slot #2 is

$${N}_{symb , all}^{PUSCH} ( 2 ) = 7.$$

In this case, a scaling value may be

$$P ( 1 ) = {N}_{symb , all}^{PUSCH} ( 1 ) / ( {N}_{symb , all}^{PUSCH} ( 1 ) + {N}_{symb , all}^{PUSCH} ( 2 ) ) and P ( 2 ) = {N}_{symb , all}^{PUSCH} ( 2 ) / ( {N}_{symb , all}^{PUSCH} ( 1 ) + {N}_{symb , all}^{PUSCH} ( 2 ) ) .$$

That is, genreally,

$$P ( i ) = {N}_{symb , all}^{PUSCH} ( i ) / ( {N}_{symb , all}^{PUSCH} ( 1 ) + {N}_{symb , all}^{PUSCH} ( 2 ) + … + {N}_{symb , all}^{PUSCH} ( N ) ) .$$

According to a fifth method, the number of bits of the entire UL-SCH(TB) may be scaled based on a PUSCH resource excluding a DM-RS symbol of each slot. More specifically, the number of bits of the entire UL-SCH(TB) may be scaled based on a ratio of PUSCH resources excluding a DM-RS symbol. A PUSCH resource excluding a DM-RS symbol may include the number of symbols in the time domain, the number of subcarriers in the frequency domain, or the number of REs. For example, the number of symbols of a PUSCH excluding a DM-RS symbol in slot #1 is Ni, and the number of symbols of a PUSCH excluding a DM-RS symbol in slot #2 is N2. In this case, a scaling value may be P(1)=N1/(N1+N2), P(2)=N2/(N1+N2).

According to a sixth method, the number of bits of the entire UL-SCH(TB) may be scaled based on a PUSCH resource excluding an RE used for a PTRS and a DM-RS symbol of each slot. More specifically, the number of bits of the entire UL-SCH(TB) may be scaled based on a ratio of PUSCH resources excluding an RE used for a PTRS and a DM-RS symbol. A PUSCH resource excluding an RE used for a PTRS and a DM-RS symbol may include the number of symbols in the time domain, the number of subcarriers in the frequency domain, or the number of REs. For example, the number of REs of a PUSCH excluding an RE used for a PTRS and a DM-RS symbol in slot #1 is Ni, and the number of REs of a PUSCH excluding an RE used for a PTRS and a DM-RS symbol in slot #2 is N2. In this case, a scaling value may be P(1)=N1/(N1+N2), P(2)=N2/(N1+N2). For reference, the number of REs of a PUSCH excluding an RE used for a PTRS and a DM-RS in slot PUSCH #1 may be determined as

$${\sum }_{l = 0}^{{N}_{symb , all}^{PUSCH} ( i ) - 1} \qquad {M}_{sc}^{UCI} ( i , l ) .$$

According to a seventh method, the scaling value may be a configured or indicated value.
<Second embodiment: Calculating the number of modulation symbols based on a resource in which a PUSCH is transmitted>

According to the second embodiment, the UE may determine the number of modulation symbols for UCI transmission based on a resource in which the entire PUSCH is transmitted. More specifically, the number of modulation symbols for UCI transmission in the i-th slot is according to Equations 13 to 15.

Equation 13 represents an example of the number of modulation symbols for HARQ-ACK/NACK of UCI.

$${Q}_{ACK}^{′} ( i ) = min \{ ⌈ \frac{\begin{matrix}( {O}_{ACK} ( i ) + {L}_{ACK} ( i ) \cdot \\ {β}_{offset}^{PUSCH} ( i ) \cdot \\ {\sum }_{n = 0}^{K - 1} {\sum }_{l = 0}^{{N}_{symb , all}^{PUSCH} ( n ) - 1} {M}_{sc}^{UCI} ( n , l )\end{matrix}}{{\sum }_{r = 0}^{{C}_{UL \cdot {SCH}^{- 1} {K}_{r}}}} ⌉ , \\ ⌈ α \cdot {\sum }_{l = {l}_{0} ( i )}^{{N}_{symb , all}^{PUSCH} ( i ) - 1} {M}_{sc}^{UCI} ( i , l ) ⌉ \} \qquad [ Equation 13 ]$$

Equation 14 represents an example of the number of modulation symbols of CSI part 1 of UCI.

$${Q}_{CSI - 1}^{′} ( i ) = min \{ \begin{matrix}⌈ \frac{\begin{matrix}( {O}_{CSI - 1} ( i ) + \\ {L}_{CSI - 1}^{} ( i ) ) \cdot {β}_{offset}^{PUSCH} \cdot \\ {\sum }_{n = 0}^{K - 1} {\sum }_{l = 0}^{{N}_{symb , all}^{PUSCH} ( n ) - 1} {M}_{sc}^{UCI} ( n , l )\end{matrix}}{P ( i ) \cdot {\sum }_{r = 0}^{{C}_{UL - {SCH}^{- 1}}} {K}_{r}} ⌉ , \\ ⌈ α \cdot {\sum }_{l = 0}^{{N}_{symb , all}^{PUSCH} ( i ) - 1} {M}_{sc}^{UCI} ( i , l ) ⌉ - {Q}_{ACK}^{′} ( i )\end{matrix} \} \qquad [ Equation 14 ]$$

Equation 15 represents an example of the number of modulation symbols of part 2 of UCI.

$${Q}_{CSI - 2}^{′} ( i ) = min \{ \begin{matrix}⌈ \frac{\begin{matrix}( {O}_{CSI - 2} ( i ) + \\ {L}_{CSI - 2}^{} ( i ) ) \cdot {β}_{offset}^{PUSCH} \cdot \\ {\sum }_{n = 0}^{K - 1} {\sum }_{l = 0}^{{N}_{symb , all}^{PUSCH} ( n ) - 1} {M}_{sc}^{UCI} ( n , l )\end{matrix}}{P ( i ) \cdot {\sum }_{r = 0}^{{C}_{UL - {SCH}^{- 1}}} {K}_{r}} ⌉ , \\ ⌈ α \cdot {\sum }_{l = 0}^{{N}_{symb , all}^{PUSCH} ( i ) - 1} {M}_{sc}^{UCI} ( i , l ) ⌉ - {Q}_{ACK}^{′} ( i ) - {Q}_{CSI - 1}^{′} ( i )\end{matrix} \} \qquad [ Equation 15 ]$$

That is, in Equations 10 to 12, Q′_{ACK}(i) Q′_{CSI-1} (i) and Q′_{CSI-2}(i) have been determined based on

$${\sum }_{l = 0}^{{N}_{symb , all}^{PUSCH} ( i ) - 1} {M}_{sc}^{UCI} ( i , l )$$

that is the number of resources in the i-th slot, but in Equations 13 to 15, Q′_{ACK}(i) may be determined based on

$${\sum }_{n = 0}^{K - 1} {\sum }_{l = 0}^{{N}_{symb}^{PUSCH} ( n ) - 1} {M}_{sc}^{UCI} ( n , l )$$

that is the number of resources in which the entire PUSCH is transmitted. Therefore, no separate scaling of TBS is required.

According to a (2-1)st embodiment, the UE may determine the number of modulation symbols for UCI transmission based on a PUSCH resource of a specific slot set. Here, the specific slot set may include a slot in which a PUCCH and a PUSCH collide, and slots consecutive to the slot in the time domain. In addition, the consecutive slots in the time domain may include slots available for PUSCH transmission. Specifically, a slot in which a PUCCH and a PUSCH collide, and slots which are consecutive to the slot in the time domain and available for PUSCH transmission may be included. More specifically, the number of modulation symbols for UCI transmission in the i-th slot may be obtained according to Equations 16 to 18.

Equation 16 represents an example of the number of modulation symbols for HARQ-ACK/NACK of UCI.

$${Q}_{ACK}^{′} ( i ) = min \{ ⌈ \frac{\begin{matrix}( {O}_{ACK} ( i ) + \\ {L}_{ACK} ( i ) \cdot {β}_{offset}^{PUSCH} ( i ) \cdot \\ {\sum }_{n = {l}_{0}}^{{K}^{′} - 1} {\sum }_{l = 0}^{{N}_{symb , all}^{PUSCH} ( n ) - 1} {M}_{sc}^{UCI} ( n , l )\end{matrix}}{{\sum }_{r = 0}^{{C}_{UL \cdot {SCH}^{- 1} {K}_{r}}}} ⌉ , \\ ⌈ α \cdot {\sum }_{l = {l}_{0} ( i )}^{{N}_{symb , all}^{PUSCH} ( i ) - 1} {M}_{sc}^{UCI} ( i , l ) ⌉ \} \qquad [ Equation 16 ]$$

Equation 17 represents an example of the number of modulation symbols of CSI part 1 of UCI.

$${Q}_{CSI - 1}^{′} ( i ) = min \{ \begin{matrix}⌈ \frac{\begin{matrix}( {O}_{CSI - 1} ( i ) + \\ {L}_{CSI - 1}^{} ( i ) ) \cdot {β}_{offset}^{PUSCH} \cdot \\ {\sum }_{n = {l}_{0}}^{{K}^{′} - 1} {\sum }_{l = 0}^{{N}_{symb , all}^{PUSCH} ( n ) - 1} {M}_{sc}^{UCI} ( n , l )\end{matrix}}{{\sum }_{r = 0}^{{C}_{UL \cdot {SCH}^{- 1}}} {K}_{r}} ⌉ , \\ ⌈ α \cdot {\sum }_{i = 0}^{{N}_{symb , all}^{PUSCH} ( i ) - 1} {M}_{sc}^{UCI} ( i , l ) ⌉ - {Q}_{ACK}^{′} ( i )\end{matrix} \} \qquad [ Equation 17 ]$$

Equation 18 represents an example of the number of modulation symbols of part 2 of UCI.

$${Q}_{CSI - 2}^{′} ( i ) = min \{ \begin{matrix}⌈ \frac{\begin{matrix}( {O}_{CSI - 2} ( i ) + \\ {L}_{CSI - 2}^{} ( i ) ) \cdot {β}_{offset}^{PUSCH} \cdot \\ {\sum }_{n = {l}_{0}}^{{K}^{′} - 1} {\sum }_{l = 0}^{{N}_{symb , all}^{PUSCH} ( n ) - 1} {M}_{sc}^{UCI} ( n , l )\end{matrix}}{{\sum }_{r = 0}^{{C}_{UL - {SCH}^{- 1}}} {K}_{r}} ⌉ , \\ ⌈ α \cdot {\sum }_{l = 0}^{{N}_{symb , all}^{PUSCH} ( i ) - 1} {M}_{sc}^{UCI} ( i , l ) ⌉ - {Q}_{ACK}^{′} ( i ) - {Q}_{CSI - 1}^{′} ( i )\end{matrix} \} \qquad [ Equation 18 ]$$

In Equations 13 to 15, Q′_{ACK} (i), Q′_{CSI-1} (i), and Q′_{CSI-2} (i) have been determined based on

$${\sum }_{n = 0}^{K - 1} {\sum }_{l = 0}^{{N}_{symb}^{PUSCH} ( n ) - 1} {M}_{sc}^{UCI} ( n , l )$$

that is the total number of PUSCH resources allocated as K symbol sets, but in Equations 16 to 18, Q′AC(i), Q′_{CSI-1}(i), and Q′_{CSI-2}(i) may be determined based on

$${\sum }_{n = {i}_{0}}^{{K}^{′} - 1} {\sum }_{i = 0}^{{N}_{symb}^{PUSCH} ( n ) - 1} {M}_{sc}^{UCI} ( n , l )$$

that is the number of consecutive PUSCH resources including a slot in which a collision with a PUCCH resource occurs. Here, K′ denotes the number of slots of a specific slot set including the i-th slot, that is, the number of consecutive PUSCH slots including the i-slot, in which a collision with a PUCCH resource occurs, in the time domain, and in denotes an index of the earliest slot in the time domain in the specific slot set including the i-th slot, that is, an index of the foremost slot among the consecutive PUSCH slots in the time domain including the i-th slot in which a collision with a PUCCH resource occurs.

In the aforementioned first embodiment and second embodiment, X in min{X,Y}used for obtaining a modulation symbol has been described. Hereinafter, an embodiment for Y indicating the maximum number of modulation symbols to be used for UCI among PUSCH resources will be described. Y values proposed in the following embodiment may be used as Y values of the first embodiment and the second embodiment.

The base station configures or indicates a for the UE, and thus the maximum number of modulation symbols to be used for UCI among PUSCH resources may be adjusted. That is, the base station may configure an appropriate value and determine the maximum number of modulation symbols for UCI transmission in a PUSCH and the minimum number of modulation symbols for UL-SCH transmission in the PUSCH. In the aforementioned first embodiment and second embodiment, a has been applied to a PUSCH resource in each slot.

For example, when determining the number of modulation symbols for HARQ-ACK transmission, the maximum number Y of modulation symbols to be used for UCI among PUSCH resources may be as shown in Equation 19.

$$⌈ α \cdot {\sum }_{l = {l}_{0} ( i )}^{{N}_{symb , all}^{PUSCH} ( i ) - 1} {M}_{sc}^{UCI} ( i , l ) ⌉ \qquad [ Equation 19 ]$$

Here,

$${\sum }_{l = {l}_{0} ( i )}^{{N}_{symb , all}^{PUSCH} ( i ) - 1} {M}_{sc}^{UCI} ( i , l )$$

is the number of REs to which an HARQ-ACK modulation symbol is allocatable among PUSCH resources in slot i. Therefore, for the value determined according to Equation 19, up to a ratio of REs to which an HARQ-ACK modulation symbol is allocatable among PUSCH resources in slot i may be used for HARQ-ACK modulation symbols. However, when one TB is transmitted over multiple slots, and if sufficient resources are available for a UL-SCH in other slots, a sufficient number of REs may be used for the UL-SCH even if all resources are used for HARQ-ACK modulation symbols in one slot.

Hereinafter, in the present disclosure, a description will be provided for a method of determining the maximum number Y of modulation symbols to be used for UCI among PUSCH resources.

### Third Embodiment: Calculating the Number of Modulation Symbols in Ascending Order of Slot Indexes

According to the third embodiment, the maximum number Y of modulation symbols to be used for UCI among PUSCH resources may be determined in ascending order of slot indexes. That is, the number of modulation symbols of UCI may be determined in chronological order in the time domain.

Specifically, when there are N PUCCHs that collide with a PUSCH, it is assumed, for each PUCCH, that Q′_{ACK} is Q′_{ACK} (1), Q′_{ACK} (2), Q′_{ACK} (N), Q′_{CSI-1} is Q′_{CSI-1} (1), Q′_{CSI-1} (2), . . . , Q′_{CSI-1} (N), and Q′_{CSI-2} is Q′_{CSI-2} (1), Q′_{CSI-2} (2), Q′_{CSI-2} (N). Here, the indexes are arranged in chronological order. A method for the UE to determine the maximum number Y of modulation symbols to be used for UCI among PUSCH resources is as follows. For reference, Y_{ACK}(i) denotes the maximum number of modulation symbols to be used for HARQ-ACK among PUSCH resources in slot i, Y_{CSI-1}(i) denotes the maximum number of modulation symbols to be used for CSI part 1 among the PUSCH resources in slot i, and Y_{CSI-2}(i) denotes the maximum number of modulation symbols to be used for CSI part 2 among PUSCH resources in slot i.

The maximum number of modulation symbols to be used for HARQ-ACK, CSI part 1, and CSI part 2 may be determined from the earliest slot (slot index 1) in time. In this case, the maximum number of modulation symbols may need to satisfy the following two conditions.

A first condition: (a condition for an available RE of a PUSCH in each slot) The maximum number of modulation symbols should be less than the number of REs available for UCI among REs of the PUSCH in each slot. For example, for HARQ-ACK in slot i, the number of modulation symbols of the HARQ-ACK should be less than

$${\sum }_{l = {l}_{0} ( i )}^{{N}_{symb , all}^{PUSCH} ( i ) - 1} - {M}_{sc}^{UCI} ( i , l ) .$$

For CSI part 1 in slot i, the number of modulation symbols of CSI part 1 should be less than

$${\sum }_{l = 0}^{{N}_{symb , all}^{PUSCH} ( i ) - 1} - {M}_{sc}^{UCI} ( i , l ) - {Q}_{ACK}^{′} ( i ) .$$

For CSI part 2 in slot i, the number of modulation symbols of CSI part 2 should be less than

$${\sum }_{l = 0}^{{N}_{symb , all}^{PUSCH} ( i ) - 1} - {M}_{sc}^{UCI} ( i , l ) - {Q}_{ACK}^{′} ( i ) - {Q}_{CSI - 1}^{′} ( i ) .$$

A second condition: (a condition for an available RE of a PUSCH in all slots, including an a value) The number of REs available for UCI among REs of the PUSCH in all slots is a out of the total number of REs. For example, for HARQ-ACK in slot i, the number of modulation symbols of the HARQ-ACK should be less than

$$⌈ α {\sum }_{k = 0}^{K - 1} {\sum }_{l = 0}^{{N}_{symb , all}^{PUSCH} ( k ) - 1} {M}_{sc}^{UCI} ( k , l ) ⌉ - \# \_of \_UCI \_REs \_in \_the \_earlier \_slots .$$

Here, #-of-UCI_RE_in_the_earlier_slots is the number of REs used for UCI up to a previous slot (slots 1, 2, . . . , i-1). For CSI part 1 in slot i, the number of modulation symbols of CSI part 1 should be less than

$$⌈ α {\sum }_{k = 0}^{K - 1} {\sum }_{l = 0}^{{N}_{symb , all}^{PUSCH} ( k ) - 1} {M}_{sc}^{UCI} ( k , l ) ⌉ - \# \_of \_UCI \_REs \_in \_the \_earlier \_slots - {Q}_{ACK}^{′} ( i ) .$$

When compared to the number of modulation symbols of HARQ-ACK, CSI part 1 has less modulation symbols by the number of HARQ-ACK modulation symbols in slot I. For CSI part 2 in slot i, the number of modulation symbols of CSI part 2 should be less than

$$⌈ α {\sum }_{k = 0}^{K - 1} {\sum }_{l = 0}^{{N}_{symb , all}^{PUSCH} ( k ) - 1} {M}_{sc}^{UCI} ( k , l ) ⌉ - \# \_of \_UCI \_REs \_in \_the \_earlier \_slots - {Q}_{ACK}^{′} ( i ) - {Q}_{CSI - 1}^{′} ( i ) .$$

When compared to the number of modulation symbols of CSI part 1, CSI part 2 has less modulation symbols by Q′_{CSI-1}(t) which is the number of CSI part 1 modulation symbols in slot i.

The number Y of modulation symbols calculated sequentially according to the conditions is as follows.

Equation 20 below represents the number of modulation symbols in slot index 1.

$${Q}_{ACK}^{′} ( 1 ) \leq {Y}_{ACK} ( 1 ) = min \{ \begin{matrix}{\sum }_{l = {l}_{0} ( 1 )}^{{N}_{symb , all}^{PUSCH} ( 1 ) - 1} {M}_{sc}^{UCI} ( 1 , l ) , \\ ⌈ α {\sum }_{k = 0}^{K - 1} {\sum }_{l = 0}^{{N}_{symb , all}^{PUSCH} ( k ) - 1} {M}_{sc}^{UCI} ( k , l ) ⌉\end{matrix} \} . \qquad [ Equation 20 ]$$

$${Q}_{CSI - 1}^{′} ( 1 ) \leq {Y}_{CSI - 1} ( 1 ) = min \{ \begin{matrix}{\sum }_{l = 0}^{{N}_{symb , all}^{PUSCH} ( 1 ) - 1} - {M}_{sc}^{UCI} ( 1 , l ) - {Q}_{ACK}^{′} ( 1 ) , \\ ⌈ α {\sum }_{k = 0}^{K - 1} {\sum }_{l = 0}^{{N}_{symb , all}^{PUSCH} ( k ) - 1} {M}_{sc}^{UCI} ( k , l ) ⌉ - {Q}_{ACK}^{′} ( 1 )\end{matrix} \} ,$$

$${Q}_{CSI - 2}^{′} ( 1 ) \leq {Y}_{CSI - 2} ( 1 ) = min \{ \begin{matrix}{\sum }_{l = 0}^{{N}_{symb , all}^{PUSCH} ( 1 ) - 1} - {M}_{sc}^{UCI} ( 1 , l ) - {Q}_{ACK}^{′} ( 1 ) - {Q}_{CSI - 1}^{′} ( 1 ) , \\ ⌈ α {\sum }_{k = 0}^{K - 1} {\sum }_{l = 0}^{{N}_{symb , all}^{PUSCH} ( k ) - 1} {M}_{sc}^{UCI} ( k , l ) ⌉ - {Q}_{ACK}^{′} ( 1 ) - {Q}_{CSI - 1}^{′} ( 1 )\end{matrix} \}$$

Equation 21 below represents the number of modulation symbols in slot index 2.

$${Q}_{ACK}^{′} ( 2 ) \leq {Y}_{ACK} ( 2 ) = min \{ \begin{matrix}{\sum }_{l = {l}_{0} ( 2 )}^{{N}_{symb , all}^{PUSCH} ( 2 ) - 1} {M}_{sc}^{UCI} ( 2 , l ) , \\ ⌈ α {\sum }_{k = 0}^{K - 1} {\sum }_{l = 0}^{{N}_{symb , all}^{PUSCH} ( k ) - 1} {M}_{sc}^{UCI} ( k , l ) ⌉ - {Q}_{tot}^{′} ( 1 )\end{matrix} \} \qquad [ Equation 21 ]$$

$${Q}_{CSI - 1}^{′} ( 2 ) \leq {Y}_{CSI - 1} ( 2 ) = min \{ \begin{matrix}{\sum }_{l = 0}^{{N}_{symb , all}^{PUSCH} ( 2 ) - 1} - {M}_{sc}^{UCI} ( 2 , l ) - {Q}_{ACK}^{′} ( 2 ) , \\ ⌈ α {\sum }_{k = 0}^{K - 1} {\sum }_{l = 0}^{{N}_{symb , all}^{PUSCH} ( k ) - 1} {M}_{sc}^{UCI} ( k , l ) ⌉ - {Q}_{tot}^{′} ( 1 ) - {Q}_{ACK}^{′} ( 2 )\end{matrix} \} ,$$

$$and$$

$${Q}_{CSI - 2}^{′} ( 2 ) \leq {Y}_{CSI - 2} ( 2 ) = min \{ \begin{matrix}{\sum }_{l = 0}^{{N}_{symb , all}^{PUSCH} ( 2 ) - 1} - {M}_{sc}^{UCI} ( 2 , l ) - {Q}_{ACK}^{′} ( 2 ) - {Q}_{CSI - 1}^{′} ( 2 ) , \\ ⌈ α {\sum }_{k = 0}^{K - 1} {\sum }_{l = 0}^{{N}_{symb , all}^{PUSCH} ( k ) - 1} {M}_{sc}^{UCI} ( k , l ) ⌉ - {Q}_{tot}^{′} ( 1 ) - {Q}_{ACK}^{′} ( 2 ) - {Q}_{CSI - 1}^{′} ( 2 )\end{matrix} \}$$

Equation 22 below represents the number of modulation symbols in slot index i.

$${Q}_{ACK}^{′} ( i ) \leq {Y}_{ACK} ( i ) = min \{ \begin{matrix}{\sum }_{l = {l}_{0} ( 2 )}^{{N}_{symb , all}^{PUSCH} ( i ) - 1} {M}_{sc}^{UCI} ( i , l ) , \\ ⌈ α {\sum }_{k = 0}^{K - 1} {\sum }_{l = 0}^{{N}_{symb , all}^{PUSCH} ( k ) - 1} {M}_{sc}^{UCI} ( k , l ) ⌉ - {\sum }_{l = 1}^{i - 1} {Q}_{tot}^{′} ( j )\end{matrix} \} \qquad [ Equation 22 ]$$

$${Q}_{CSI - 1}^{′} ( i ) \leq {Y}_{CSI - 1} ( i ) = min \{ \begin{matrix}{\sum }_{l = 0}^{{N}_{symb , all}^{PUSCH} ( i ) - 1} - {M}_{sc}^{UCI} ( i , l ) - {Q}_{ACK}^{′} ( i ) , \\ ⌈ α {\sum }_{k = 0}^{K - 1} {\sum }_{l = 0}^{{N}_{symb , all}^{PUSCH} ( k ) - 1} {M}_{sc}^{UCI} ( k , l ) ⌉ - {\sum }_{l = 1}^{i - 1} {Q}_{tot}^{′} ( j ) - {Q}_{ACK}^{′} ( i )\end{matrix} \} ,$$

$$and$$

$${Q}_{CSI - 2}^{′} ( i ) \leq {Y}_{CSI - 2} ( i ) = min \{ \begin{matrix}{\sum }_{l = 0}^{{N}_{symb , all}^{PUSCH} ( i ) - 1} - {M}_{sc}^{UCI} ( i , l ) - {Q}_{ACK}^{′} ( i ) - {Q}_{CSI - 1}^{′} ( i ) , \\ \begin{matrix}⌈ α {\sum }_{k = 0}^{K - 1} {\sum }_{l = 0}^{{N}_{symb , all}^{PUSCH} ( k ) - 1} {M}_{sc}^{UCI} ( k , l ) ⌉ - \\ {\sum }_{l = 1}^{i - 1} {Q}_{tot}^{′} ( j ) - {Q}_{ACK}^{′} ( i ) - {Q}_{CSI - 1}^{′} ( i )\end{matrix}\end{matrix} \} .$$

$$Here , {Q}_{tot}^{′} ( i ) = {Q}_{ACK}^{′} ( i ) + {Q}_{CSI - 1}^{′} ( i ) + {Q}_{CSI - 2}^{′} ( i ) .$$

According to a (3-1)st embodiment, a method for the UE to determine the maximum number Y of modulation symbols to be used for UCI among PUSCH resources in as follow

The number of modulation symbols for UCI transmission may be determined in ascending order (i.e., in chronological order) of indexes of slots in a specific slot set. Here, the specific slot set may include a slot including a PUSCH that collides with a PUCCH and slots consecutive to the slot in the time domain. In addition, the consecutive slots in the time domain may include slots available for PUSCH transmission. The maximum number of modulation symbols to be used for HARQ-ACK, CSI part 1, and CSI part 2 is determined from the earliest slot (slot index i₀) in time. In this case, the maximum number of modulation symbols may need to satisfy the following two conditions.

A first condition: (a condition for an available RE of a PUSCH in each slot) The maximum number of modulation symbols should be less than the number of REs available for UCI among REs of the PUSCH in each slot. For example, for HARQ-ACK in slot i, the number of modulation symbols of the HARQ-ACK should be less than

$${\sum }_{l = {l}_{0} ( i )}^{{N}_{symb , all}^{PUSCH} ( i ) - 1} - {M}_{sc}^{UCI} ( i , l ) .$$

For CSI part 1 in slot i, the number of modulation symbols of CSI part 1 should be less than

$${\sum }_{l = 0}^{{N}_{symb , all}^{PUSCH} ( i ) - 1} - {M}_{sc}^{UCI} ( i , l ) - {Q}_{ACK}^{′} ( i ) .$$

For CSI part 2 in slot i, the number of modulation symbols of CSI part 2 should be less than

$${\sum }_{l = 0}^{{N}_{symb , all}^{PUSCH} ( i ) - 1} - {M}_{sc}^{UCI} ( i , l ) - {Q}_{ACK}^{′} ( i ) - {Q}_{CSI - 1}^{′} ( i ) .$$

A second condition: (a condition for an available RE of a PUSCH in a specific slot set, including an a value) The number of REs available for UCI among REs of the PUSCH in the specific slot set is a out of the number of REs in the specific slot set. For example, for HARQ-ACK in slot i, the number of modulation symbols of the HARQ-ACK should be less than

$$⌈ α {\sum }_{k = {i}_{0}}^{{K}^{′} - 1} {\sum }_{l = 0}^{{N}_{symb , all}^{PUSCH} ( k ) - 1} {M}_{sc}^{UCI} ( k , l ) ⌉ - \# \_of \_UCI \_REs \_in \_the \_earlier \_slots .$$

# of_UCI_REs_in_the_earlier_slots is the number of REs used for UCI up to a previous slot (slots i₀, i₀+1, . . . , i−1). K′ is the number of slots of a specific slot set including the i-th slot, that is, the number of consecutive PUSCH slots including a slot, in which a collision with a PUCCH resource occurs, in the time domain, and i₀ denotes an index of the earliest slot in the time domain in the specific slot set including the i-th slot, that is, an index of the foremost slot among the consecutive PUSCH slots in the time domain including the slot in which a collision with a PUCCH resource occurs. For CSI part 1 in slot i, the number of modulation symbols of CSI part 1 should be less than

$$⌈ α {\sum }_{k = {i}_{0}}^{{K}^{′} - 1} {\sum }_{l = 0}^{{N}_{symb , all}^{PUSCH} ( k ) - 1} {M}_{sc}^{UCI} ( k , l ) ⌉ - \# \_of \_UCI \_REs \_in \_the \_earlier \_slots - {Q}_{ACK}^{′} ( i ) .$$

When compared to the number of modulation symbols of HARQ-ACK, CSI part 1 has less modulation symbols by Q′_{ACK}(i) which is the number of HARQ-ACK modulation symbols in slot i. For CSI part 2 in slot i, the number of modulation symbols of CSI part 2 should be less than

$$⌈ α {\sum }_{k = {i}_{0}}^{{K}^{′} - 1} {\sum }_{i = 0}^{{N}_{symb , all}^{PUSCH} ( k ) - 1} {M}_{sc}^{UCI} ( k , l ) ⌉ - \# \_of \_UCI \_REs \_in \_the \_earlier \_slots - {Q}_{ACK}^{′} ( i ) - {Q}_{CSI - 1}^{′} ( i ) .$$

When compared to the number of modulation symbols of CSI part 1, CSI part 2 has less modulation symbols by Q′_{CSI-1}(i) which is the number of CSI part 1 modulation symbols in slot i.

The number Y of modulation symbols calculated sequentially according to the conditions is as follows.

Equation 23 below represents the number of modulation symbols in slot index i₀.

$${Q}_{ACK}^{′} ( {i}_{0} ) \leq {Y}_{ACK} ( {i}_{0} ) = min \{ \begin{matrix}{\sum }_{l = {l}_{0} ( {i}_{0} )}^{{N}_{symb , all}^{PUSCH} ( {i}_{0} ) - 1} {M}_{sc}^{UCI} ( {i}_{0} , l ) , \\ ⌈ α {\sum }_{k = {i}_{0}}^{{K}^{′} - 1} {\sum }_{i = 0}^{{N}_{symb , all}^{PUSCH} ( k ) - 1} {M}_{sc}^{UCI} ( k , l ) ⌉\end{matrix} \} , \qquad [ Equation 23 ]$$

$${Q}_{CSI - 1}^{′} ( {i}_{0} ) \leq {Y}_{CSI - 1} ( {i}_{0} ) = min \{ \begin{matrix}{\sum }_{l = {l}_{0} ( {i}_{0} )}^{{N}_{symb , all}^{PUSCH} ( {i}_{0} ) - 1} {M}_{sc}^{UCI} ( {i}_{0} , l ) - {Q}_{ACK}^{′} ( {i}_{0} ) , \\ ⌈ α {\sum }_{k = {i}_{0}}^{{K}^{′} - 1} {\sum }_{l = 0}^{{N}_{symb , all}^{PUSCH} ( k ) - 1} {M}_{sc}^{UCI} ( k , l ) ⌉ - {Q}_{ACK}^{′} ( {i}_{0} )\end{matrix} \} ,$$

$${Q}_{CSI - 2}^{′} ( {i}_{0} ) \leq {Y}_{CSI - 2} ( {i}_{0} ) = min \{ \begin{matrix}{\sum }_{l = 0}^{{N}_{symb , all}^{PUSCH} ( {i}_{0} ) - 1} {M}_{sc}^{UCI} ( {i}_{0} , l ) - {Q}_{ACK}^{′} ( {i}_{0} ) - {Q}_{CSI - 1}^{′} ( {i}_{0} ) , \\ ⌈ α {\sum }_{k = {i}_{0}}^{{K}^{′} - 1} {\sum }_{l = 0}^{{N}_{symb , all}^{PUSCH} ( k ) - 1} {M}_{sc}^{UCI} ( k , l ) ⌉ - {Q}_{ACK}^{′} ( {i}_{0} ) - {Q}_{CSI - 1}^{′} ( {i}_{0} )\end{matrix} \}$$

Equation 24 below represents the number of modulation symbols in slot index i₀+1.

$${Q}_{ACK}^{′} ( {i}_{0} + 1 ) \leq {Y}_{ACK} ( {i}_{0} + 1 ) = min \{ \begin{matrix}{\sum }_{l = {l}_{0} ( {i}_{0} + 1 )}^{{N}_{symb , all}^{PUSCH} ( {i}_{0} + 1 ) - 1} {M}_{sc}^{UCI} ( {i}_{0} + 1 , l ) , \\ ⌈ α {\sum }_{k = {i}_{0}}^{{K}^{′} - 1} {\sum }_{i = 0}^{{N}_{symb , all}^{PUSCH} ( k ) - 1} {M}_{sc}^{UCI} ( k , l ) ⌉ - {Q}_{tot}^{′} ( {i}_{0} )\end{matrix} \} , \qquad [ Equation 24 ]$$

$${Q}_{CSI - 1}^{′} ( {i}_{0} + 1 ) \leq {Y}_{CSI - 1} ( {i}_{0} + 1 ) = min \{ \begin{matrix}{\sum }_{l = 0}^{{N}_{symb , all}^{PUSCH} ( {i}_{0} + 1 ) - 1} {M}_{sc}^{UCI} ( {i}_{0} + 1 , l ) - {Q}_{ACK}^{′} ( {i}_{0} + 1 ) , \\ ⌈ α {\sum }_{k = {i}_{0}}^{{K}^{′} - 1} {\sum }_{l = 0}^{{N}_{symb , all}^{PUSCH} ( k ) - 1} {M}_{sc}^{UCI} ( k , l ) ⌉ - {Q}_{tot}^{′} ( {i}_{0} ) - {Q}_{ACK}^{′} ( {i}_{0} + 1 )\end{matrix} \} , and$$

$${Q}_{CSI - 2}^{′} ( {i}_{0} + 1 ) \leq {Y}_{CSI - 2} ( {i}_{0} + 1 ) = min \{ \begin{matrix}\begin{matrix}{\sum }_{l = 0}^{{N}_{symb , all}^{PUSCH} ( {i}_{0} + 1 ) - 1} {M}_{sc}^{UCI} ( {i}_{0} + 1 , l ) - \\ {Q}_{ACK}^{′} ( {i}_{0} + 1 ) - {Q}_{CSI - 1}^{′} ( {i}_{0} + 1 ) ,\end{matrix} \\ \begin{matrix}⌈ α {\sum }_{k = {i}_{0}}^{{K}^{′} - 1} {\sum }_{l = 0}^{{N}_{symb , all}^{PUSCH} ( k ) - 1} {M}_{sc}^{UCI} ( k , l ) ⌉ - \\ {Q}_{tot}^{′} ( {i}_{0} ) - {Q}_{ACK}^{′} ( {i}_{0} + 1 ) - {Q}_{CSI - 1}^{′} ( {i}_{0} + 1 )\end{matrix}\end{matrix} \}$$

Equation 25 below represents the number of modulation symbols in slot index i.

$${Q}_{ACK}^{′} ( {i}_{0} ) \leq {Y}_{ACK} ( i ) = min \{ \begin{matrix}{\sum }_{l = {l}_{0} ( i )}^{{N}_{symb , all}^{PUSCH} ( i ) - 1} {M}_{sc}^{UCI} ( i , l ) , \\ \begin{matrix}⌈ α {\sum }_{k = {i}_{0}}^{{K}^{′} - 1} {\sum }_{i = 0}^{{N}_{symb , all}^{PUSCH} ( k ) - 1} {M}_{sc}^{UCI} ( k , l ) ⌉ - \\ {\sum }_{j = {i}_{0}}^{i - 1} {Q}_{tot}^{′} ( j )\end{matrix}\end{matrix} \} , \qquad [ Equation 25 ]$$

$${Q}_{CSI - 1}^{′} ( i ) \leq {Y}_{CSI - 1} ( i ) = min \{ \begin{matrix}{\sum }_{l = 0}^{{N}_{symb , all}^{PUSCH} ( i ) - 1} {M}_{sc}^{UCI} ( i , l ) - {Q}_{ACK}^{′} ( i ) , \\ ⌈ α {\sum }_{k = {i}_{0}}^{{K}^{′} - 1} {\sum }_{l = 0}^{{N}_{symb , all}^{PUSCH} ( k ) - 1} {M}_{sc}^{UCI} ( k , l ) ⌉ - {\sum }_{j = {i}_{0}}^{i - 1} {Q}_{tot}^{′} ( j ) - {Q}_{ACK}^{′} ( i )\end{matrix} \} , and$$

$${Q}_{CSI - 2}^{′} ( i ) \leq {Y}_{CSI - 2} ( i ) = min \{ \begin{matrix}{\sum }_{l = 0}^{{N}_{symb , all}^{PUSCH} ( i ) - 1} {M}_{sc}^{UCI} ( i , l ) - {Q}_{ACK}^{′} ( i ) - {Q}_{CSI - 1}^{′} ( i ) , \\ \begin{matrix}⌈ α {\sum }_{k = {i}_{0}}^{{K}^{′} - 1} {\sum }_{l = 0}^{{N}_{symb , all}^{PUSCH} ( k ) - 1} {M}_{sc}^{UCI} ( k , l ) ⌉ - \\ {\sum }_{j = {i}_{0}}^{i - 1} {Q}_{tot}^{′} ( j ) - {Q}_{ACK}^{′} ( i ) - {Q}_{CSI - 1}^{′} ( i )\end{matrix}\end{matrix} \}$$

$$Here , {Q}_{tot}^{′} ( i ) = {Q}_{ACK}^{′} ( i ) + {Q}_{CSI - 1}^{′} ( i ) + {Q}_{CSI - 2}^{′} ( i ) .$$

In a scheme according to the third embodiment, the UE determines the number of modulation symbols to be used for UCI in chronological order. However, according to this scheme, CSI part 1 or CSI part 2 in a slot that comes earlier is preferentially assigned with the number of modulation symbols, compared to HARQ-ACK in a slot that comes later. Accordingly, there may be a shortage of REs to be allocated to more important HARQ-ACK. A method to solve this problem is disclosed.

### Fourth Embodiment: Calculating the Number of Modulation Symbols According to a UCI Type

According to the fourth embodiment, the number of modulation symbols of each parameter of UCI to be multiplexed on a PUSCH may be calculated according to a type of the UCI.

Specifically, when a TB is transmitted via multiple slots and thus a TBS exceeds one slot, and a symbol in which a part of the TB and a symbol in which UCI of a PUCCH overlap in each slot, the UCI of the PUCCH and a PUSCH may be multiplexed and transmitted. In this case, the number of modulation symbols of each parameter of the UCI may be determined based on a type of the UCI. Here, the number of modulation symbols for HARQ-ACK transmission is calculated before the number of modulation symbols for CSI part 1 or CSI part 2 transmission. The number of modulation symbols for CSI part 1 transmission is calculated before the number of modulation symbols for CSI part 2 transmission. For a UCI type, the number of modulation symbols for UCI transmission may be determined in ascending order (i.e., in chronological order) of slot indexes.

More specifically, when there are N PUCCHs that collide with a PUSCH, it is assumed, for each PUCCH, that Q′_{ACK} is Q′_{ACK} (1), Q′_{ACK} (2), . . . , Q′_{ACK}(N), Q′_{CSI-1} is Q′_{CSI-1}(1), Q′_{CSI-1} (2), . . . , Q′_{CSI-1}(N), and Q′_{CSI-2} is Q′_{CSI-2} (1), Q′_{CSI-2} (2), . . . , Q′_{CSI-2} (N). Here, the indexes are arranged in chronological order. A method for the UE to determine the maximum number Y of modulation symbols to be used for UCI among PUSCH resources is as follows. For reference, Y_{ACK}(i) denotes the maximum number of modulation symbols to be used for HARQ-ACK among PUSCH resources in slot i, Y_{CSI-1}(i) denotes the maximum number of modulation symbols to be used for CSI part 1 among the PUSCH resources in slot i, and Y_{CSI-2}(i) denotes the maximum number of modulation symbols to be used for CSI part 2 among PUSCH resources in slot i.

Depending on a UCI type, the maximum number of modulation symbols to be used for HARQ-ACK, CSI part 1, and CSI part 2 is determined. In this case, the maximum number of modulation symbols may need to satisfy the following two conditions.

A first condition: (a condition for an available RE of a PUSCH in each slot) The maximum number of modulation symbols should be less than the number of REs available for UCI among REs of the PUSCH in each slot. For example, for HARQ-ACK in slot i, the number of modulation symbols of the HARQ-ACK should be less than

$${\sum }_{l = {l}_{0} ( i )}^{{N}_{symb , all}^{PUSCH} ( i ) - 1} {M}_{sc}^{UCI} ( i , l ) .$$

For CSI part 1 in slot i, the number of modulation symbols of CSI part 1 should be less than

$${\sum }_{l = 0}^{{N}_{symb , all}^{PUSCH} ( i ) - 1} {M}_{sc}^{UCI} ( i , l ) - {Q}_{ACK}^{′} ( i ) .$$

For CSI part 2 in slot i, the number of modulation symbols of CSI part 2 should be less than

$${\sum }_{l = 0}^{{N}_{symb , all}^{PUSCH} ( i ) - 1} {M}_{sc}^{UCI} ( i , l ) - {Q}_{ACK}^{′} ( i ) - {Q}_{CSI - 1}^{′} ( i ) .$$

A second condition: (a condition for an available RE of a PUSCH in all slots, including an a value) The number of REs available for UCI among REs of the PUSCH in all slots is a out of the total number of REs. For example, for HARQ-ACK in slot i, the number of modulation symbols of the HARQ-ACK should be less than

$$⌈ α {\sum }_{k = 0}^{K} {\sum }_{l = 0}^{{N}_{symb , all}^{PUSCH} ( k ) - 1} {M}_{sc}^{UCI} ( k , l ) ⌉ - \# \_of \_HARQ \_ACK \_REs \_in \_the \_earlier \_slots .$$

Here, #_of_HARQ_ACK_REs_in_the_slots is the number of modulation symbols used for HARQ-ACK up to a previous slot (slots 1, 2, . . . , i−1). For CSI part 1 in slot i, the number of modulation symbols of CSI part 1 should be less than

$$⌈ α {\sum }_{k = 0}^{K - 1} {\sum }_{l = 0}^{{N}_{symb , all}^{PUSCH} ( k ) - 1} {M}_{sc}^{UCI} ( k , l ) ⌉ - \# \_of \_HARQ \_ACK \_REs \_in \_the \_slots - \# \_of \_CSI \_part1 \_REs \_in \_the \_earlier \_slots .$$

Here, #_of_HARQ_ACK_REs_in_the_slots is the number of modulation symbols for HARQ-ACK transmission in all slots, and #_of_CSI_partlREs_in_the_earlier_slots is the number of modulation symbols used for CSI part 1 up to a previous slot (slots 1, 2, . . . , i−1). For CSI part 2 in slot i, the number of modulation symbols of CSI part 2 should be less than

$$⌈ α {\sum }_{k = 0}^{K - 1} {\sum }_{l = 0}^{{N}_{symb , all}^{PUSCH} ( k ) - 1} {M}_{sc}^{UCI} ( k , l ) ⌉ - \# \_of \_HARQ \_ACK \_REs \_in \_the \_slots - \# \_of \_CSI \_part1 \_REs \_in \_the \_slots - \# \_of \_CSI \_part2 \_REs \_in \_the \_earlier \_slots$$

Here, #_of_CSI_part1_REs_in_the_slots is the number of modulation symbols for CSI part 2 transmission in all s lots, and #_of_CSI_part2_REs_in_the_earlier_slots is the number of modulation symbols used for CSI part 2 up to a previous slot (slots 1, 2, . . . , i−1).

The number Y of modulation symbols of each parameter of UCI calculated sequentially according to the conditions is as follows.

Equation 26 below represents the number of modulation symbols of HARQ-ACK according to a UCI index.

$${Q}_{ACK}^{′} ( 1 ) \leq {Y}_{ACK} ( 1 ) = min \{ {\sum }_{l = {l}_{0} ( 1 )}^{{N}_{symb , all}^{PUSCH} ( 1 ) - 1} {M}_{sc}^{UCI} ( 1 , l ) , \\ ⌈ α {\sum }_{k = 0}^{K - 1} {\sum }_{l = 0}^{{N}_{symb , all}^{PUSCH} ( k ) - 1} {M}_{sc}^{UCI} ( k , l ) ⌉ \} , \qquad [ Equation 26 ]$$

$${Q}_{ACK}^{′} ( 2 ) \leq {Y}_{ACK} ( 2 ) = min \{ {\sum }_{l = {l}_{0} ( 2 )}^{{N}_{symb , all}^{PUSCH} ( 2 ) - 1} {M}_{sc}^{UCI} ( 2 , l ) , \\ ⌈ α {\sum }_{k = 0}^{K - 1} {\sum }_{l = 0}^{{N}_{symb , all}^{PUSCH} ( k ) - 1} {M}_{sc}^{UCI} ( k , l ) ⌉ - {Q}_{ACK}^{′} ( 1 ) \} ,$$

$${Q}_{ACK}^{′} ( i ) \leq {Y}_{ACK} ( i ) = min \{ {\sum }_{l = {l}_{0} ( i )}^{{N}_{symb , all}^{PUSCH} ( i ) - 1} {M}_{sc}^{UCI} ( i , l ) , \\ ⌈ α {\sum }_{k = 0}^{K - 1} {\sum }_{l = 0}^{{N}_{symb , all}^{PUSCH} ( k ) - 1} {M}_{sc}^{UCI} ( k , l ) ⌉ - {\sum }_{j = 1}^{i - 1} {Q}_{ACK}^{′} ( j ) \} ,$$

Equation 27 below represents the number of modulation symbols of CSI part 1 according to a UCI index.

$${Q}_{CSI - 1}^{′} ( 1 ) \leq {Y}_{CSI - 1} ( 1 ) = min \{ \begin{matrix}{\sum }_{l = 0}^{{N}_{symb , all}^{PUSCH} ( 1 ) - 1} {M}_{sc}^{UCI} ( 1 , l ) - {Q}_{ACK}^{′} ( 1 ) , \\ ⌈ α {\sum }_{k = 0}^{K - 1} {\sum }_{l = 0}^{{N}_{symb , all}^{PUSCH} ( k ) - 1} {M}_{sc}^{UCI} ( k , l ) ⌉ - {Q}_{ACK - tot}^{′}\end{matrix} \} , and \qquad [ Equation 27 ]$$

$${Q}_{CSI - 1}^{′} ( 2 ) \leq {Y}_{CSI - 1} ( 2 ) = min \{ \begin{matrix}{\sum }_{l = 0}^{{N}_{symb , all}^{PUSCH} ( 2 ) - 1} {M}_{sc}^{UCI} ( 2 , l ) - {Q}_{ACK}^{′} ( 2 ) , \\ ⌈ α {\sum }_{k = 0}^{K - 1} {\sum }_{l = 0}^{{N}_{symb , all}^{PUSCH} ( k ) - 1} {M}_{sc}^{UCI} ( k , l ) ⌉ - {Q}_{ACK - tot}^{′} - {Q}_{CSI - 1}^{′} ( 1 )\end{matrix} \}$$

$${Q}_{CSI - 1}^{′} ( i ) \leq {Y}_{CSI - 1} ( i ) = min \{ \begin{matrix}{\sum }_{l = 0}^{{N}_{symb , all}^{PUSCH} ( i ) - 1} {M}_{sc}^{UCI} ( i , l ) - {Q}_{ACK}^{′} ( i ) , \\ \begin{matrix}⌈ α {\sum }_{k = 0}^{K - 1} {\sum }_{l = 0}^{{N}_{symb , all}^{PUSCH} ( k ) - 1} {M}_{sc}^{UCI} ( k , l ) ⌉ - \\ {Q}_{ACK - tot}^{′} - {\sum }_{j = 1}^{i - 1} {Q}_{CSI - 1}^{′} ( j )\end{matrix}\end{matrix} \}$$

Equation 28 below represents the number of modulation symbols of CSI part 2 according to a UCI index.

$${Q}_{CSI - 2}^{′} ( 1 ) \leq {Y}_{CSI - 2} ( 1 ) = min \{ \begin{matrix}\begin{matrix}{\sum }_{l = 0}^{{N}_{symb , all}^{PUSCH} ( 1 ) - 1} {M}_{sc}^{UCI} ( 1 , l ) - \\ {Q}_{ACK}^{′} ( 1 ) - {Q}_{CSI - 1}^{′} ( 1 ) ,\end{matrix} \\ \begin{matrix}⌈ α {\sum }_{k = 0}^{K - 1} {\sum }_{l = 0}^{{N}_{symb , all}^{PUSCH} ( k ) - 1} {M}_{sc}^{UCI} ( k , l ) ⌉ - \\ {Q}_{ACK - tot}^{′} - {Q}_{CSI - 1 - tot}^{′}\end{matrix}\end{matrix} \} , and \qquad [ Equation 28 ]$$

$${Q}_{CSI - 2}^{′} ( 2 ) \leq {Y}_{CSI - 2} ( 2 ) = min \{ \begin{matrix}{\sum }_{l = 0}^{{N}_{symb , all}^{PUSCH} ( 2 ) - 1} {M}_{sc}^{UCI} ( 2 , l ) - {Q}_{ACK}^{′} ( 2 ) - {Q}_{CSI - 1}^{′} ( 2 ) , \\ \begin{matrix}⌈ α {\sum }_{k = 0}^{K - 1} {\sum }_{l = 0}^{{N}_{symb , all}^{PUSCH} ( k ) - 1} {M}_{sc}^{UCI} ( k , l ) ⌉ - \\ {Q}_{ACK - tot}^{′} - {Q}_{CSI - 1 - tot}^{′} - {Q}_{CSI - 2}^{′} ( 1 )\end{matrix}\end{matrix} \}$$

$${Q}_{CSI - 2}^{′} ( i ) \leq {Y}_{CSI - 2} ( i ) = min \{ \begin{matrix}{\sum }_{l = 0}^{{N}_{symb , all}^{PUSCH} ( i ) - 1} {M}_{sc}^{UCI} ( i , l ) - {Q}_{ACK}^{′} ( i ) - {Q}_{CSI - 1}^{′} ( i ) , \\ \begin{matrix}⌈ α {\sum }_{k = 0}^{K - 1} {\sum }_{l = 0}^{{N}_{symb , all}^{PUSCH} ( k ) - 1} {M}_{sc}^{UCI} ( k , l ) ⌉ - \\ {Q}_{ACK - tot}^{′} - {Q}_{CSI - 1 - tot}^{′} - {\sum }_{j = 1}^{i - 1} {Q}_{CSI - 2}^{′} ( j )\end{matrix}\end{matrix} \}$$

In Equations 26 to 28,

$${Q}_{ACK - tot}^{′} = {Q}_{ACK}^{′} ( 1 ) + {Q}_{ACK}^{′} ( 2 ) + … {Q}_{ACK}^{′} ( N ) and$$

$${Q}_{CSI - 1 - tot}^{′} = {Q}_{CSI - 1}^{′} ( 1 ) + {Q}_{CSI - 1}^{′} ( 2 ) + … {Q}_{CSI - 1}^{′} ( N ) .$$

According to a (4-1)st embodiment, depending on a UCI type, the UE may determine the number of modulation symbols used for UCI transmission as follows.

For a UCI type, the number of modulation symbols for UCI transmission may be determined in ascending order (i.e., in chronological order) of indexes of slots in a specific slot set. Here, the specific slot set may include a slot including a PUSCH that collides with a PUCCH and slots consecutive to the slot in the time domain. In addition, the consecutive slots in the time domain may include slots available for PUSCH transmission. Depending on a UCI type, the UE may determine the maximum number of modulation symbols to be used for HARQ-ACK, CSI part 1, and CSI part 2. In this case, the maximum number of modulation symbols may need to satisfy the following two conditions.

A first condition: (a condition for an available RE of a PUSCH in each slot) The maximum number of modulation symbols should be less than the number of REs available for UCI among REs of the PUSCH in each slot. For example, for HARQ-ACK in slot i, the number of modulation symbols of the HARQ-ACK should be less than

$${\sum }_{l = {l}_{0} ( i )}^{{N}_{symb , all}^{PUSCH} ( i ) - 1} {M}_{sc}^{UCI} ( i , l ) .$$

For CSI part 1 in slot i, the number of modulation symbols of CSI part 1 should be less than

$${\sum }_{i = 0}^{{N}_{symb , all}^{PUSCH} ( i ) - 1} {M}_{SC}^{UCI} ( i , l ) - {Q}_{ACK}^{′} ( i ) .$$

For CSI part 2 in slot i, the number of modulation symbols of CSI part 2 should be less than

$${\sum }_{i = 0}^{{N}_{symb , all}^{PUSCH} ( i ) - 1} {M}_{SC}^{UCI} ( i , l ) - {Q}_{ACK}^{′} ( i ) - {Q}_{CSI - 1}^{′} ( i ) .$$

A second condition: (a condition for an available RE of a PUSCH in a specific slot set, including a value) The number of REs available for UCI among REs of the PUSCH in the specific slot set is a out of the number of REs in the specific slot set. For example, for HARQ-ACK in slot i, the number of modulation symbols of the HARQ-ACK should be less than

$$⌈ α {\sum }_{k = {i}_{0}}^{{K}^{′} - 1} {\sum }_{i = 0}^{{N}_{symb , all}^{PUSCH} ( k ) - 1} {M}_{SC}^{UCI} ( k , l ) ⌉ - \# \_of \_HARQ \_ACK \_REs \_in \_the \_earlier \_slots .$$

Here, #_of_HARQ_ACK_REsIn_the_earlier_slots is the number of modulation symbols used for HARQ-ACK up to a previous slot (slots i₀, i₀+1, . . . , i−1). K′ is the number of slots of a specific slot set including the i-th slot, that is, the number of consecutive PUSCH slots including a slot, in which a collision with a PUCCH resource occurs, in the time domain, and i₀ denotes an index of the earliest slot in the time domain in the specific slot set including the i-th slot, that is, an index of the foremost slot among the consecutive PUSCH slots in the time domain including the slot in which a collision with a PUCCH resource occurs. For CSI part 1 in slot i, the number of modulation symbols of CSI part 1 should be less than

$$⌈ α {\sum }_{k = {i}_{0}}^{{K}^{′} - 1} {\sum }_{i = 0}^{{N}_{symb , all}^{PUSCH} ( k ) - 1} {M}_{SC}^{UCI} ( k , l ) ⌉ - \# \_of \_HARQ \_ACK \_REs \_in \_the \_slots - \# \_of \_CSI \_part1 \_REs \_in \_the \_earlier \_slots .$$

Here, #_of_HARQ_ACK_REs_in_the_slots is the number of modulation symbols for HARQ-ACK transmission in all slots in the specific slot set, and #_of_CSI_part1_REs_in_the_earlier_slots is the number of modulation symbols used for CSI part 1 up to a previous slot (slots i₀, i₀+1, . . . , i−1). For CSI part 2 in slot i, the number of modulation symbols of CSI part 2 should be less than

$$⌈ α {\sum }_{k = {i}_{0}}^{{K}^{′} - 1} {\sum }_{i = 0}^{{N}_{symb , all}^{PUSCH} ( k ) - 1} {M}_{SC}^{UCI} ( k , l ) ⌉ - \# \_of \_HARQ \_ACK \_REs \_in \_the \_slots - \# \_of \_CSI \_part1 \_REs \_in \_the \_slots - \# \_of \_CSI \_part2 \_REs \_in \_the \_earlier \_slots .$$

#_of_CSI_part2_REs_in_the_slots is the number of modulation symbols for CSI part 2 transmission in all slots in the specific slot set, and #_of_CSI_part2_REs_in_the_earlier_slots is the number of modulation symbols used for CSI part 2 up to a previous slot (slots i₀, i₀+1, . . . , i−1).

The number Y of modulation symbols of parameters of UCI calculated sequentially according to the conditions is as follows.

Equation 29 below represents the number of modulation symbols of HARQ-ACK according to a UCI index.

$${Q}_{ACK}^{′} ( {i}_{0} ) \leq {Y}_{ACK} ( {i}_{0} ) = min \{ \begin{matrix}{\sum }_{i = 0}^{{N}_{symb , all}^{PUSCH} ( {i}_{0} ) - 1} {M}_{sc}^{UCI} ( {i}_{0} , l ) , \\ ⌈ α {\sum }_{k = {i}_{0}}^{{K}^{′} - 1} {\sum }_{i = 0}^{{N}_{symb , all}^{PUSCH} ( k ) - 1} {M}_{sc}^{UCI} ( k , l ) ⌉\end{matrix} \} , \qquad [ Equation 29 ]$$

$${Q}_{ACK}^{′} ( {i}_{0} + 1 ) \leq {Y}_{ACK} ( {i}_{0} + 1 ) = min \{ \begin{matrix}{\sum }_{i = 0}^{{N}_{symb , all}^{PUSCH} ( {i}_{0} + 1 ) - 1} {M}_{sc}^{UCI} ( {i}_{0} + 1 , l ) , \\ ⌈ α {\sum }_{k = {i}_{0}}^{{K}^{′} - 1} {\sum }_{i = 0}^{{N}_{symb , all}^{PUSCH} ( k ) - 1} {M}_{sc}^{UCI} ( k , l ) ⌉ - {Q}_{ACK}^{′} ( {i}_{0} )\end{matrix} \} ,$$

$${Q}_{ACK}^{′} ( i ) \leq {Y}_{ACK} ( i ) = min \{ \begin{matrix}{\sum }_{i = 0}^{{N}_{symb , all}^{PUSCH} ( {i}_{0} + 1 ) - 1} {M}_{sc}^{UCI} ( i , l ) , \\ ⌈ α {\sum }_{k = {i}_{0}}^{{K}^{′} - 1} {\sum }_{i = 0}^{{N}_{symb , all}^{PUSCH} ( k ) - 1} {M}_{sc}^{UCI} ( k , l ) ⌉ - {\sum }_{j = {i}_{0}}^{i - 1} {Q}_{ACK}^{′} ( j )\end{matrix} \}$$

Equation 30 below represents the number of modulation symbols of CSI part 1 according to a UCI index.

$${Q}_{CSI - 1}^{′} ( {i}_{0} ) \leq {Y}_{CSI - 1} ( {i}_{0} ) = min \{ \begin{matrix}{\sum }_{i = 0}^{{N}_{symb , all}^{PUSCH} ( {i}_{0} ) - 1} {M}_{sc}^{UCI} ( {i}_{0} , l ) - {Q}_{ACK}^{′} ( {i}_{0} ) , \\ ⌈ α {\sum }_{k = {i}_{0}}^{{K}^{′} - 1} {\sum }_{i = 0}^{{N}_{symb , all}^{PUSCH} ( k ) - 1} {M}_{sc}^{UCI} ( k , l ) ⌉ - {Q}_{ACK - tot}^{′}\end{matrix} \} , \qquad [ Equation 30 ]$$

$$and$$

$${Q}_{CSI - 1}^{′} ( {i}_{0} + 1 ) \leq {Y}_{CSI - 1} ( {i}_{0} + 1 ) = min \{ \begin{matrix}{\sum }_{i = 0}^{{N}_{symb , all}^{PUSCH} ( {i}_{0} ) - 1} {M}_{sc}^{UCI} ( {i}_{0} + 1 , l ) - {Q}_{ACK}^{′} ( {i}_{0} + 1 ) , \\ ⌈ α {\sum }_{k = {i}_{0}}^{{K}^{′} - 1} {\sum }_{i = 0}^{{N}_{symb , all}^{PUSCH} ( k ) - 1} {M}_{sc}^{UCI} ( k , l ) ⌉ - {Q}_{ACK - tot}^{′} - {Q}_{CSI - 1}^{′} ( {i}_{0} )\end{matrix} \}$$

$${Q}_{CSI - 1}^{′} ( i ) \leq {Y}_{CSI - 1} ( i ) = min \{ \begin{matrix}{\sum }_{i = 0}^{{N}_{symb , all}^{PUSCH} ( {i}_{0} ) - 1} {M}_{sc}^{UCI} ( i , l ) - {Q}_{ACK}^{′} ( i ) , \\ ⌈ α {\sum }_{k = {i}_{0}}^{{K}^{′} - 1} {\sum }_{i = 0}^{{N}_{symb , all}^{PUSCH} ( k ) - 1} {M}_{sc}^{UCI} ( k , l ) ⌉ - {Q}_{ACK - tot}^{′} - {\sum }_{j = {i}_{0}}^{i - 1} {Q}_{CSI - 1}^{′} ( {i}_{0} )\end{matrix} \}$$

Equation 31 below represents the number of modulation symbols of CSI part 2 according to a UCI index.

$${Q}_{CSI - 2}^{′} ( {i}_{0} ) \leq {Y}_{CSI - 2} ( {i}_{0} ) = min \{ \begin{matrix}{\sum }_{i = 0}^{{N}_{symb , all}^{PUSCH} ( {i}_{0} ) - 1} {M}_{sc}^{UCI} ( {i}_{0} , l ) - \\ {Q}_{ACK}^{′} ( {i}_{0} ) - {Q}_{CSI - 1}^{′} ( {i}_{0} ) , \\ ⌈ α {\sum }_{k = {i}_{0}}^{{K}^{′} - 1} {\sum }_{i = 0}^{{N}_{symb , all}^{PUSCH} ( k ) - 1} {M}_{sc}^{UCI} ( k , l ) ⌉ - \\ {Q}_{ACK - tot}^{′} - {Q}_{CSI - 1 - tot}^{′}\end{matrix} \} , \qquad [ Equation 31 ]$$

$$and$$

$${Q}_{CSI - 2}^{′} ( {i}_{0} + 1 ) \leq {Y}_{CSI - 2} ( {i}_{0} + 1 ) = min \{ \begin{matrix}{\sum }_{i = 0}^{{N}_{symb , all}^{PUSCH} ( {i}_{0} + 1 ) - 1} {M}_{sc}^{UCI} ( {i}_{0} + 1 , l ) - \\ {Q}_{ACK}^{′} ( {i}_{0} + 1 ) - {Q}_{CSI - 1}^{′} ( {i}_{0} + 1 ) , \\ ⌈ α {\sum }_{k = {i}_{0}}^{{K}^{′} - 1} {\sum }_{i = 0}^{{N}_{symb , all}^{PUSCH} ( k ) - 1} {M}_{sc}^{UCI} ( k , l ) ⌉ - \\ {Q}_{ACK - tot}^{′} - {Q}_{CSI - 1 - tot}^{′} - {Q}_{CSI - 2 - tot}^{′}\end{matrix} \}$$

$${Q}_{CSI - 2}^{′} ( i ) \leq {Y}_{CSI - 2} ( i ) = min \{ \begin{matrix}{\sum }_{i = 0}^{{N}_{symb , all}^{PUSCH} ( i ) - 1} {M}_{sc}^{UCI} ( i , l ) - \\ {Q}_{ACK}^{′} ( i ) - {Q}_{CSI - 1}^{′} ( i ) , \\ ⌈ α {\sum }_{k = {i}_{0}}^{{K}^{′} - 1} {\sum }_{i = 0}^{{N}_{symb , all}^{PUSCH} ( k ) - 1} {M}_{sc}^{UCI} ( k , l ) ⌉ - \\ {Q}_{ACK - tot}^{′} - {Q}_{CSI - 1 - tot}^{′} - {\sum }_{j = {i}_{0}}^{i - 1} {Q}_{CSI - 2 - tot}^{′} ( j )\end{matrix} \}$$

In Equations 29 to 31,

$${Q}_{ACK - tot}^{′} = {Q}_{ACK}^{′} ( 1 ) + {Q}_{ACK}^{′} ( 2 ) + ⋯ + {Q}_{ACK}^{′} ( N )$$

$$and$$

$${Q}_{CSI - 1 - tot}^{′} = {Q}_{CSI - 1}^{′} ( 1 ) + {Q}_{CSI - 1}^{′} ( 2 ) + ⋯ + {Q}_{CSI - 1}^{′} ( N ) .$$

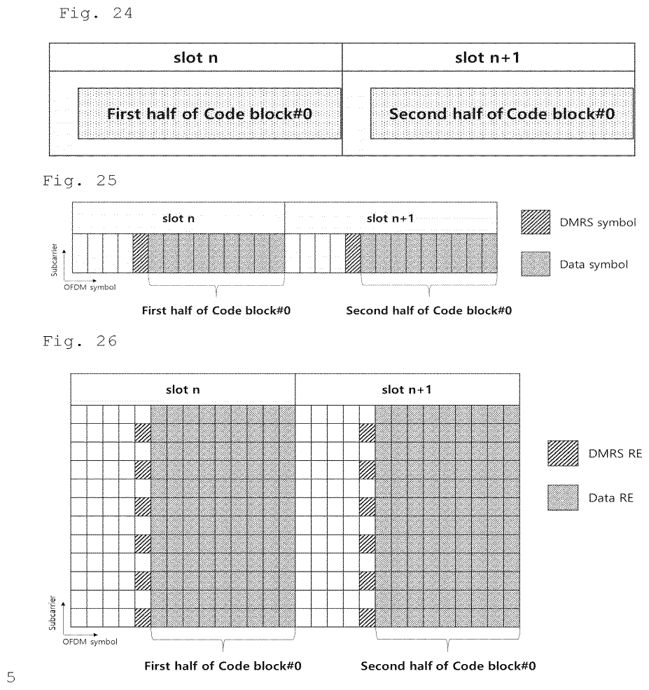

FIG. 24 illustrates an example of a method of determining transmission power of a PUSCH for which a TBS has been determined based on multiple slots or multiple nominal PUSCHs.

Referring to FIG. 24, when a TBS is greater than one slot, a UE may determine, based on a scaled TBS, transmission power of a PUSCH in each slot in which a TB is transmitted.

First, according to 7.1.1 of TS38.213, transmission power of a PUSCH may be determined as follows.

If the UE transmits a PUSCH in active UL BWP “b” of carrier “f” of serving cell “c” by using a parameter set configuration having index “j” and a PUSCH power control adjustment state having index of “1”, the UE may calculate PUSCH transmission power P_{PUSCH,b,f,c}(i),j,qd,l) in PUSCH transmission occasion “i” according to Equation 32 below.

$${P}_{PUSCH , b , f , c} ( i , j , {q}_{d} , l ) = min \{ \begin{matrix}{P}_{CMAX , \text{?}} ( i ) , \\ {P}_{O \_ PUSCH , \text{?}} ( j ) + {log}_{10} ( {2}^{\text{?}} \cdot {M}_{\text{?}}^{PUSCH} ( i ) ) + \\ {a}_{\text{?}} ( j ) \cdot \text{?} + {Δ}_{\text{?}} ( i ) + {f}_{\text{?}} ( i , l )\end{matrix} \} [ dBm ] \qquad [ Equation 32 ]$$

$$\text{?} \text{indicates text missing or illegible when filed}$$

Here, the problem to be solved in the present disclosure relates to a method of determining Δ_{TF,b,f,c(i)} Δ_{TF,b,f,c(i)} may be calculated via Equation 33 below.

$${Δ}_{TF , b , f , c} ( i ) = 10 {log}_{10} ( ( {2}^{BPRE \cdot {K}_{s}} - 1 ) \cdot {β}_{offset}^{PUSCH} ) \qquad [ Equation 33 ]$$

In Equation 33, i is a transmission occasion index of a PUSCH and may be determined according to 7 of TS38.213, as shown below.

PUSCH/PUCCH/SRS/PRACH transmission point “i” may be defined by slot index

$${n}_{s , f}^{u} ,$$

in a frame having a system frame number of SFN, first symbol “S” in a slot, and the number “L” of consecutive symbols. For PUSCH transmission having repetition type B, an PUSCH transmission occasion is nominal repetition.

That is, for repetitive PUSCH transmission type A, a transmission occasion is a slot, and for repetitive PUSCH transmission type B, a transmission occasion is nominal repetition.

For reference, in the present disclosure, a transmission occasion may be the same as a symbol set described above. That is, a symbol set of repetitive PUSCH transmission type A is a PUSCH transmitted in one slot, and a symbol set of repetitive PUSCH transmission type B is a PUSCH transmitted via one nominal repetition.

In Equation 33, Kₛ may be configured as one of 1.25 or 0. If a PUSCH includes a UL-SCH,

$${β}_{offset}^{PUSCH} = 1 ,$$

and a bit per resource element (BPRE) may be calculated according to Equation 34 below.

$$BPRE = {\sum }_{c = 0}^{C - 1} {K}_{r} / {N}_{RE} \qquad [ Equation 34 ]$$

In Equation 34, C denotes the number of code blocks transmitted via a PUSCH, and Kᵣ denotes the size (the number of bits) of code block r. N_{R}E is the number of REs occupied by the PUSCH and may be obtained via Equation 35 below.

$${N}_{RE} = {M}_{RB , h , f , c}^{PUSCH} ( i ) \cdot {\sum }_{j = 0}^{{N}_{symb , h , f , c}^{PUSCH} ( i ) - 1} {N}_{sc , data}^{RB} ( i , j ) \qquad [ Equation 35 ]$$

$${N}_{symb , b , f , c}^{PUSCH} ( i )$$

in Equation 35 is the number of symbols occupied by a PUSCH corresponding to an i-th transmission occasion of active UL BWP b of carrier f of cell c.

$${N}_{sc , data}^{RB} ( i , j )$$

denotes the number of subcarriers excluding a DMRS or a phase tracking reference signal (PTRS) in symbol j.

$${M}_{RB , b , f , c}^{PUSCH} ( i )$$

is the number of PRBs occupied by the PUSCH corresponding to the i-th transmission occasion of active UL BWP b of carrier f of cell c.

In Equation 34, a BPRE and N_{R}E are determined based on the i-th transmission occasion, but

$${\sum }_{r = 0}^{C - 1} {K}_{r}$$

is determined based on one TB. Here, a TBS may be determined based on multiple transmission occasions (or multiple symbol sets). In this case, when the same code block is transmitted in multiple transmission occasions, a problem may occur in obtaining BPRE. That is, even if a specific transmission occasion includes only a part of the code block, BPRE may be calculated based on the entire code block size

$$( {\sum }_{r = 0}^{C - 1} {K}_{r} )$$

according to the equation above.

In this case, BPRE and N_{RE} for calculation of transmission power P_{PUSCH,b,f,c}(i,j,q_{d},l) determined based on the i-th transmission occasion, but

$${\sum }_{r = 0}^{C - 1} {K}_{r}$$

is determined based on one TB. Here, a TBS may be determined based on multiple transmission occasions (or multiple symbol sets). In this case, when the same code block is transmitted in multiple transmission occasions, a problem may occur in obtaining BPRE.

That is, even if a specific transmission occasion includes only a part of the code block, BPRE may be calculated based on the entire code block size

$$( {\sum }_{r = 0}^{C - 1} {K}_{r} )$$

according to the equation above.

For example, as illustrated in FIG. 24, based on repetitive transmission type A, the UE may be indicated with PUSCH transmission for which a TBS has been determined based on one code block #0 with respect to two slots which are slot n and slot n+1. Here, a first symbol set to which PUSCH transmission is allocated in slot n is a first transmission occasion, and a second symbol set to which PUSCH transmission is allocated in slot n+1 is a second transmission occasion. In this case, a BPRE or transmission power may be determined for each transmission occasion.

However, as illustrated in FIG. 24, each of the first transmission opportunity (first symbol set) and the second transmission opportunity (second symbol set) includes only half of code block #0, but an actually calculated BPRE may be determined based on the size of the entire code block #0. That is, the entire code block size (K₀, due to transmission of only code block #0 in FIG. 24) may be applied to each transmission occasion, for example, BPRE=K₀/N_{RE} in a first transmission occasion (a first symbol set) and BPRE=K₀/N_{RE} in a second transmission occasion (a second symbol set). Since K₀ is the size of the code block for two transmission occasions, the equation above makes it difficult to determine transmission power based on an accurate size of the code block. Therefore, when one code block is transmitted via multiple transmission occasions, a method of calculating a BPRE of each transmission power is required.

### First Embodiment: Calculating a BPRE of Transmission Power by Scaling a TBS to a TBS of Each Transmission Occasion

According to the first embodiment, a BPRE of each transmission occasion may be obtained by scaling a code block size to a code block size of each transmission occasion. A UE may calculate BPRE(i) in transmission occasion i by scaling

$${\sum }_{r = 0}^{C - 1} {K}_{r} / {N}_{RE} or {\sum }_{r = 0}^{C - 1} {K}_{r} . That is , BPRE ( i ) = P ( i ) \cdot {\sum }_{r = 0}^{C - 1} {K}_{r} / {N}_{RE} ( i ) .$$

Here, N_{RE}(i) is the number of PUSCH REs excluding a PTRS and a DMRS of transmission occasion i, and P(i) is a scaling value for transmission occasion i.

That is, when a TB is transmitted via multiple slots and a TBS is thus greater than one slot (i.e., when the TBS is greater than that determined based on one slot (resource)), only a part of the TB may be transmitted in one slot. In this case, transmission power for PUSCH transmission in one slot needs to be determined for each slot, and therefore the transmission power for PUSCH transmission may be determined based on units of slots. In this case, since the TBS is greater than one slot, the value of the TBS needs to be scaled based on one slot in order to determine the transmission power of a PUSCH. Therefore, when the size of the TBS is greater than or equal to one slot, the TBS may be adjusted via scaling that increases or decreases the TBS on the assumption that one TB is transmitted in one slot, and PUSCH transmission power for each slot may be determined based on the adjusted TBS.

In this case, a scaling value P(i) for scaling may be determined via the following methods.

Firstly, P(i)=1. That is, even if a PUSCH in one slot includes only a part of a TB, it is considered as if the entire TB is transmitted in the slot. According to the first method, a code block size larger than a code block size for actual transmission in one transmission occasion is considered, so that a BPRE may be determined to have a larger value. Therefore, greater transmission power may be determined for transmission occasion i.

Secondly, P(i) may be determined based on the number of transmission occasions in which one TB is transmitted. Specifically, when the same code block occupies M transmission occasions for PUSCH transmission, P(i) may be 1/M (P(i)=1/M). That is, a code block size corresponding to transmission occasion i may be obtained

$${\sum }_{r = 0}^{C - 1} {K}_{r} / M , and therefore BPRE ( i ) = \frac{{\sum }_{r = 0}^{C - 1} {K}_{r}}{M \cdot {N}_{RE} ( i )}$$

may be satisfied.

For example, as illustrated in FIG. 24, the UE may be indicated with PUSCH transmission for which a TBS has been determined based on two slots which are slot n and slot n+1. Here, a first symbol set to which PUSCH transmission is allocated in slot n is a first transmission occasion, and a second symbol set to which PUSCH transmission is allocated in slot n+1 is a second transmission occasion. In this case, the TBS is used to generate code block #0 (or TB or codeword (CW)), and each of a first transmission occasion (first symbol set) and a second transmission occasion (second symbol set) includes only a half of code block #0. According to the second method, since P(1)=P(2)=½, a code block size of the first transmission occasion or second transmission occasion may be obtained as K0/2, and therefore

$$BPRE ( 1 ) = \frac{{K}_{0}}{2 \cdot {N}_{RE} ( 1 )} , BPRE ( 2 ) = \frac{{K}_{0}}{2 \cdot {N}_{RE} ( 2 )}$$

may be satisfied.

FIG. 25 illustrates an example of a PUSCH transmission power determination method according to an embodiment of the present disclosure.

Referring to FIG. 25, thirdly, unlike the aforementioned first method and second method, P(i) may be determined based on the number of symbols of a PUSCH.

Specifically,

$$P ( i ) = \frac{{N}_{symb , b , f , c}^{PUSCH , CB \# r} ( i )}{{N}_{symb}^{PUSCH , CB \# r}}$$

may be satisfied in transmission occasion i. Here,

$${N}_{symb , b , f , c}^{PUSCH , CB \# r} ( i )$$

denotes the number of PUSCH symbols enabling transmission of an r-th code block in the i-th transmission occasion of active UL BWP b of carrier f of cell c, and

$${N}_{symb}^{PUSCH , CB \# r}$$

denotes the total number of PUSCH symbols enabling transmission of the r-th code block. Therefore,

$$BPRE ( i ) = {\sum }_{r = 0}^{C - 1} ( {K}_{r} * \frac{{N}_{symb , b , f , c}^{PUSCH , CB \# r} ( i )}{{N}_{symb}^{PUSCH , CB \# r}} ) / {N}_{RE} ( i )$$

may be satisfied.

For example, as illustrated in FIG. 25, the UE may be indicated with PUSCH transmission for which a TBS has been determined based on two slots which are slot n and slot n+1. Here, a first symbol set to which PUSCH transmission is allocated in slot n is a first transmission occasion, and a second symbol set to which PUSCH transmission is allocated in slot n+1 is a second transmission occasion. In this case, the TBS is used to generate code block #0 (or TB or codeword (CW)), and each of a first transmission occasion (first symbol set) and a second transmission occasion (second symbol set) includes only a half of code block #0.

In this case, according to the third method,

$$P ( 1 ) = P ( 2 ) = \frac{9}{18} = \frac{1}{2} ,$$

so that the code block size of the first transmission occasion or second transmission occasion may be obtained as K0/2, and therefore

$$BPRE ( 1 ) = \frac{{K}_{0}}{2 \cdot {N}_{RE} ( 1 )} , BPRE ( 2 ) = \frac{{K}_{0}}{2 \cdot {N}_{RE} ( 2 )}$$

may be satisfied.

FIG. 26 illustrates another example of a PUSCH transmission power determination method according to an embodiment of the present disclosure.

Referring to FIG. 26, fourthly, unlike the aforementioned first to third methods, P(i) may be determined based on the number of PUSCH REs of a transmission occasion in which one TB is transmitted.

Specifically,

$$P ( i ) = \frac{{N}_{RE}^{CB \# r} ( i )}{{N}_{RE}^{CB \# r}}$$

in transmission occasion i. Here,

$${N}_{RE}^{CB \# r} ( i )$$

denotes the number of PUSCH REs enabling transmission of an r-th code block in transmission occasion i, and

$${N}_{RE}^{CB \# r}$$

denotes the total number of PUSCH REs enabling transmission of the r-th code block. Therefore,

$$BPRE ( i ) = {\sum }_{r = 0}^{C - 1} ( {K}_{r} \cdot \frac{{N}_{RE}^{CB \# r} ( i )}{{N}_{RE}^{CB \# r}} ) / {N}_{RE} ( i )$$

may be satisfied. For example, referring to FIG. 26, a UE may be indicated with PUSCH transmission for which a TBS has been determined based on one code block #0 with respect to two slots which are slot n and slot n+1.

Here, a first symbol set to which PUSCH transmission is allocated in slot n is a first transmission occasion, and a second symbol set to which PUSCH transmission is allocated in slot n+1 is a second transmission occasion. In this case, each of a first transmission occasion (first symbol set) and a second transmission occasion (second symbol set) includes only a half of code block #0.

According to the fourth method,

$$P ( 1 ) = P ( 2 ) = \frac{108}{216} = \frac{1}{2} ,$$

so that a code block size of the first transmission occasion or second transmission occasion may be obtained as K₀/2, and therefore

$$BPRE ( 1 ) = \frac{{K}_{0}}{2 \cdot {N}_{RE} ( 1 )} , BPRE ( 2 ) = \frac{{K}_{0}}{2 \cdot {N}_{RE} ( 2 )}$$

may be satisfied.

Fifthly, the scaling value may be a value configured or indicated by a base station.

### Second Embodiment: Calculating a BPRE of Transmission Power Based on a Code Block Included in a Transmission Occasion

According to the second embodiment, a BPRE of transmission occasion i may be determined based on a code block included in a transmission occasion. That is, when an index of a code block included in transmission occasion i is {rⱼ} and the number of code blocks is Cᵢ,

$$BPRE ( i ) = {\sum }_{j = 0}^{{C}_{i} - 1} {K}_{{r}_{j}} / {N}_{RE} ( i )$$

is satisfied. Here, N_{RE} (i) denotes the number of PUSCH REs excluding a PTRS and a DMRS in transmission occasion i. A code block included in transmission occasion i and the number of code blocks may be determined based on the following methods.

As a first method, when at least a part of a code block is included in transmission occasion i, it is determined that the code block is included in the transmission occasion.

As a second method, only when one entire code block is included in transmission occasion i, it is determined that the code block is included in the transmission occasion.

According to a (2-1)st embodiment, a BPRE of transmission occasion i may be determined based on the number of PUSCH symbols and a code block included in the transmission occasion. That is, when an index of a code block included in transmission occasion i is {rⱼ} and the number of code blocks is Cᵢ,

$$BPRE ( i ) = {\sum }_{j = 0}^{{C}_{i} - 1} {K}_{{r}_{j}} * \frac{{N}_{symb , b , f , c}^{PUSCH , CB} ( i )}{{N}_{symb}^{PUSCH , CB}} / {N}_{RE} ( i )$$

may be satisfied.

Here,

$${N}_{symb , b , f , c}^{PUSCH , CB} ( i )$$

denotes the number of PUSCH symbols enabling transmission of a code block in an i-th transmission occasion of active UL BWP b of carrier f of cell c, and

$${N}_{symb}^{PUSCH , CB}$$

denotes the total number of PUSCH symbols enabling transmission of the code block.

According to a (2-2)nd embodiment, a BPRE of transmission occasion i may be determined based on the number of PUSCH REs and a code block included in the transmission occasion. That is, when an index of a code block included in transmission occasion i is {rⱼ} and the number of code blocks is Cᵢ,

$$BPRE ( i ) = {\sum }_{j = 0}^{{C}_{i} - 1} {K}_{{r}_{j}} * \frac{{N}_{RE}^{CB} ( i )}{{N}_{RE}^{CB}} / {N}_{RE} ( i )$$

may be calculated. Here,

$${N}_{RE}^{CB} ( i )$$

denotes the number of PUSCH REs enabling transmission of the code block in transmission occasion i, and

$${N}_{RE}^{CB}$$

denotes the total number of PUSCH REs enabling transmission of the code block.

In the first embodiment and the second embodiment, a transmission occasion may be determined based on time domain resource assignment (TDRA) information associated with PUSCH scheduling. For example, when repetitive PUSCH transmission type A is indicated, a transmission occasion is slots indicated for PUSCH transmission, and when repetitive PUSCH transmission type B is indicated, a transmission occasion may be determined based on nominal repetitions or a slot indicated for PUSCH transmission.

Alternatively, a transmission occasion may be determined independently of TDRA information associated with PUSCH scheduling. For example, although repetitive PUSCH transmission type B is indicated, a transmission occasion may be determined based on slots indicated for PUSCH transmission.

In the first embodiment and the second embodiment, one transmission occasion may be determined based on multiple slots or nominal repetitions.

### <Method of Determining a Redundancy Version for Repetitive PUSCH Transmission of a TB>

The UE may transmit a PUSCH by using one of methods configured for the UE by the base station, such as a scheduling method using a dynamic grant (DG), which is a method of scheduling PUSCH transmission in control information (DCI) transferred via reception of a PDCCH, or a scheduling method using a configured grant (CG), which is a method of transmitting a PUSCH according to a resource and a transmission method configured in advance by the base station.

That is, the UE may transmit a PUSCH by determining a TBS by using multiple symbol sets (or slots) which are resources scheduled via a dynamic grant or resources configured via a configured grant. In other words, for a PUSCH configured in a DG or CG-based transmission scheme by the base station, the UE may determine a TBS based on multiple symbol sets.

When determining multiple symbol sets for uplink transmission in the DG or CG-based transmission scheme, the UE may perform the determination based on a time domain resource available for uplink transmission. Here, the time domain resource available for uplink transmission may be a time domain resource including a flexible symbol or an uplink symbol configured according to a cell-specific UL/DL configuration and a UE-specific UL/DL configuration which are configured for the UE by the base station. For example, when multiple symbol sets for a PUSCH transmission resource are determined using repetitive PUSCH transmission type A, a symbol set may be a slot in consideration that repetitive PUSCH transmission type A is repetitive transmission in units of slots, and the UE may determine a time domain resource for PUSCH transmission based on a slot available for uplink transmission in repetitive PUSCH transmission type A.

The UE may receive, from the base station, an indication to enable repetitive transmission of a PUSCH, for which a TBS has been determined based on multiple symbol sets (or slots) for uplink coverage extension, in multiple time domain resources. Here, the “PUSCH for which a TBS has been determined based on multiple symbol sets” indicates that, when a TB is transmitted via the PUSCH, a size of the TB is determined based on multiple symbol sets (e.g., slots), for example, the amount of time-frequency (e.g., RE) allocated in multiple symbol sets (e.g., slots).

Hereinafter, for convenience of description, it is assumed that the number of multiple symbol sets (the number of slots or nominal repetitions) corresponding to one PUSCH transmission among one PUSCH transmission, for which a TBS has been determined based on multiple symbol sets, and one or more repetitive PUSCH transmissions is N, and that the number of repetitive PUSCH transmissions, for which a TBS has been determined based on N symbol sets, is M. That is, one TB is generated over N symbol sets (or slots), and the TB may be repetitively transmitted up to M times via a PUSCH. Here, N is an integer of 2 or larger. In addition, K is an integer of 1 or larger, preferably an integer of 2 or larger. For convenience of description, when a TBS is determined based on multiple symbol sets (or slots), a TB generated based on the TBS may be referred to as a TB over multiple symbol sets or TB over multiple slots (TBoMS). In addition, a PUSCH used for TBoMS transmission may be referred to as a TBoMS PUSCH.

When a PUSCH is scheduled in a DG or type 2 CG-based transmission scheme for the UE, the UE may receive DCI format 0_1 or 0_2 via a PDCCH for scheduling of the PUSCH, and may perform repetitive transmission of the PUSCH, for which a TBS has been determined based on multiple symbol sets, in M multiple time domain resources. Here, the multiple time domain resources may correspond to the number of the multiple symbol sets. For example, for repetitive PUSCH transmission type A, multiple symbol sets may be multiple slots, and therefore multiple time domain resources may be the number of the multiple slots. For the UE, an M value may be configured from a higher layer (e.g., RRC) or may be received via a TDRA field of DCI, and the UE may perform repetitive PUSCH transmission based on a TBS determined based on M slots (or symbol sets).

When a PUSCH is scheduled in a type 1 CG-based transmission scheme for the UE, the UE may perform repetitive PUSCH transmission based on a TBS determined based on symbol sets in M multiple time domain resources according to a preconfigured resource and transmission method. Here, the multiple time domain resources may correspond to the number of the multiple symbol sets. The UE may be configured with an M value from a higher layer, and may perform repetitive PUSCH transmission based on a TBS determined based on M multiple slots (or symbol sets).

When CG-based PUSCH transmission performed in a single slot is repeated in the NR system, the UE and the base station may define a time point which may be assumed to be a start of CG-based PUSCH transmission, as follows. The UE may be configured with one of RV sequences {0, 2, 3, 11, {0, 3, 0, 31, and {0, 0, 0, 01 applied to repetitive CG-based PUSCH transmission, and the UE may use an RV value corresponding to a {mod(n−1, 4)+1}th value in an n-th initial transmission occasion (TO). Here, n indicates a TO index and is an integer larger than 0. In this case, the UE may determine, as follows, an initial TO from which repetitive transmission may start according to the configured RV sequence.

When the RV sequence is configured to be {0, 2, 3, 1}, the UE may start repetitive transmission from a first TO corresponding to RV=0 as an initial TO, and the base station attempts to receive repetitive CG-based PUSCH transmission by assuming that repetitive transmission of the UE may start.

When the RV sequence is configured to be {0, 3, 0, 3}, the UE may start repetitive transmission from a TO corresponding to RV=0 as an initial TO, and the base station attempts to receive repetitive CG-based PUSCH transmission by assuming that repetitive transmission of the UE may start.

When the RV sequence is configured to be {0, 0, 0, 0}, the UE may determine, as an initial TO, all TOs corresponding to RV=0 excluding the last TO so as to start repetitive transmission, and the base station attempts to receive repetitive CG-based PUSCH transmission by assuming that repetitive transmission of the UE may start.

When the UE determines an initial TO according to the RV sequence {0, 2, 3, 1}, {0, 3, 0, 3}, or {0, 0, 0, 0}configured via RRC, separate RRC parameter startingFromRV0 for determination of the initial TO may not be configured. In addition, separate RRC parameter startingFromRV0 for determination of an initial TO may be additionally configured for the UE by the base station. Here, RRC parameter startingFromRV0 indicates a parameter used to determine an initial TO of a TB with respect to a given RV sequence.

When startingFromRV0 is configured via RRC, the UE may determine, as follows, an initial TO from which repetitive CG-based PUSCH transmission may start according to a value (e.g., on or off) of the configured startingFromRV0, and the base station may attempt to receive repetitive CG-based PUSCH transmission by assuming that repetitive CG-based PUSCH transmission of the UE may start from the corresponding TO.

1) When startingFromRV0=“off” is configured, the UE may always start repetitive CG-based PUSCH transmission only from a first TO, and the base station may attempt to receive repetitive CG-based PUSCH transmission by assuming that repetitive CG-based PUSCH transmission of the UE may start from the corresponding TO.

2) When startingFromRV0=“on” is configured, the UE may determine, as follows, an initial TO from which repetitive CG-based PUSCH transmission may start according to the configured RV sequence.

When the RV sequence configured via RRC is configured to be {0, 2, 3, 1}, the UE may start repetitive CG-based PUSCH transmission from a first TO as an initial TO, and the base station may attempt to receive repetitive CG-based PUSCH transmission by assuming that repetitive CG-based PUSCH transmission of the UE may start from the corresponding TO.

When the RV sequence configured via RRC is configured to be {0, 3, 0, 3}, the UE may start repetitive CG-based PUSCH transmission from a TO corresponding to RV=0 as an initial TO, and the base station attempts to receive repetitive CG-based PUSCH transmission by assuming that repetitive CG-based PUSCH transmission of the UE may start from the corresponding TO.

When the RV sequence configured via RRC is configured to be {0, 0, 0, 0}, the UE may determine an initial TO from TOs excluding the last TO so as to start repetitive CG-based PUSCH transmission, and the base station attempts to receive repetitive CG-based PUSCH transmission by assuming that repetitive CG-based PUSCH transmission of the UE may start from the corresponding TO.

Regarding a problem to be solved by the present disclosure, when a case of repetitive CG-based PUSCH transmission performed in a single slot is applied, as it is, to a case of repetitive TBoMS PUSCH transmission according to a CG-based transmission scheme, if a slot configured with RV=0 as an initial TO fails to be determined as an available slot (i.e., if the slot is determined to be invalid for repetitive PUSCH transmission) or if repetitive TBoMS PUSCH transmission is scheduled or configured from a slot other than a slot with RV=0, a problem that repetitive transmission cannot be performed for the entire TBoMS PUSCH occurs.

Therefore, the present disclosure is to solve a task of determining an initial transmission occasion (TO) from which repetitive transmission may be started when a UE performs repetitive TBoMS PUSCH transmission according to the CG-based transmission scheme.

First, description is provided for a method of determining M TOs available for repetitive transmission when M times of repetitive transmission is indicated for a PUSCH, for which a TBS has been determined based on N symbol sets (or slots), according to the CG-based transmission scheme.

A UE may be configured with a period and an offset, in which repetitive PUSCH transmission is to be performed, by a base station. The UE may determine a first slot of a first TO in which a PUSCH is to be repeatedly transmitted according to the period and the offset. Here, the period and the offset may be given in ms or in a unit of one or more slots. Subsequent procedures may be determined according to the methods described below.

In the drawings below, slot D may be a slot including a downlink symbol, slot U may be a slot including an uplink symbol, and slot S may be a slot including a flexible symbol. For example, slot S may be (a) a slot including a flexible symbol, (b) a slot including a downlink symbol and a flexible symbol, (c) a slot including a downlink symbol, a flexible symbol, and an uplink symbol, or (d) a slot including a flexible symbol and an uplink symbol. In the drawing, a slot configuration within a frame may be configured according to a cell-specifically configured UL/DL configuration and/or a UE-specifically configured UL/DL configuration.

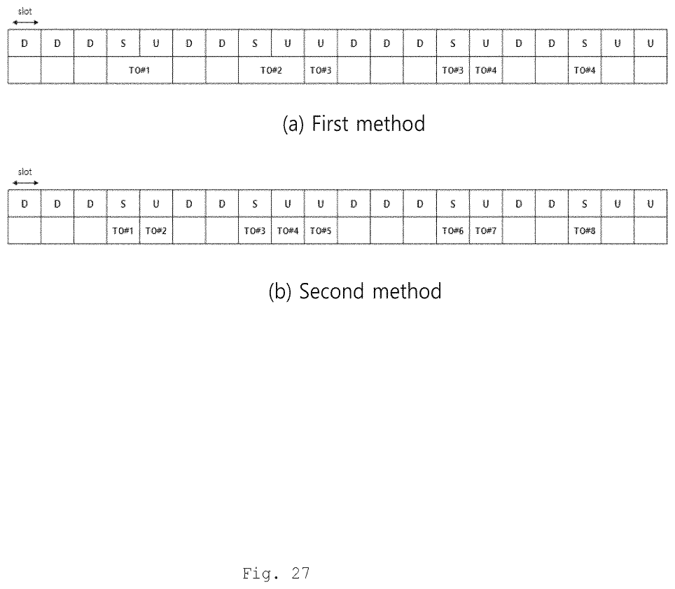

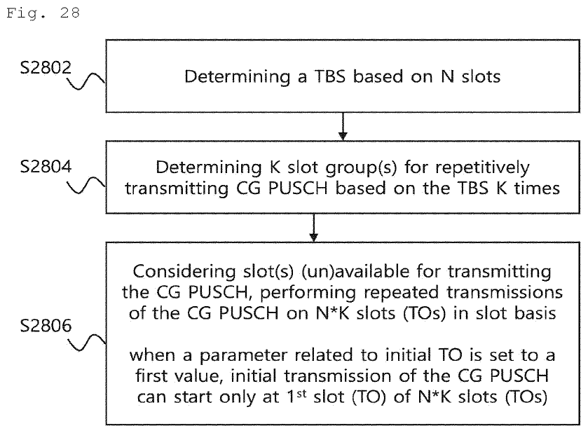

FIG. 27 illustrates a method of determining a transmission occasion of a PUSCH for which a TBS has been determined based on multiple slots or multiple nominal PUSCHs according to an embodiment of the present disclosure.

Referring to FIG. 27, firstly (first method), a TO may be determined based on N slots (or slot sets) in which PUSCH transmission is possible. That is, when determining a TBS based on multiple (e.g., N) symbol sets, a UE may determine a TO also based on a unit of multiple (e.g., N) symbol sets. Therefore, a total of M TOs may be determined. Here, N is an integer of 2 or larger. K is an integer of 1 or larger, preferably an integer of 2 or larger.

Specifically, referring to FIG. 27A, repetitive PUSCH transmission type A of the CG-based transmission scheme, N=2, and M=4 are configured for the UE. The UE may assume that PUSCH transmission is possible in slot S and slot U. According to a first method, the UE may sequentially determine TOs for N slots (N=2) from a first S slot in which PUSCH transmission is possible. Here, N slots (N=2) determined as TOs may be contiguous or discontinuous in the time domain. According to the first method, since repetitive transmission of one PUSCH is determined as one TO, there is no ambiguity between a UE and a base station with respect to whether a PUSCH transmitted in multiple slots corresponds to repetitive transmission of one PUSCH or repetitive transmission of different PUSCHs.

Secondly (second method), a TO may be determined based on a slot in which PUSCH transmission is possible. Even if the UE determines a TBS based on multiple (e.g., N) symbol sets, a TO may be determined in units of slots. Therefore, a total of N*M TOs may be determined. Here, N is an integer of 2 or larger. K is an integer of 1 or larger, preferably an integer of 2 or larger. For example, as illustrated in FIG. 27B, repetitive PUSCH transmission type A of the CG-based transmission scheme, N=2, and M=4 may be configured for the UE. The UE may sequentially determine a TO for each slot from a first S slot in which PUSCH transmission is possible. According to the second method, since one slot is determined as one TO, there is an advantage in maintaining backward compatibility by maintaining, as it is, an NR attribute of determining a TO in units of slots. In addition, unlike the first method, since PUSCH transmission may be performed in units of slots, even if some of N slots corresponding to repetitive transmission of one PUSCH are invalid, repetitive PUSCH transmission may be (partially) performed in other valid slots, so that the second method may be advantageous for improving coverage.

Subsequently, a description will be provided for a method of determining an initial TO from which repetitive PUSCH transmission may be started in the CG-based transmission scheme. This may be determined as follows according to the method of determining M TOs in which repetitive PUSCH transmission is possible.

When a TO is determined according to the first method (FIG. 27A), the UE may be configured with one of RV sequences {0, 2, 3, 1}, {0, 3, 0, 3}, and {0, 0, 0, 0}applied to repetitive CG-based PUSCH transmission, and may use an RV value corresponding to a {mod(n−1, 4)+1}th value in an n-th TO. Here, n indicates a TO index and is an integer larger than 0. In this case, the UE may determine, as follows, an initial TO from which repetitive transmission may start according to the configured RV sequence.
When the RV sequence is configured to be {0, 2, 3, 1}, a first TO among M TOs may be determined as an initial TO. This TO may be a TO corresponding to RV=0.
When the RV sequence is configured to be {0, 3, 0, 3}, a TO corresponding to RV=0 among M TOs may be determined as an initial TO.
When the RV sequence is configured to be {0, 0, 0, 0}, all TOs among M TOs may be determined as an initial TO. However, when (the number N of multiple symbol sets)*(the number M of configured repetitive transmissions) is greater than or equal to 8, repetitive transmission may not start in the last symbol set of the last TO.

When a TO is determined according to the second method (FIG. 27B), the UE may be configured with one of RV sequences {0, 2, 3, 1}, {0, 3, 0, 3}, and {0, 0, 0, 0}applied to CG-based PUSCH (simply, CG PUSCH) repetitive transmission, and may use an RV value corresponding to a {mod(ceil(n/N)-1, 4)+1}th value in an nth TO. Here, n indicates a TO index and is an integer larger than 0, and ceil(x) indicates a smallest integer among integers larger than or equal to x. Therefore, values in the RV sequence may be mapped in a circular manner to each N TOs starting from a first TO among a total of N*M TOs for repetitive CG PUSCH transmission. For example, when the RV sequence {0, 2, 3, 1} is given for TB transmission, N=2, and M=6, RVs corresponding to 12 TOs for CG PUSCH transmission are as follows: {0, 0, 2, 2, 3, 3, 1, 1, 0, 0, 2, 2}.

In this case, the UE may determine, as follows, an initial TO from which repetitive transmission may start according to the configured RV sequence.
When the RV sequence is configured to be {0, 2, 3, 1}, first N TOs among N*M TOs may be determined as an initial TO. Here, the first N TOs may be TOs corresponding to RV=0.
When the RV sequence is configured to be {0, 3, 0, 3}, a TO corresponding to RV=0 among N*M TOs may be determined as an initial TO.
When the RV sequence is configured to be {0, 0, 0, 0}, all TOs among N*M TOs may be determined as an initial TO. However, when (the number N of multiple symbol sets)*(the number M of configured repetitive transmissions) is greater than or equal to 8, repetitive transmission may not start in the last TO.

In the first method or the second method, when the UE determines an initial TO according to the RV sequence {0, 2, 3, 1}, {0, 3, 0, 3}, or {0, 0, 0, 0}configured via RRC, the UE may be not be configured with separate RRC parameter startingFromRV0 for determination of the initial TO or may be configured with RRC parameter startingFromRV0. Here, RRC parameter startingFromRV0 is used to determine an initial TO of a TB with respect to a given RV sequence. For example, RRC parameter startingFromRV0 may indicate whether initial transmission of the TB can start from a TO corresponding to RV0 among TOs for repetitive transmission. Accordingly, the initial TO of the TB may be determined based on RRC parameter startingFromRV0 for determination of the initial TO. A value of RRC parameter startingFromRV0 for determination of the initial TO may be configured to be “off” or “on”. The UE may determine the initial TO, from which CG-based PUSCH (simply, CG PUSCH) repetitive transmission may start according to the configured startingFromRV0 value, as follows. Accordingly, the base station may attempt to receive repetitive CG PUSCH transmission by assuming that repetitive CG PUSCH transmission of the UE may start from a corresponding TO.

Based on the TO determined according to the first method and the second method, an initial TO for repetitive CG PUSCH (i.e., TBoMS) transmission may be determined as follows.

1) When startingFromRV0=“off” is configured, the UE may always start repetitive CG PUSCH transmission only from a first TO, and the base station may attempt to receive repetitive CG PUSCH transmission by assuming that repetitive CG PUSCH transmission of the UE may start from the corresponding TO. For example, in case of FIG. 27A, the UE may start initial transmission of the CG PUSCH (i.e., TBoMS) only from the first TO among M TOs for repetitive transmission. Here, the first TO may be determined to be valid if even one slot among slots in the first TO is valid. Accordingly, even if a first slot of the first TO is invalid, if a second or subsequent slot of the first TO are valid, the UE may start initial transmission of the CG PUSCH (i.e., TBoMS) in the second or subsequent slot of the first TO. However, in this case, information bits (systematic bits) among coded bits of a TB (i.e., TBoMS) are not included in CG PUSCH transmission, or only some of the information bits are included in CG PUSCH transmission, so that performance degradation may occur. In case of FIG. 27B, the UE may start initial transmission of the CG PUSCH (i.e., TBoMS) only from the first TO among N*M TOs for repetitive transmission. Accordingly, when the first TO among N*M TOs are invalid, even if there is a valid TO in the remaining N−1 TOs among the first N TOs corresponding to first CG PUSCH repetition, the UE may not start initial transmission of the CG PUSCH (i.e., TBoMS). This is because, when starting of initial transmission of the CG PUSCH (i.e., TBoMS) is allowed in the remaining N−1 TOs among the first N TOs, information bits (systematic bits) among coded bits of a TB (i.e., TBoMS) are not included in the CG PUSCH transmission, or only some of the information bits are included in the CG PUSCH transmission, so that performance degradation may occur.

2) When startingFromRV0=“on” is configured, the UE may determine, as follows, an initial TO from which repetitive CG PUSCH (i.e., TBoMS) transmission may start according to the configured RV sequence (for repetitive transmission).
When the RV sequence configured via RRC is configured to be {0, 2, 3, 1}, the UE may start repetitive CG PUSCH transmission from a first TO as an initial TO, and the base station may attempt to receive repetitive CG PUSCH transmission by assuming that repetitive CG PUSCH transmission of the UE may start from the corresponding TO. For example, in case of FIG. 27A, the UE may start initial transmission of the CG PUSCH (i.e., TBoMS) only from the first TO among M TOs for repetitive transmission. In case of FIG. 27B, the UE may start initial transmission of the CG PUSCH (i.e., TBoMS) only from the first TO among N*M TOs for repetitive transmission.
When the RV sequence configured via RRC is configured to be {0, 3, 0, 3}, the UE may start repetitive CG PUSCH transmission from a TO corresponding to RV=0 as an initial TO, and the base station attempts to receive repetitive CG PUSCH transmission by assuming that repetitive CG PUSCH transmission of the UE may start from the corresponding TO. For example, in case of FIG. 27A, the UE may start initial transmission of the CG PUSCH (i.e., TBoMS) only from TO(s) corresponding to RV=0 among M TOs for repetitive transmission. In case of FIG. 27B, the UE may start initial transmission of the CG PUSCH (i.e., TBoMS) within the TO(s) corresponding to RV=0 among N*M TOs for repetitive transmission. Accordingly, the UE may start initial transmission of the CG PUSCH from a middle TO even if the TO is not the first TO among the N*M TOs for repetitive transmission.
When the RV sequence configured via RRC is configured to be {0, 0, 0, 0}, the UE may determine an initial TO from any TOs excluding the last TO so as to start repetitive CG PUSCH transmission, and the base station may attempt to receive repetitive CG PUSCH transmission by assuming that the UE determines the initial TO from any TO and repetitive CG PUSCH transmission of the UE may start from the corresponding TO. For example, in case of FIG. 27A, the UE may start initial transmission of the CG PUSCH (i.e., TBoMS) only from TO(s) corresponding to RV=0 among M TOs for repetitive transmission. In case of FIG. 27B, the UE may start initial transmission of the CG PUSCH (i.e., TBoMS) within the TO(s) corresponding to RV=0 among N*M TOs for repetitive transmission. Accordingly, the UE may start initial transmission of the CG PUSCH from a middle TO even if the TO is not the first TO among the N*M TOs for repetitive transmission.

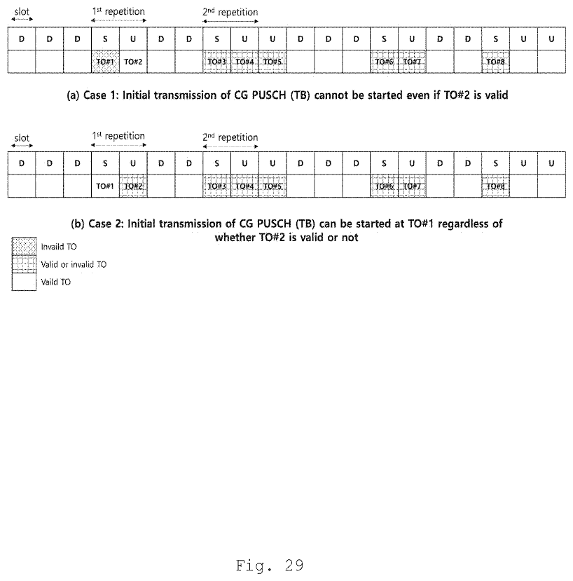

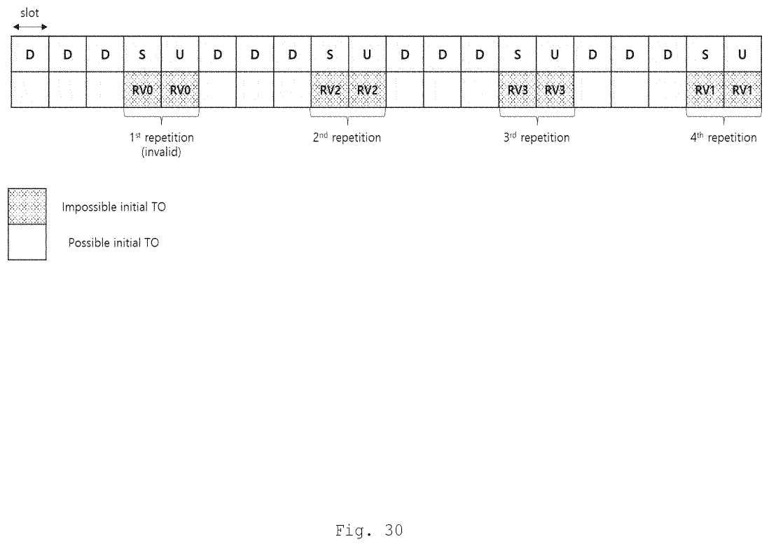

FIG. 28 and FIG. 29 illustrate an uplink transmission procedure according to an embodiment of the present disclosure.

Referring to FIG. 28, a UE may determine a TBS based on N (>1) slots (S2802). In addition, the UE may determine K slot groups for repetitively transmitting a CG PUSCH based on the TBS K times (S2804). K is an integer of 1 or larger, preferably an integer of 2 or larger. Here, each slot group may include N slots corresponding to each repetitive CG PUSCH transmission. Then, the UE may perform repetitive transmission of the CG PUSCH in units of slots in N*K slots in consideration of a slot in which transmission of the CG PUSCH is possible (and/or a slot in which transmission of the CG PUSCH is not possible) (S2806). Here, a slot in which transmission of the CG PUSCH is possible (and/or a slot in which transmission of the CG PUSCH is not possible) may be determined based on slot format information (e.g., slot format indicator (SFI)) in a group-common PDCCH, downlink scheduling information in a PDCCH, and/or the like. For example, a slot in which CG PUSCH transmission is not possible may include a downlink symbol, etc. configured based on slot format information in a group-common PDCCH, downlink scheduling information in a PDCCH, and/or the like. A slot in which CG PUSCH transmission is not possible may be referred to as an invalid TO.

When an RRC parameter (e.g., startingFromRV0) for initial TO determination is configured to be a first value (e.g., off) (in relation to repetitive transmission of the CG PUSCH), initial transmission of the CG PUSCH may start only from the first slot among N*K slots for the CG PUSCH. For example, referring to FIG. 29, when CG PUSCH transmission is not possible in the first slot (e.g., TO #1) among N*K slots, the UE may not start initial transmission of the CG PUSCH (even if there is a valid TO (e.g., TO #2) in first repetitive transmission). When CG PUSCH transmission is possible in the first slot (e.g., TO #1) among N*K slots, the UE may start initial transmission of the CG PUSCH in TO #1 (regardless of whether the remaining TO (e.g., TO #2) in first repetitive transmission is valid).

In addition, the UE may further receive configuration information on an RV sequence. In this case, based on index n corresponding to the N*K slots, RV values in the RV sequence are cyclically mapped one by one in a unit of N slots within the N*K slots, and the RV sequence may include one or more RV0s. Based on that (1) the RRC parameter for initial TO determination is configured to be a second value (e.g., on), and (2) the RV sequence is {RV0, RV3, RV0, RV3}, starting of initial transmission of the CG PUSCH may be allowed in slots associated with RV0 among the N*K slots. In addition, based on that (1) the RRC parameter (e.g., startingFromRV0) for initial TO determination is configured to be the second value (e.g., on), and (2) the RV sequence is {RV0, RV0, RV0, RV0}, starting of initial transmission of the CG PUSCH may be allowed in slots associated with RV0 among the N*K slots. In addition, based on that (1) the RRC parameter (e.g., startingFromRV0) for initial TO determination is configured to be the second value (e.g., on), and (2) the RV sequence is {RV0, RV2, RV3, RV1}, starting of initial transmission of the CG PUSCH may be allowed only in the first slot among the N*K slots.

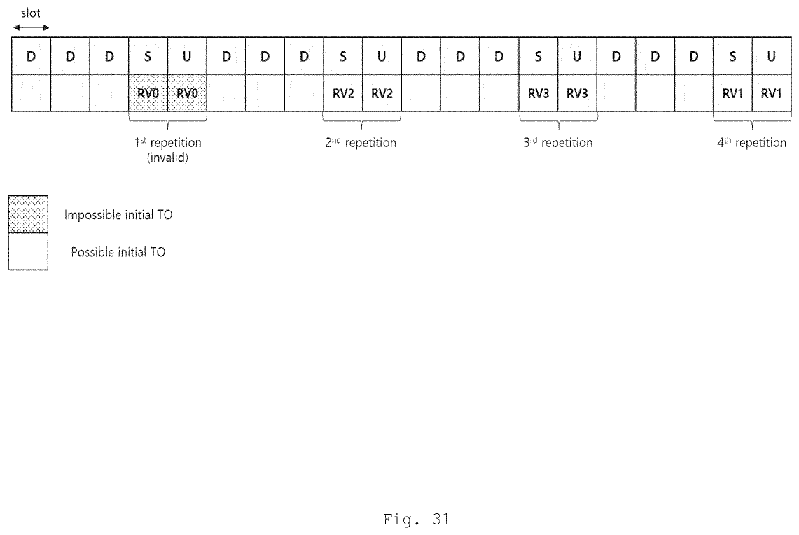

FIG. 30 illustrates an example of a method of determining an initial transmission occasion of a PUSCH for which a TBS has been determined based on multiple slots or multiple nominal PUSCHs.

Referring to FIG. 30, when a TB is transmitted via multiple slots, and a PUSCH for transmitting the TB is repetitively transmitted, a UE may transmit a first TB in a slot assigned with “0” in an RV sequence configured by a base station.

Specifically, the UE may be configured or indicated to repetitively transmit, in multiple time domain resources, a PUSCH for which a TBS has been determined based on multiple symbol sets according to the CG-based transmission scheme. For example, when scheduled with repetitive PUSCH transmission type A, a PUSCH for which a TBS has been determined based on N slots may be repetitively transmitted M times. In this case, the UE may determine an RV value for M repetitive transmissions according to the configured RV sequence.

For example, as illustrated in FIG. 30, repetitive PUSCH transmission type A of the CG-based transmission scheme, N=2, and M=4 may be configured for the UE, and RV sequence {0, 2, 3, 1} may be configured from the base station. In this case, PUSCH transmission may not be possible in TOs of two slots corresponding to first repetitive transmission. That is, first two TOs corresponding to RV=0 may not be valid. Although PUSCH transmission is possible in TOs corresponding to subsequent second, third, and fourth repetitive transmissions, the TOs do not satisfy RV=0 that is a condition for an initial TO, so that the UR cannot start repetitive transmission. In this case, since PUSCH transmission is possible again after 6 slots in which PUSCH transmission is possible, a problem of increased latency occurs.

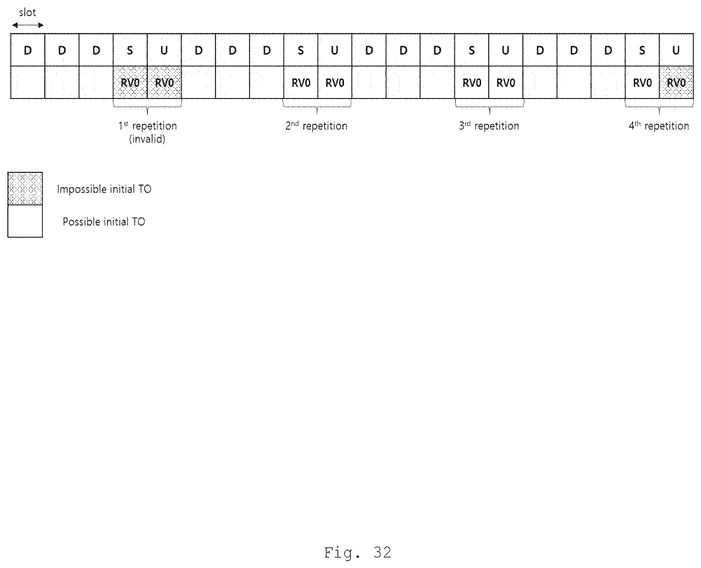

FIG. 31 illustrates another example of a method of determining an initial transmission occasion of a PUSCH for which a TBS has been determined based on multiple slots or multiple nominal PUSCHs according to an embodiment (hereinafter, first embodiment) of the present disclosure.

Referring to FIG. 31, when a TB is transmitted via multiple slots, and a PUSCH for transmitting the TB is repetitively transmitted, the UE may start repetitive PUSCH transmission for the TB in a corresponding TO even if the TO does not correspond to an RV value of “0”.

Specifically, multiple symbol sets may be configured for the UE via a configured grant scheme. The UE may determine a TBS based on allocated or configured multiple symbol sets and may repetitively transmit the PUSCH in multiple time domain resource, based on the determined TBS. In this case, the UE may perform repetitive PUSCH transmission based on an RV value configured for each slot according to an RV sequence configured by a base station.

In this case, when a slot for which an RV value of “0” has been configured for starting repetitive PUSCH transmission is invalid, the UE may start repetitive PUSCH transmission in a slot for which an RV value other than “0” is configured. That is, the UE may start repetitive PUSCH transmission even in a slot for which an RV value is not configured to be “0”.

That is, when the UE is configured or indicated to repetitively transmit, in multiple time domain resources, the PUSCH for which the TBS has been determined based on multiple symbol sets, the UE may be configured to start repetitive PUSCH transmission regardless of an RV value. In other words, the UE may start repetitive PUSCH transmission in a TO having a value other than RV=0. The other value may include values of RV=1, RV=2, and RV=3.

For example, as illustrated in FIG. 31, repetitive PUSCH transmission type A of the CG-based transmission scheme, N=2, and M=4 are configured for the UE. In addition, RV sequence {0, 2, 3, 1} is configured from the base station. When TOs of two slots corresponding to first repetitive transmission are not available for PUSCH transmission, the UE may be configured to start repetitive transmission even if a TO corresponding to the remaining repetitive transmission has a value other than RV=0. That is, the UE may be configured to start repetitive PUSCH transmission in TOs of two slots, which have a value of RV=2 and correspond to second repetitive transmission, TOs of two slots, which have a value of RV=3 and correspond to third repetitive transmission, or TOs of two slots, which have a value of RV=1 and correspond to fourth repetitive transmission. That is, when CG-based PUSCH transmission, which is transmission in a single-slot, is repetitively performed in the NR system, the UE and the base station may configure so that, unlike a time point, at which the UE may be assumed to start CG-based PUSCH transmission, being configured to RV=0, when the UE is configured or indicated to repetitively transmit, in multiple time domain resources, the CG-based PUSCH for which the TBS has been determined based on multiple symbol sets, repetitive PUSCH transmission may be started regardless of an RV value.

According to the (1-1)st embodiment of the present disclosure, the UE may be configured or indicated to repetitively transmit, in multiple time domain resources, a PUSCH for which a TBS has been determined based on multiple symbol sets. In this case, when separate RRC parameter startingFromRV0 for determination of an initial TO is configured to be “off” for the UE by the base station, the UE may start repetitive PUSCH transmission only in the preconfigured first TO among M repetitions. Alternatively, the UE may start repetitive PUSCH transmission only in the first TO among valid TOs excluding an invalid TO among preconfigured TOs in M repetitions.

However, when repetitive transmission starts in a TO having a value other than RV=0 according to the method (i.e., the first embodiment) described in FIG. 31, information bits (systematic bits) among coded bits may not be included in PUSCH transmission or only some of the information bits may be included in in PUSCH transmission, so that PUSCH performance degradation may occur. Hereinafter, embodiments for solving this problem will be described.

FIG. 32 illustrates another example of a method of determining an initial transmission occasion of a PUSCH for which a TBS has been determined based on multiple slots or multiple nominal PUSCHs according to an embodiment (hereinafter, second embodiment) of the present disclosure.

Referring to FIG. 32, when a TB is transmitted via multiple slots, and a PUSCH for transmitting the TB is repetitively transmitted, a UE may be configured with an RV sequence including only “0” from a base station, and may start repetitive PUSCH transmission for the TB in a TO having an RV value corresponding to “0”.

Specifically, multiple symbol sets may be configured for the UE via a configured grant scheme. The UE may determine a TBS based on allocated or configured multiple symbol sets and may repetitively transmit the PUSCH in multiple time domain resource, based on the determined TBS. In this case, the UE may perform repetitive PUSCH transmission based on an RV value configured for each slot according to an RV sequence configured by a base station.

In this case, when a slot for which an RV value of “0” has been configured for starting repetitive PUSCH transmission is invalid, the UE cannot perform repetitive PUSCH transmission in a slot for which an RV value other than “0” is configured. In this case, since the size of the TB is equal to or greater than one slot, repetitive PUSCH transmission for transmitting the TB may start again after a large number of slots have passed. Accordingly, in order to start repetitive PUSCH transmission, latency may occur.

Therefore, in this case, when the TBS which is the size of the TB is determined to be greater than one slot, the base station may configure a specific sequence including only a specific RV value to be an RV sequence for repetitive PUSCH transmission for transmitting the TB. In this case, the specific RV value may be an RV value enabling repetitive PUSCH transmission to be started.

For example, the base station may configure, for the UE, {0,0,0,0}as an RV sequence for repetitive PUSCH transmission, and since RV values of all slots are “0”, the UE may immediately start repetitive PUSCH transmission in a substantially valid slot even if a first slot for PUSCH transmission is invalid. In this case, the last TO may not be used for repetitive PUSCH transmission.

Specifically, when the UE is configured or indicated to repetitively transmit, in multiple time domain resources, the CG-base PUSCH for which the TBS has been determined based on multiple symbol sets, the RV sequence for repetitive transmission of the PUSCH, for which the TBS is determined based on multiple symbol sets for transmission, may always be configured to be {0, 0, 0, 0} for the UE. This corresponds to a scheme in which, when CG-based PUSCH transmission, which is transmission in a single slot, is repetitively transmitted in the NR system, the UE and the base station use the same method as that of configuring a time point, at which the UE may be assumed to start CG-based PUSCH transmission, to be RV=0, wherein a scheduling restriction on the base station is allowed for an RV sequence configuration. That is, since the UE may start repetitive PUSCH transmission in a TO corresponding to RV=0 in the same manner for CG-based PUSCH transmission in which transmission is performed in a single slot, and repetitive transmission of the CG-based PUSCH, for which the TBS has been determined based on multiple symbol sets, in multiple time domain resources, the RV sequence may be always configured to be {0, 0, 0, 0} so that repetitive transmission may start in any TO. For example, referring to FIG. 32, repetitive PUSCH transmission type A of the CG-based transmission scheme, N=2, and M=4 are configured for the UE. In this case, even if TOs of two slots corresponding to first repetitive transmission are not available for PUSCH transmission, TOs of two slots corresponding to the remaining repetitive transmission have a value of RV=0, and thus repetitive PUSCH transmission may be started. In addition, since the RV sequence is configured to be {0, 0, 0, 0} and N*M=8, the UE may start repetitive transmission in a second slot (slot U) of a TO corresponding to fourth repetitive transmission according to the aforementioned method of determining a TO.

According to the (2-1)st embodiment of the present disclosure, when the UE is configured or indicated to repetitively transmit, in multiple time domain resources, a CG PUSCH for which a TBS has been determined based on multiple symbol sets, the base station may configure, for the UE, RV sequence {0, 0, 0, 0}configured via RRC, without configuring separate RRC parameter startingFromRV0 for the UE to determine an initial TO. Alternatively, the base station may configure, for the UE, RRC parameter startingFromRV0 for initial TO determination to be “on”, wherein an RV sequence for a CG PUSCH for which a TBS has been determined based on multiple symbol sets may be configured to be {0, 0, 0, 0}. In this case, the UE may start repetitive transmission by determining an initial TO from any TO excluding the last TO among M repetitions. Accordingly, the base station may attempt to receive repetitive CG PUSCH transmission by assuming that the UE determines an initial TO from any TO and repetitive transmission of the UE may start from the TO.

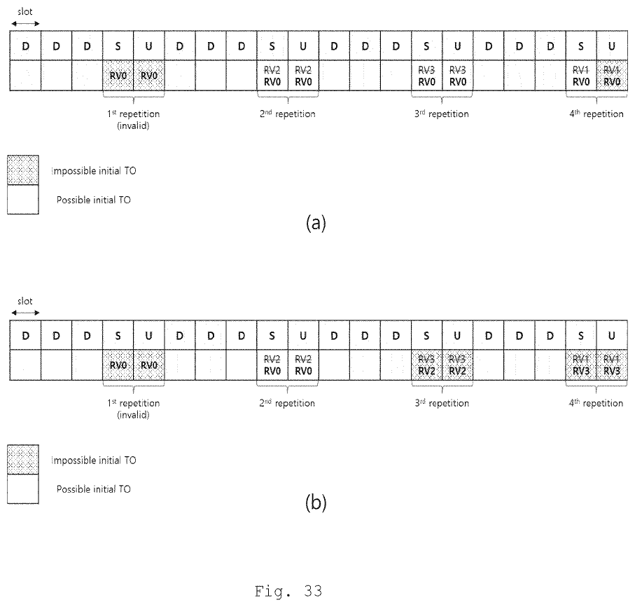

FIG. 33 illustrates another example of a method of determining an initial transmission occasion of a PUSCH for which a TBS has been determined based on multiple slots or multiple nominal PUSCHs according to an embodiment (hereinafter, third embodiment) of the present disclosure.

Referring to FIG. 33, when a TB is transmitted via multiple slots, and a PUSCH for transmitting the TB is repetitively transmitted, a UE may map an RV sequence value from a TO where repetitive PUSCH transmission may be started.

Specifically, multiple symbol sets may be configured for the UE via a configured grant scheme by a base station. The UE may determine a TBS based on allocated or configured multiple symbol sets, and may perform repetitive transmission via the PUSCH in multiple time domain resource, based on the determined TBS. In this case, the UE may perform repetitive PUSCH transmission based on an RV value configured for each slot according to an RV sequence configured by the base station.

In this case, when a slot for which an RV value of “0” has been configured for starting repetitive PUSCH transmission is invalid, the UE cannot perform repetitive PUSCH transmission in a slot for which an RV value other than “0” is configured. In this case, since the size of the TB is equal to or greater than one slot, repetitive PUSCH transmission for transmitting the TB may start again after a large number of slots have passed. Accordingly, in order to start repetitive PUSCH transmission, latency may occur.

Therefore, in this case, the UE may start repetitive PUSCH transmission by reconfiguring RV values of the RV sequence from a TO of a slot, which is available for starting of repetitive PUSCH transmission, after the invalid TO.

Specifically, when the UE is configured or indicated to repetitively transmit, in multiple time domain resources, the CG-based PUSCH for which the TBS has been determined based on multiple symbol sets, the UE may map a new RV value from the TO which is available for starting of repetitive PUSCH transmission. Specifically, when a TO having RV=0 corresponding to first repetitive transmission is invalid, a TO corresponding to subsequent repetitive transmission is determined to have RV=0, so that the CG-based PUSCH, for which the TBS has been determined based on multiple symbol sets, may be repetitively transmitted in multiple time domain resources.

Referring to FIG. 33A, RV sequence {0, 0, 0, 0} may be reconfigured and applied starting from a TO which is available for starting of repetitive PUSCH transmission. Regardless of the RV sequence configured from the base station, when a TO having RV=0 corresponding to first repetitive transmission is invalid, the UE may be configured to reconfigure and apply RV sequence {0,0, 0, 0} from repetitive transmission of a subsequent valid TO so as to perform repetitive PUSCH transmission. For example, referring to FIG. 33A, repetitive PUSCH transmission type A of the CG-based transmission scheme, N=2, and M=4 are configured for the UE. In addition, RV sequence {0, 2, 3, 1} is configured from the base station. Since TOs of two slots corresponding to first repetitive transmission are invalid, RV sequence {0, 0, 0, 0} may be applied from a TO corresponding to second repetitive transmission. In this case, since N*M=8, the UE may start repetitive PUSCH transmission in slots S or slots U remaining after excluding a second slot (slot U) of a TO corresponding to fourth repetitive transmission.

Referring to FIG. 33B, from a TO available for starting of repetitive PUSCH transmission, mapping may be performed sequentially starting from RV=0 of the configured RV sequence. When a TO having RV=0 corresponding to first repetitive transmission is invalid, the UE may sequentially reconfigure RV=0 of the configured RV sequence from repetitive transmission of a subsequent valid TO, so as to map respective RV values of the RV sequence. For example, repetitive PUSCH transmission type A of the CG-based transmission scheme, N=2, and M=4 are configured for the UE. In addition, RV sequence {0, 2, 3, 1} is configured from the base station. Since TOs of two slots corresponding to first repetitive transmission are invalid, the RV sequence may be mapped by sequentially reconfiguring the value of RV=0 starting from a TO corresponding to second repetitive transmission. That is, a value of RV=0 is mapped to a TO corresponding to second repetitive transmission, a value of RV=2 is mapped to a TO corresponding to third repetitive transmission, and a value of RV=3 is mapped to a TO corresponding to fourth repetitive transmission, so that repetitive PUSCH transmission may be started from the TO corresponding to the second repetitive transmission.

In addition, when the TO with RV=0 is invalid, the UE and the base station may have the same information basis which may be assumed thereby. When RV sequences and RV values for repetitive PUSCH transmission, which may be assumed by the UE and the base station, are different, the base station needs to blind-detect a PUSCH, which has an RV value based on an RV sequence configuration configured for a previous UE, and an additional PUSCH having a value of RV=0 each time to receive repetitive CG-based PUSCH transmission in a resource in which repetitive CG-based PUSCH transmission is performed.

In the first, second, and third embodiments, the UE may not be configured with separate RRC parameter startingFromRV0 for determining an initial TO, or RRC parameter startingFromRV0 may be configured to be “on” for the UE.

According to the fourth embodiment of the present disclosure, when the UE is configured or indicated to repetitively transmit, in multiple time domain resources, a PUSCH for which a TBS has been determined based on multiple symbol sets, the UE may always be configured with startingFromRV0=“off” by the base station. Specifically, when the UE is configured or indicated to repetitively transmit, in multiple time domain resources, a PUSCH for which a TBS has been determined based on multiple symbol sets according to the CG-based transmission scheme, the UE may always be configured with startingFromRV0=“off” by the base station. When configured with startingFromRV0=“off”, the UE may start repetitive CG-based PUSCH transmission in a first TO regardless of a condition of RV=0 which is a condition for an initial TO, and the base station attempts to receive repetitive CG-based PUSCH transmission by assuming that repetitive CG-based PUSCH transmission of the UE may start.

According to the (4-1)st embodiment of the present disclosure, when the UE is configured or indicated to repetitively transmit, in multiple time domain resources, a PUSCH for which a TBS has been determined based on multiple symbol sets, separate RRC parameter startingFromRV0 for the UE to determine an initial TO may be configured to be “off” for the UE, and when this is configured to the UE, the UE may start transmission only in the preconfigured first TO among M repetitions. Alternatively, the UE may start transmission only in the first TO among valid TOs excluding an invalid TO among preconfigured TOs in M repetitions.

The foregoing descriptions of the present disclosure are for illustration purposes, and those skilled in the art, to which the present disclosure belongs, will be able to understand that modification to other specific forms can be easily achieved without changing the technical spirit or essential features of the present disclosure. Therefore, it should be understood that the embodiments described above are illustrative and are not restrictive in all respects. For example, each element described as one type may be implemented in a distributed manner, and similarly, elements described as being distributed may also be implemented in a combined form.

The scope of the present disclosure is indicated by claims to be described hereinafter rather than the detailed description, and all changes or modifications derived from the meaning and scope of the claims and their equivalent concepts should be interpreted as being included in the scope of the present disclosure.

1. A user equipment (UE) used in a wireless communication system, the UE comprising:
a communication module; and
a processor configured to control the communication module,
wherein the processor is configured to:
determine a transport block size (TBS) based on N (>1) slots,
determine K slot groups for repetitively transmitting, K (>=1) times, a configured grant (CG) physical uplink shared channel (PUSCH) based on the TBS, each slot group comprising N slots corresponding to each repetitive CG PUSCH transmission,
wherein the repetitive CG PUSCH transmission is performed on N*K slots in a slot basis, based on a slot in which the repetitive CG PUSCH transmission is available, and
wherein, based on that a radio resource control (RRC) parameter for determination of an initial transmission occasion (TO) is configured to be a first value, initial transmission of the CG PUSCH starts only in a first slot among the N*K slots for the repetitive CG PUSCH transmission.

2. The UE of claim 1, wherein the processor is further configured to receive configuration information on an RV sequence,
wherein, based on index n corresponding to the N*K slots, RV values in the RV sequence are cyclically mapped one by one in a unit of N slots within the N*K slots, and wherein the RV sequence comprises one or more RV0s.

3. The UE of claim 2, wherein, based on that (1) the RRC parameter for determination of the initial TO is configured to be a second value, and (2) the RV sequence is {RV0, RV3, RV0, RV3}, the initial transmission of the CG PUSCH starts within slots associated with RV0 among the N*K slots.

4. The UE of claim 2, wherein, based on that (1) the RRC parameter for determination of the initial TO is configured to be a second value, and (2) the RV sequence is {RV0, RV0, RV0, RV0}, the initial transmission of the CG PUSCH starts within slots associated with RV0 among the N*K slots.

5. The UE of claim 2, wherein, based on that (1) the RRC parameter for determination of the initial TO is configured to be a second value, and (2) the RV sequence is {RV0, RV2, RV3, RV1}, the initial transmission of the CG PUSCH starts only in the first slot among the N*K slots.

6. A method used by a UE in a wireless communication system, the method comprising:
determining a transport block size (TBS) based on N (>1) slots;
determining K slot groups for repetitively transmitting, K (>=1) times, a configured grant (CG) physical uplink shared channel (PUSCH) based on the TBS, each slot group comprising N slots corresponding to each repetitive CG PUSCH transmission; and
performing the repetitive CG PUSCH transmission on N*K slots in a slot basis, based on a slot in which the repetitive CG PUSCH transmission is available, and
wherein, in case that a radio resource control (RRC) parameter for determination of an initial transmission occasion (TO) is configured to be a first value, initial transmission of the CG PUSCH starts only in a first slot among the N*K slots for the CG PUSCH.

7. The method of claim 6, further comprising receiving configuration information on an RV sequence,
wherein, based on index n corresponding to the N*K slots, RV values in the RV sequence are cyclically mapped one by one in a unit of N slots within the N*K slots, and
wherein the RV sequence comprises one or more RV0s.

8. The method of claim 7, wherein, based on that (1) the RRC parameter for determination of the initial TO is configured to be a second value, and (2) the RV sequence is {RV0, RV3, RV0, RV3}, the initial transmission of the CG PUSCH starts within slots associated with RV0 among the N*K slots.

9. The method of claim 7, wherein, based on that (1) the RRC parameter for determination of the initial TO is configured to be a second value, and (2) the RV sequence is {RV0, RV0, RV0, RV0}, the initial transmission of the CG PUSCH starts within slots associated with RV0 among the N*K slots.

10. The method of claim 7, wherein, based on that (1) the RRC parameter for determination of the initial TO is configured to be a second value, and (2) the RV sequence is {RV0, RV2, RV3, RV1}, the initial transmission of the CG PUSCH starts only in the first slot among the N*K slots.

11. A base station used in a wireless communication system, the base station comprising:
a communication module; and
a processor configured to control the communication module,
wherein the processor is configured to:
determine a transport block size (TBS) based on N (>1) slots,
determine K slot groups for repetitively receiving, K (>=1) times, a configured grant (CG) physical uplink shared channel (PUSCH) based on the TBS, each slot group comprising N slots corresponding to each repetitive CG PUSCH reception,
wherein the repetitive CG PUSCH reception is performed on N*K slots in a slot basis, based on a slot in which the repetitive CG PUSCH reception is available, and
wherein, based on that a radio resource control (RRC) parameter for determination of an initial transmission occasion (TO) is configured to be a first value, initial reception of the CG PUSCH starts only in a first slot among the N*K slots for the repetitive CG PUSCH reception.

12. The base station of claim 11, wherein the processor is further configured to transmit configuration information on an RV sequence,
wherein, based on index n corresponding to the N*K slots, RV values in the RV sequence are cyclically mapped one by one in a unit of N slots within the N*K slots, and
wherein the RV sequence comprises one or more RV0s.

13. The base station of claim 12, wherein, based on that (1) the RRC parameter for determination of the initial TO is configured to be a second value, and (2) the RV sequence is {RV0, RV3, RV0, RV3}, the initial reception of the CG PUSCH starts within slots associated with RV0 among the N*K slots.

14. The base station of claim 12, wherein, based on that (1) the RRC parameter for determination of the initial TO is configured to be a second value, and (2) the RV sequence is {RV0, RV0, RV0, RV0}, the initial reception of the CG PUSCH starts within slots associated with RV0 among the N*K slots.

15. The base station of claim 12, wherein, based on that (1) the RRC parameter for determination of the initial TO is configured to be a second value, and (2) the RV sequence is {RV0, RV2, RV3, RV1}, the initial reception of the CG PUSCH starts only in the first slot among the N*K slots.

16. A method used by a base station in a wireless communication system, the method comprising:
determining a transport block size (TBS) based on N (>1) slots;
determining K slot groups for repetitively receiving, K (>=1) times, a configured grant (CG) physical uplink shared channel (PUSCH) based on the TBS, each slot group comprising N slots corresponding to each repetitive CG PUSCH reception; and
performing the repetitive CG PUSCH reception on N*K slots in a slot basis, based on a slot in which the repetitive CG PUSCH reception is available, and
wherein, when a radio resource control (RRC) parameter for determination of an initial transmission occasion (TO) is configured to be a first value, initial reception of the CG PUSCH starts only in a first slot among the N*K slots for the CG PUSCH.

17. The method of claim 16, further comprising transmitting configuration information on an RV sequence,
wherein, based on index n corresponding to the N*K slots, RV values in the RV sequence are cyclically mapped one by one in a unit of N slots within the N*K slots, and
the RV sequence comprises one or more RV0s.

18. The method of claim 17, wherein, based on that (1) the RRC parameter for determination of the initial TO is configured to be a second value, and (2) the RV sequence is {RV0, RV3, RV0, RV3}, the initial reception of the CG PUSCH starts within slots associated with RV0 among the N*K slots.

19. The method of claim 17, wherein, based on that (1) the RRC parameter for determination of the initial TO is configured to be a second value, and (2) the RV sequence is {RV0, RV0, RV0, RV0}, the initial reception of the CG PUSCH starts within slots associated with RV0 among the N*K slots.

20. The method of claim 17, wherein, based on that (1) the RRC parameter for determination of the initial TO is configured to be a second value, and (2) the RV sequence is {RV0, RV2, RV3, RV1}, the initial reception of the CG PUSCH starts only in the first slot among the N*K slots.
